(19) United States
(12) Patent Application Publication
(10) Pub. No.: US 2023/0067609 A1
(43) Pub. Date: Mar. 2, 2023

(54) ENDOPHYTIC MICROBES FOR GROWTH PROMOTION OF CROP PLANTS AND SUPPRESSION OF AGGRESSIVE INVASIVE PLANT SPECIES, BIOHERBICIDES COMPRISING THE SAME AND METHODS OF USE THEREOF

(71) Applicants: RUTGERS, THE STATE UNIVERSITY OF NEW JERSEY, New Brunswick, NJ (US); U.S. GEOLOGICAL SURVEY, Ann Arbor, MI (US)

(72) Inventors: James F. White, South River, NJ (US); Kurt P. Kowalski, Ann Arbor, MI (US); Kathryn L. Kingsley, Robbinsville, NJ (US); Matthew T. Elmore, East Brunswick, NJ (US); Xiaoqian Chang, Piscataway, NJ (US)

(21) Appl. No.: 17/815,435

(22) Filed: Jul. 27, 2022

Related U.S. Application Data
(63) Continuation-in-part of application No. 17/266,489, filed on Feb. 5, 2021.
(60) Provisional application No. 63/203,575, filed on Jul. 27, 2021.
(60) Provisional application No. 62/716,742, filed on Aug. 9, 2018.

(51) Int. Cl. A01N 63/30; A01N 25/04; A01N 63/27; A01P 13/02; A01N 63/20; A01N 47/44; A01N 65/36; A01N 63/25; A01N 63/22

(52) U.S. Cl. CPC A01N 63/30; A01N 25/04; A01N 63/27; A01P 13/02; A01N 63/20; A01N 47/44; A01N 65/36; A01N 63/25; A01N 63/22

(57) ABSTRACT

Endophytic bacteria, compositions comprising the same, and methods of use thereof are disclosed which suppress growth of aggressive, invasive weed species which grow in the same habitat of target plants of interest. Bioherbicides, compositions comprising the endophytic bacteria and methods of use thereof are disclosed which suppress growth of aggressive, invasive weed species which grow in the same habitat of target plants of interest.

### CROSS REFERENCE TO RELATED APPLICATION

This continuation-in-part application claims the benefit of U.S. Provisional Application No. 63/203,575 filed Jul. 27, 2021 and U.S. application Ser. No. 17/266,489 filed Feb. 5, 2021 which is a § 371 application of PCT/US2019/045932 filed Aug. 9, 2019 which in turn claims priority of U.S. Provisional Application No. 62/716,742 filed Aug. 9, 2018, the entire contents of each application being incorporated by reference herein as though set forth in full.

### GRANT STATEMENT

This invention was made with funds from the US Geological Survey, Grant No. CESU G16AC00433 and USDA-NIFA Multistate Project, W3147. The US government has rights in this invention.

### INCORPORATION-BY-REFERENCE OF MATERIAL SUBMITTED IN ELECTRONIC FORM

The contents of the electronic sequence listing (RUT-P06608CIP.xml; Size: 66,467 bytes; and Date of Creation: Jul. 27, 2022) is herein incorporated by reference in its entirety.

### FIELD OF THE INVENTION

This invention relates to compositions comprising endophytic bacteria and methods of use thereof to promote plant growth and suppress aggressiveness in invasive plant species. More specifically, this invention relates to bioherbicidal compositions comprising naturally occurring herbicidal components and plant inhibitory endophytic bacteria or fungi and methods of use thereof to kill or suppress aggressive invasive or weedy plant species.

### BACKGROUND OF THE INVENTION

Several publications and patent documents are cited throughout the specification in order to describe the state of the art to which this invention pertains. Each of these citations is incorporated by reference herein as though set forth in full.

Plant seeds carry embryonic plants and nutrients for early stages of seedling growth; seeds also carry small communities of symbiotic microbes (primarily bacteria and fungi) that are needed for defense from pathogens, modulation of plant development, and nutrient acquisition in seedlings. Seed-vectored symbiotic microbes are adapted to their host plant and may enable seedlings to survive and thrive (Compant, Clement and Sessitsch, 2010; Kandel et al., 2017). Without symbiotic microbes, seedlings do not develop properly—often lacking normal root gravitropic response where roots do not grow downward into the soil or other substrate—sometimes growing upward—where roots may not produce root hairs—or hairs may be sparse or short (Holland, 1997; Verma et al., 2017a, 2017b; White et al., 2012). Seedlings without their microbes are more susceptible to diseases and oxidative stresses (abiotic and biotic in nature), drought, heat, heavy metals, herbivory, etc. (Rodriguez et al., 2009; Torres et al., 2012; Waller et al., 2005; White and Torres, 2010).

Some seed-associated tissues appear to harbor adaptations to vector microbes on seeds. Dried paleas and lemmas that adhere closely to grass seed coats (or caryopsis testa) vector bacteria and sometimes fungi that colonize roots and shoots of the germinating seedlings as they emerge from the seeds (White et al., 2012). The characteristically winged seeds of species in the plant family Polygonaceae vector bacteria that colonize germinating seedlings. In cotton (Gossypium spp.; Malvaceae) elongated trichomes (cotton fibers) carry bacteria that may stimulate seedling growth and protect cotton plants from diseases. Removal of the cotton fibers by acid delinting as is commonly done makes seeds easier to process in mechanical planters but also removes symbiotic bacteria from cotton seeds, leaving the seedlings defenseless from pathogens, insect pests, and compromised developmentally (Irizarry and White, 2017, 2018). As a consequence, cotton is often considered to be “the world's dirtiest crop” due to the amount of agrochemicals frequently used in its cultivation (Environmental Justice Foundation, 2007). In many grasses of subfamily Pooidae fungal Epichloë endophytes colonize the ovules of the maternal plant and grow into the embryo inside caryopsis—thus germinating seedlings already contain the fungal endophyte (White and Cole, 1986).

It is clear that regulation of plant cell growth by changing the endosymbiotic microbial biosphere (microbiome) surrounding and within the plant under certain conditions is highly desirable. It is an object of the invention to provide compositions and methods for changing said biosphere to kill or suppress invasive or weedy plant species.

### SUMMARY OF THE INVENTION

In accordance with the present invention a method of improving a competitive advantage in a target plant of interest over aggressive invasive weed species which grow in the same habitat is provided. An exemplary method comprises inoculating a plant element with a formulation comprising one or more biologically pure endophytic microbes selected from those set forth in Table 1, Table 3B or Table 4. In certain embodiments, the microbes are 1) yeasts Rhodotorula sp. (strain Abrus #1) and Aureobasidium pullulans (strain Froelichia #2; NRRL No. B-68181), and, or, ii) bacteria Sphingomonas sp. (strain Abrus #3), Rhodococcus sp. (strain AbrusR; NRRL No. B68175), Micrococcus luteus (strain Lycopersicon #1; NRRL No. 68176), Curtobacterium sp. (strain Froelichia #4; NRRL No. B-68177) and Paenibacillus sp. (strain PA-NA-2B1; NRRL No. B68174) and, or iii) Strain 5, Pantoea sp. from crabgrass, strain PP4F, Pseudomonas sp. from Poa pratenses and strain Froelichia #2, Aureobasidium pullulans; and, or iv) Strain 4, Pantoea sp. from crabgrass and strain PA-NA-2B1, Paenibacillus sp. from Poa annua and strain PP4-F, Pseudomonas sp. from Poa pratensis; and, or v): Strain PP4F, Pseudomonas sp. from Poa pratenses and Strain PA-NA-2B1, Paenibacillus sp. from Poa annua and Strain Froelichia #2, Aureobasidium pullulans) which are heterologously disposed to said plant element, wherein said endophyte strains are present in the formulation in an amount capable of modulating growth of undesirable competitor weed species growing in the same habitat as said target plant, as compared to a reference, untreated plant grown under the same conditions.

In certain embodiments, the plant is a plant is a monocot or dicot. In other embodiments, the plant is selected from the group of plants consisting of cotton, okra, soybean, cacao, kenaf and kola nut, coffee, tobacco, potato, tomato, sweet potato, sunflower, rapeseed, wheat, corn, rice, barley, sorghum, grass, sugarcane, bamboo, buckwheat, snap bean, dry bean, canola, peas, peanuts, safflower, sunflower, alfalfa hay, clover, vetch, and trefoil, blackberry, blueberry, currant, elderberry, gooseberry, huckleberry, loganberry, raspberry, strawberry, grape, garlic, leek, onion, shallot, citrus hybrid, grapefruit, kumquat, lime, orange, pummelo, cucumber, melon, gourd, pumpkin, squash, eggplant, sweet pepper, hot pepper, tomatillo, herb, spice, mint, arugula, celery, chervil, endive, fennel, lettuce, parsley, radicchio, rhubarb, spinach, swiss chard, broccoli, brussels sprout, cabbage, cauliflower, collard, kale, kohlrabi, mustard green, asparagus, pear, quince, beet, sugarbeet, red beet, carrot, celeriac, chicory, horseradish, parsnip, radish rutabaga, salsify, and turnips, maple, pine, rye, wheat, sorghum, millet, apricot, cherry, nectarine, peach, plum, prune, almond, beech nut, Brazil nut, butternut, cashew, chestnut, filbert, hickory nut, macadamia nut, pecan, pistachio, walnut, artichoke, cassava, and ginger plants.

In certain aspects the one or more endophyte strains in the formulation are present in a synthetic seed ball. In other aspects, the one or more endophyte strains in the formulation are present in a seed treatment. The one or more endophyte strains in the formulation can also be present in a liquid formulation which is sprayed on seeds or the target plant. In other embodiments, the liquid formulation is applied to the plant as a root dunk. The formulation can also optionally comprise a controlled release fertilizer formulation.

The present invention also encompasses a synthetic combination comprising one or more microbes selected from Rhodotorula sp. (strain Abrus #1) and Aureobasidium pullulans (strain Froelichia #2; NRRL No. B-68181), Sphingomonas sp. (strain Abrus #3), Rhodococcus sp. (strain AbrusR; NRRL No. B-68175), Micrococcus luteus (strain Lycopersicon #1; NRRL No. B-68176), Curtobacterium sp. (strain Froelichia #4; NRRL No. B-68177), Paenibacillus sp. (strain PA-NA-2B1; NRRL No. B-68174), PP16 (Pseudomonas sp.), PP21 (Exiguobacterium sp.), PP4-F (Pseudomonas sp.), AA3A (Bacillus sp.; B-68173), Aa2 (Bacillus sp.) NRRL No. B-6178, AA15 (Bacillus sp.), OVLBP2R (Methylobacter sp.), OVYP4AD19 (Sphingomonas sp.), OMPDAP5BK (Bacillus sp.; NRRL No. B-68180), OMYESP3B (Terribacillus sp.), isolates 4, 5, 8, 12, 18, 22 from Table 4 and, or a combination of isolates 4 and 5 from Table 4, in a formulation suitable for application to a plant element or soil. The synthetic combination can be present in a seed ball. The synthetic combination can be present in a liquid suitable for application to seeds.

In certain embodiments of the method described above, the one or more microbes are the yeast Aureobasidium pullulans (Froelichia #2) and bacterium Micrococcus luteus (Lycopersicum #1) where strains complement one another, and the combination shows maximum seedling mortality. In other embodiments, the one or more microbes are selected from the yeast Rhodotorula sp. (strain Abrus #1), Sphingomonas sp. (strain Abrus #3) and Micrococcus luteus (Lycopersicum #1) which are each effective to inhibit root growth. In other embodiments, all of said microbes are present. Finally, the synthetic combinations of the invention may further comprise an insecticide or fungicide and/or the strains identified as having plant growth promoting activity.

In another aspect of the present invention, natural bioherbicide compositions have been developed to kill undesirable plant species. In one aspect, the invention provides a bioherbicide composition comprising citrus oil, arginine, and sugar. In an exemplary embodiment, the sugar is sucrose. In another embodiment, the composition contains 1-15% arginine, 1-20% sucrose, 5-20% citrus oil and 1%-5% glycerol. In another embodiment, the composition may further comprise an effective amount of at least one inhibitory endophytic bacterium or fungus selected from those listed in Table 11, at least one organic acid or salt, or both. In a preferred embodiment, the composition contains 1×10²⁻⁶ cells/mL of inhibitory bacteria or fungi. In another embodiment, the composition contains 0.1-6% organic acid or salt. In another embodiment, the bioherbicide composition does not include organic acids or salts or butyrate. In certain embodiments, the composition may be dissolved or suspended in water. In another embodiment, the bioherbicide contains 5% arginine, 1% butyrate, 15% citrus oil, and 15% sucrose and optionally 1% to 5% glycerol.

In another aspect, the invention provides methods for killing undesirable plant species comprising administering the bioherbicide disclosed herein. In alternative embodiments, the method encompasses administration of the composition via a spray or via soil drenching. The method entails administration via a soil drenching solution containing arginine and sugar. Methods of soil drenching can include administration of a bioherbicide containing composition comprising 1-15% arginine and 1-20% sucrose thereby causing formation of excessive reactive oxygen species (ROS) by endogenous bacteria or fungi present in the undesirable plant species to be treated, and inducing plant cell death. In other embodiments, the method includes administration of the bioherbicide composition along with heterologously-disposed inhibitory endophytic bacteria or fungi which further enhance plant cell death in undesirable competitor plant species.

### BRIEF DESCRIPTION OF THE DRAWINGS

FIG. 1. Micrococcus luteus. Micrococcus luteus in seedling of carrots (arrows show white accumulations of bacteria around seedlings on agarose after two weeks.

FIG. 2. Tetrads of Micrococcus luteus (arrows) from colonies on yeast extract-sucrose agar (bar=10 μm).

FIG. 3. Cells around root-tip meristem of seedling of Rumex crispus showing tetrads of Micrococcus luteus (arrows) in the periplasmic space of cells (bar=25 μm).

FIG. 4. Cells around the root-tip meristem of a seedling of Rumex crispus that had not been inoculated with Micrococcus luteus, showing that bacteria are not visible in cells (bar—25 μm).

FIG. 5. Parenchyma cells of Rumex crispus showing spherical bacterial L-forms of Micrococcus luteus (arrows) in periplasmic spece of cells (bar=25 μm).

FIG. 6. Parenchyma cells of Rumex crispus showing spherical bacterial L-forms of Micrococcus luteus (arrows) in periplasmic spece of cells (bar=25 μm).

FIG. 7. Micrococcus luteus in host tissues (stained with 3,3-diaminobenzidine for 15 hours followed by aniline blue). L-forms of Micrococcus luteus (arrows) in root hair of Rumex crispus (bar=25 μm).

FIG. 8. Root hair initial of Rumex crispus seedling showing spherical L-forms in periplasmic space (white arrow) and blue tetrads of Micrococcus luteus reporming as bacteria (black arrow) exit through the cell wall and spill off the side of the root hair initial (bar=25 μm).

FIG. 9. Root hair of Rumex crispus seedling showing Micrococcus luteus exiting the root hair at the hair tip, and reforming tetrads (arrows; bar=25 μm).

FIG. 10. Root hairs of carrot (Daucus carota) seedling showing exiting of Micrococcus luteus from the tips of hairs (arrows; bar=20 μm).

FIG. 11. Root hair initial of carrot seedling showing Micrococcus luteus emerging from the hair initial (arrows; bar=20 μm).

FIG. 12. Root hair tip of Rumex crispus seedling showing spherical L-forms (white arrow) in periplasmic space and tetrads (black arrow) of Micrococcus luteus just outside the cell wall; exit channels are visible passing through the cell wall (bar=5 μm).

FIG. 13. Aureobasidium pullulans in seedling cells (stained with 3,3-diaminobenzidine for 15 hours, followed by aniline blue). Root hair of Amaranthus hypochondriacus seedling inoculated with Aureobasidium pullulans, showing intracellular, brown-staining and collapsed walled yeast cells (white arrow) and extracellular, blue-staining yeast cells (black arrows; bar=20 μm).

FIG. 14. Amaranthus viridis seedling root parenchyma cell showing intracellular walled hypha (arrow) of Aureobasidium pullulans (bar=25 μm).

FIG. 15. Froelichia gracilis seedling root hair showing intracellular yeast mycosomes (arrows; bar=20 μm).

FIG. 16. Amaranthus viridis root parenchyma cells showing abundance of intracellular brown-staining yeast mycosomes (bar=25 μm).

FIG. 17. Froelichia gracilis seedling root hair with intracellular yeast mycosomes (arrows; bar=20 μm).

FIG. 18. Amaranthus viridis root hair without intracellular yeasts (bar=20 μm).

FIG. 19A. Micrococcus-treated Poa annua seedlings do not grow properly in the agarose assays. Seedling roots are undeveloped and seedlings lodge rather than stand upright. FIG. 19B. Suppression of root development is seen in Micrococcus-treated Poa annua seedlings (arrows indicate root tips; seedlings are 10-days-old; stained with DAB). FIG. 19C. Carrot (Daucus carota; Apiaceae) Seedlings are Inhibited by Micrococcus. FIG. 19D. Japanese knotweed (Fallopia japonica Polygonaceae) seedling growth is also inhibited by M. luteus.

FIG. 20. Yeast Aureobasidium (Froelichia #2)-inoculated seedling (left) compared to control seedling (right) of Amaranthus hypochondriacus containing only native endophytic bacteria. Seedlings were stained overnight with DAB to visualize reactive oxygen in roots (brown coloration). Both seedlings are 7 days old.

FIGS. 21A-21B. Taraxacum officinale seedling root hairs stained with aniline blue as well as DAB for H₂O₂ 14 days after seeds were inoculated with a Pantoea sp. (Isolate 4). Root hairs of a non-inoculated seedling (FIG. 21A) are intact while roots hairs from an inoculated seed (FIG. 21B) have ruptured (indicated with arrows).

FIGS. 22A-22C. Trifolium repens seedlings 14 days after inoculation with Pantoea sp. Isolate 5 (FIG. 22A), Pantoea sp. Isolate RiLB4 (positive control) (FIG. 22B), and bacteria free control (FIG. 22C).

FIG. 23. Root cortex cells in the primary Poa annua seedling root 10 days after seeds were inoculated with a Curvularia sp. showing an intercellular fungal hyphae (indicated with arrows) stained with aniline blue (0.1%).

FIG. 24. Photograph showing bacterium Micrococcus luteus (arrows) in periplasmic space of root meristematic cells of weed Rumex crispus (Mag.=1000×).

FIG. 25. Photograph of clusters of bacteria (arrows) within a leaf hair (trichome) of tree-of-heaven (Ailanthus altissima) stained with 1% ammonium molybdate solution to show ethylene (purple) around bacteria (Mag.=1000×).

FIG. 26. Chemical equation that represents an interaction between endosymbiotic bacteria and plant cells. In this interaction, microbes produce and secrete ethylene onto plant cells. Ethylene triggers the plant cell to grow, release nutrients and release superoxide from NADPH oxidases on the plant cell plasma membrane. Some of the superoxide oxidizes cell walls from bacteria, inducing nutrient leakage and cell wall degradation. Some of the superoxide reacts with ethylene to produce hydrogen peroxide and carbon dioxide. Reactants and products detected in histochemical analyses are indicated in red.

FIG. 27. Seedlings of Poa reptans grown on agarose with and without 0.05% arginine. Seedlings exposed to arginine show repressed growth and lack of chlorophyll in shoot tissues.

FIG. 28. A micrograph of Poa reptans seedling leaves showing absence of green color in leaves treated with 0.05% arginine.

FIG. 29. Leaf cells of Poa reptans seedling treated with 0.05% arginine showing irregular outline of chloroplasts (arrows) due to their colonization by actively motile bacteria are shown (Mag.=1000×).

FIG. 30. A micrograph of Poa reptans seedling roots stained with diaminobenzidine tetrahydrochloride showing excess hydrogen peroxide (brown color) in roots treated with 0.05% arginine compared to roots that were not exposed to arginine.

FIG. 31. A micrograph of seedlings of Poa reptans treated with arginine (right) show increased concentration of superoxide internally as indicated by the purple staining (red square) using nitro blue tetrazolium; untreated seedlings (e.g., left photo) show reduced superoxide and root hairs. Increased ethylene production by endosymbiotic bacteria results in increased root hair growth.

FIGS. 32A-32B. A micrograph showing sections of Phragmites australis leaves treated with either water or a bioherbicidal mixture containing citrus oil, arginine and organic salts (Mag.=1000×). FIG. 32A shows a water-treated leaf possessing a think cuticular layer (arrow) on the epidermis; FIG. 32B shows a leaf treated with a citrus oil containing bioherbicidal mix where the leaf epidermal surface lacks the waxy cuticle (arrow).

FIGS. 33A-33B. FIG. 33A shows Phragmites australis plants 3 days after being treated with an arginine-containing bioherbicidal mixture without exogenous bacteria, where several leaves (arrows) do not show desiccation. FIG. 33B shows plants treated with the same bioherbicide mixture in which a bacterium (Bacillus sp. at a concentration of 1×10³ cells/mL) has been included.

FIG. 34 A micrograph of a section of a leaf treated with the arginine-based herbicide mixture showing growth of fungi (arrows) degrading tissues within the leaf (Mag.=1000×).

FIG. 35. A micrograph of a section of a leaf treated with the arginine-based herbicide mixture showing growth of fungi (arrows) degrading the stomatal cells of the leaf, with mycelium and spores on the leaf surface (Mag.=1000×).

FIG. 36. A graph showing Phragmites australis killing effectiveness (numbers of dead stems per plot) after 2 weeks treatment using bioherbicidal mixture (Data from Table 12).

FIG. 37. A graph showing the change in Phragmites australis culms at weekly intervals (weeks 1-3) using bioherbicidal mixtures. Plots were treated weekly with bioherbicidal mixtures and dead culms (stems) were assessed after 3 weeks.

FIGS. 38A-38B. Plots of mugwort (Artemesia vulgaris): FIG. 38A Plot was treated only with water; FIG. 38B Plot treated with the arginine-based bioherbicide showing dead plants 1 week post treatment.

FIG. 39. A schematic of a typical arginine-based bioherbicide activity timeline in Phragmites australis.

FIGS. 40A-40D. Comparative analysis of plants treated via foliar application or soil dreching. FIG. 40A shows the plants prior to administration of the bioherbicide. All plants received 5% arginine and 10% sucrose. Plants labeled F.Humic and D.Humic also received 0.01% humic acid. Plants labeled F.Humic and NHF were administered the bioherbicide via foliar application. Plants labeled D. Humic and NHD were drenched. FIG. 40B shows the plants after 5 days of bioherbicide application. FIG. 40C shows the plants after 11 days of bioherbicide application. FIG. 40D shows a postmortem analysis of a plant that received foliar application (top) and one that was drenched (bottom).

### DETAILED DESCRIPTION OF THE INVENTION

Considerable experimental evidence has been accumulated that supports the disease suppressive role of seed-vectored microbes (Verma et al., 2018). These microbes control disease in two ways: 1) by direct colonization of potentially pathogenic soil borne fungi and suppression of their growth and virulence, and/or 2) colonization of seedlings resulting in up-regulation of defense-related genes that makes plants more resistant to disease (Gond et al., 2015; Irizarry and White, 2018).

This invention pertains to the use of endophytic microbes, including, but not limited to Micrococcus luteus (strain Lycospersicon #1), Rhodococcus sp. (strain AbrusR), Paenibacillus sp. (strain PA-NA-2B1), Rhodotorula sp. (strain Abrus #1), Sphingomonas sp. (strain Abrus #3), Pantoea sp. (strains crabgrass #4 and #5), and Aureobasidium pullulans (strain Froelichia #2) as bioherbicides to suppress growth and development of weed plants. The endophytes were obtained from plant species Abrus precatorius, Froelichia gracilis, Lycopersicum esculentum, Digitaria ischaemum, and Poa annua. Several of these endophytes were shown to suppress development of seedlings of dandelion (Taraxacum officionale), curly dock (Rumex crispus), clover (Trifolium repens), Japanese knotweed (Fallopia japonica) and annual bluegrass (Poa annua), Amaranthus hypochondriacus and Amaranthus viridis. Inhibitory microbes were found to enter into root cells at the root tip meristem, becoming located within the periplasmic spaces, between the cell wall and plasma membrane. Normally microbes in root symbiosis play roles in modulation of plant development, including stimulation of root gravitropic response (trigger roots to grow downward) and increasing root and shoot growth. Maladaptive endophytic microbes from other hosts displaced native endophytes and disrupted functions of the symbiosis, and led to reduced seedling growth and increased seedling mortality. The term ‘endobiome interference’ is used herein to describe this maladaptive symbiosis. None of these microbes appeared to be pathogenic or inhibitory of growth in their original hosts based on growth of seedlings containing microbes on agarose media. Micrococcus luteus was found to be growth promotional in tomato seedlings, resulting in intracellular colonization and increased root hair length. Accordingly, these microbes have utility in agricultural products to promote growth of crop species and suppress growth of undesirable weed species.

Digitaria ischaemum (Schreb) Schreb ex Muhl Schreb. and Poa annua L. are competitive early successional species usually considered weeds in agricultural and turfgrass systems. Bacteria and fungi associated with these weeds may contribute to their competitiveness. D. ischaemum and P. annua are annuals that reproduce exclusively through seed. These seeds may be a mechanism to vector important microbes. We tested whether bacteria associated with D. ischaemum and P. annua seeds would affect seedling growth and antagonize competitor forbs such as Taraxacum officinale, Trifolium repens. Bacteria and fungi associated with seeds of D. ischaemum and P. annua were isolated for study in axenic culture. Twenty-four bacterial strains and two fungal species were isolated. Twenty-four bacterial strains were inoculated onto T. officinale seeds. Ten strains were antagonistic to T. officinale seedling growth and four of those were antagonistic enough to cause significant seedling mortality. All four bacterial strains that increased T. officinale mortality were isolated from D. ischaemum seed while none of the 14 isolates from P. annua seed increased mortality. Two of the four bacterial isolates (characterized as Pantoea spp.) were evaluated further on D. ischaemum, T. repens (a competitor forb) and P. annua (a competitor grass) alone and in combination with a Curvularia sp. fungus also isolated from D. ischaemum seed. These bacteria caused >65% T. repens seedling mortality but did not affect P. annua seedling mortality. Effects on D. ischaemum seedling mortality were inconsistent. Whether alone or in combination with bacteria, Curvularia was highly pathogenic to D. ischaemum and T. repens but not P. annua. This Curvularia sp. was growth promotional in P. annua, increasing the gravitropic response of P. annua roots. These data demonstrate that bacteria associated with D. ischaemum seeds may be antagonistic to competitor forbs. The weedy character of D. ischaemum could at least in part stem from possession of bacteria that are antagonistic to competitor species.

Ethylene is a growth and stress hormone in plants. The secretion of ethylene into root cells by intracellular bacteria results in increased root cell and root growth (FIG. 3; Chang, Kingsley and White, 2021). In this interaction with plants, endophytes use microbial ethylene synthase to convert arginine (Chang, Kingsley and White, 2021), either produced internally or supplied by host cells, to produce ethylene that is secreted into the space between microbe and host cell. The ethylene has 3 effects on plant cells as follows: 1) plant cell growth is initiated (Lynch and Brown, 1997; Pitts et al., 1998; Feng et al., 2017), 2) exudates containing nutrients are released from the plant cells to the microbes outside cells as plant cells grow (Hu et al, 2018), and 3) ethylene triggers superoxide production from NADPH oxidases in the plant cell plasma membrane (Chae and Lee, 2001; Trobacher, 2009). Plant cell-produced superoxide has the effect of oxidizing cell walls from bacteria and inducing nutrient leakage from the bacterial protoplasts and regulating microbe proliferation and plant cell growth (Foreman et al., 2003; Paungfoo-Lonhienne et al., 2010; Hill et al., 2013; White et al., 2018a, 2019b). These same chemical interactions are at play in leaves and shoots of plants, with bacteria evident within developing leaf trichomes (FIG. 2). Endosymbiotic bacteria and fungi are present in all tissues of plants (White et al., 2019a).

Endosymbionts of all types have been shown to increase oxidative stress tolerance in plant hosts (White and Torres, 2010; Hamilton et al, 2012; White et al, 2018a). This increased oxidative stress tolerance is likely the result of ethylene production by endophytic microbes and the superoxide response by plant cells (Chang, Kingsley and White, 2021). Ethylene produced in excess leads to formation of excess reactive oxygen species (ROS) and oxidative stress in plants (White and Torres, 2010). However, the plant normally regulates endosymbiont production of ethylene by limiting the supply of arginine in exudates (nutrients) provided to endosymbionts (Chang, Kingsley and White, 2021). Addition of exogenous arginine provides the endosymbiotic microbes in plants with excess arginine that permits them to over-produce ethylene, resulting in over-production of superoxide and other reactive oxygen forms (e.g., hydrogen peroxide) by plant cells and tissues. This over-production of ethylene and superoxide results in oxidative stress in plants leading to the death of the plant.

Here, production and testing of a bioherbicide that kills plants by causing normally beneficial endosymbiotic microbes (bacteria and fungi) that naturally inhabit plant cells and tissues (roots and shoots) to overgrow, overproduce ethylene, and become pathogenic to plants is described. Under these conditions, superoxide, a highly potent form of reactive oxygen species (ROS), is overproduced causing increased oxidative stress in plants that leads to plant death. In certain embodiments, the invention comprises a mixture of amino acid arginine (1-15%), sucrose (1-20%), and citrus oil (5-20%). In certain embodiments, the mixture further comprises microbes (bacteria or fungi) (1×10²⁻⁶ cells/mL) and/or organic acids or salts (0.1-6%). The mixture may be dissolved or suspended in water and applied to plants.

The components of this invention function as follows: 1) citrus oil strips the waxy cuticle from surfaces of plants allowing entry of other components into tissues; 2) inhibitor microbes and sucrose increase the microbial load on plants and increase stress; 3) arginine stimulates microbes to produce ethylene that causes excess stress in plants; 4) organic salts inhibit plant cell and tissue recovery from stress and tissue damage.

The herbicide is not harmful to the environment; instead, it may function as a soil fertility stimulant by: 1) Stimulation of degradation of weeds by endosymbiotic/endophytic fungi (turned saprophytes) that release nutrients from standing weed material (leaves, stems and roots) to the soil where crop plants may access the nutrients; 2) Stimulation of the soil microbiome (bacteria and fungi) that grow on components of the herbicide and release additional soil nutrients that may be absorbed by crop plants. Further, the enhanced soil microbiome may be used by plants to obtain additional nutrients in the rhizophagy cycle (White et al., 2018a).

### Definitions

An “endophyte” or “endophytic microbe” is an organism that lives within a plant or is otherwise associated therewith. Endophytes can occupy the intracellular or intercellular spaces of plant tissue, including the leaves, stems, flowers, fruits, seeds, or roots. An endophyte can be either a bacterial or a fungal organism that can confer a beneficial property to a plant such as an increase in yield, biomass, resistance, or fitness in its host plant. As used herein, the term “microbe” or “bacteria” is sometimes used to describe an endophyte.

Several strains of the bacteria described herein can be identified by their distinct ribosomal 16S sequences. 16S ribosomal RNA (or 16S rRNA) is the component of the 30S small subunit of a prokaryotic ribosome that binds to the Shine-Dalgarno sequence. The genes coding for it are referred to as 16S rRNA gene (ITS regions) and are used in reconstructing phylogenies, due to the slow rates of evolution of this region of the gene.

Rhodotorula sp. (strain Abrus#1) (ITS rDNA)
(SEQ ID NO: 1)
CTAAAGTTGACTAATAGAATTAGAAGCTTCTACTTTACAAAACTCGGCCACTCCCGAAAGAGCGTCCT
CAGCGAATAGTCTATTACACTGAGTCAATCCGATTTTCGAATATGAGATGCTAATCATTTACGAACGA
GCTTCGCCAATAAAGGCCAGCAGGCGTTCAGAATCCAAACACTAATCCGATTTACTAGAAACCGGTAG
GTTGAAGAGTTCATGACACTCAAACAGACATGCTCTCCGGAATACCAGAGAGCGCAAGGTGCGTTCAA
AGATTCGATGATTCACTGAATTCTGCAATTCACATTACTTATCACATTTCGCTGCGTTCTTCATCGATGC
GAGAGCCAAGAGATCCGTTGTTGAAAGTTTTTTTTTGTTTTGTTTTTATTTACATACTTTAACTAATGTT
TAATAGTGAGCCGCAGACTGAATAGCAATTGCTTACTCTCAGTCCGCCAATAGTGCACAGAGTTGGAA
AATGAAGGTTGAGCTAACCGAAGTTACGCTCTAAATTCACTAATGATCCTTC
Sphingomonas sp. (strain Abrus#3) (16S rDNA)
(SEQ ID NO: 2)
AGTCGACGATGCTCTCTCGGCATAGGGTTGCGTGGGTGCTGCGCCTTGGGGGCGTACCGCGTCCCTCT
GGGATAACAGGTGTGGGCGAACGGTCTGAGAACGTGGTATCTCGAGGTTGATATCTTGCCATCAAAGG
ATGATCCCCCGTCGTATTCCCCGCTTGGAGAGAACTATCTGGTGGGGGGAAGGCCTACGAAGGCGGCT
TGCTGGGACGGTCCTGCGCGGCGGATCTGACACCCTGGGACTGCTCCTCGGGCCGGCCTCCTAGGGGA
AGAATCAGTGGGGAATAATGCCCTATGCGCGAAAGCCTGTGCCAGCGGTGCCCTGTTTATGGTGGAGC
ACTTCGGGTTGTAAAGCTCTTTTTGCCGGGATGCGAATGACAGTACCCGCCAAATTCCCCGCGGCCAA
CCCCGTGCCTGCAGCCGGGGCAATAGGGGCGGGGATAGCGTGGTTCGGAAGTACTGGGCGTAAAGTT
TGCGGACCTGGCAAGAGCTGGTGAAGGTCTGCTCGTTAATTCCAATTAAACAAGTGCCTTTGCCGCTG
GGTCACTTGACCGGCAGTTCCTTAGGGGTTTATCCAATTGTACAAGAGACACTCGAGGATAATCTGAA
GAGCCAGCTGGGCGAACCGAGGATGATGTTGCGGGGCTGCTACTGATCATCGAAAGAGGCGTGGATT
ACCTGGGAATCCACTCCGGTATGCTTGGCCCGCTTTTGCGCCTCGTCGCGGATCGGGGGTGTGGAAGTT
GGGTGGTCCACTGAAGCTCCTGGGAATATCTACTAGGTAGTCCTGTACCCTCGAATAAACGGGGCCCT
CTCCAGCGGGGCATCGTGGGGCTGTGGAACGAGCGGCTCACATCAAAGTACCGCCGTTAACCTTGGCC
GGACTATTTCTGTACCGGGCGCTTCACCACTCGGGGCTCCTACCTCAGGTACTTGCTGGCGGACGGCTG
CTTGGGTGTCGACGGGTTGAGCAAGGGCTGATTGGACCGGGACCCCCATCCATAAGTTCCTATCCTTT
AATTACCGTAATTTAAAAGGGAAC
Rhodococcus sp. (strain AbrusR) (16S rDNA)
(SEQ ID NO: 3; NRRL No. B-68175)
TTCGCCGCCGGCTTCGGGTGTTACCGACTTTCATGAGGGGACGGGCGGTGTGTACAAGGCCCGGGAAC
GTATTCACCGCAGCGTTGCTGATCTGCGATTACTAGCGACTCCGACTTCACGGGGTCGAGTTGCAGAC
CCCGATCCGAACTGAGACCGGCTTTAAGGGATTCGCTCCACCTCACGGTATCGCAGCCCTCTGTACCG
GCCATTGTAGCATGTGTGAAGCCCTGGACATAAGGGGCATGATGACTTGACGTCGTCCCCACCTTCCT
CCGAGTTGACCCCGGCAGTCTCCTGCGAGTCCCCCGACTCCGCGGGTGGCAACACAGGACAAGGGTTG
CGCTCGTTGCGGGACTTAACCCAACATCTCACGACACGAGCTGACGACAGCCATGCACCACCTGTACA
CCGACCACAAGGGGGGCCGTGTCTCCACGGCTTTCCGGTGTATGTCAAACCCAGGTAAGGTTCTTCGC
GTTGCATCGAATTAATCCACATGCTCCGCCGCTTGTGCGGGCCCCCGTCAATTCCTTTGAGTTTTAGCC
TTGCGGCCGTACTCCCCAGGCGGGGCGCTTAATGCGTTAGCTACGGCACGGATCCCGTGGAAGGAAAC
CCACACCTAGCGCCCACCGTTTACGGCGTGAACTACCAGGGTATCTAATCCTGTTCGCTACCCACGCAT
TCGCTCCTCAGCGTCAGTTATTTCCCAGAGACCCGCCTTCGCCACCGGTGTTCCTCCTGATATCTGCGC
ATTTCACCGCTACATCAGGAATTCCAGTCTCCCCTGAAGTACTCAAGTCTGCCCGTATCGCCTGCAAGC
CAACAGTTGAGCTGCTGGGATCCTCAGACGATGCGACAAACCGCCTACAAGCTCTTTACCCCCAGTAA
TTCCGGACGAAGCTTGGAGCCTACGTGGTACCCCGGCTGCTGGCACGTAGTTGGCCGG
Curtobacterium sp. (strain Froelichia#4) (16S rDNA)
(SEQ ID NO: 4; NRRL No. B-68177)
TGGGGTCGTCCGACGAGGGGGAGCTTGCCCGGGTGCGGGGTGGAGAAAGGTTGATGACTTCGTGAGT
AACCTGCCCATGGCTCTGGGATGTATTTAGCACACGACGTCTAATACTGGATAAGATCAGACGCCGCA
TGGACTGGTGGTGGAAGCAGATTTCAGTTGGGGCTGGACTCGCGGCCTATCAGCTTGTTGGTGAGGTA
ATGGCTCACCAAGGCGGCGCCGGGTAGCCGGCCTGGCGGGGTGCCCGGCCACACTGGGGCTGAATGA
CGGCCCAGCCTCCTACGGGTCGCAGCAGTGGGGAATATTGCACAATGGGCGAAAGCCTGCTGCAGCA
ACGCCGCGTGTAGGACGAGGGCCTTCGGGTTGTAAACCTCTTTTAGTAGGGAAGAAGCCACGAGGTGG
GTACCTGCAGAAAAAGCACCGGCTAACTACGTGCGAGCAGCCGCGGTAATACGTAGGGTGCAAGCGT
TGTCCGGAATTATTGGGCGTAAAGAGCTCGTACGCGGTTTGTCGCGTCCTCCGCCGCTTGCCGAGGCTC
CCCCTCGGGCTTGCGGTGGGTACGGGCAGACTAGAGTGCGGCAGGGGAGGCTGTAAATGCTGGAGCT
GCGGCGCAAAGCGCAGAGAACAGGCCGAACATCTATGGCCAAACGTTAACTCTGGGGCGTAACTGGG
GCTGTAGTCCTGATCCGTGGGGACCCATTCGGTCTACAGCGTCTGGTACTGCCCGCAGTAATCGTTTCG
CCCTCGGTGTACCGCCCGTTACCCGGGTTCTGCGCCGCAACTCCCGGATTTCCCGCCCCCCCTAGGGAA
TTCTGCCGCGCCGGTAAACCTTGAAGGCCTTAGGGGGGGCCTCGGCAATCCGCGGCACATGCGACTAA
ACTCCTAGCAGCGCTTTACACCTTACCATTCCTGGACATCCCCCGGACCATAGGTATGACATGGGCTGC
CCCTACGGAGCGGGGCAGGGGCTTTTTATTGCAGGTATCGGCACTTTCCCTGCGATCT
Paenibacillus sp. (strain PA-NA-2B1) (16S rDNA)
(SEQ ID NO: 5; NRRL No. B-68174)
CAATTCCGACTTCATGCAGGCGAGTTGCAGCCTGCAATCCGAACTGAGACCGGCTTTTAAGGATTGGC
TCCATCTTGCGATATTGCTTCCCGTTGTACCGGCCATTGTAGTACGTGTGTAGCCCAAGTCATAAGGGG
CATGATGATTTGACGTCATCCCCACCTTCCTCCGGTTTGTCACCGGCAGTCTGCTTAGAGTGCCCACCA
TGATGTGCTGGCAACTAAGCATAAGGGTTGCGCTCGTTGCGGGACTTAACCCAACATCTCACGACACG
AGCTGACGACAACCATGCACCACCTGTCTCCTTTGTCCCGAAGGAAAAGACTATCTCTAGTCCGGTCA
AAGGGATGTCAAGACTTGGTAAGGTTCTTCGCGTTGCTTCGAATTAAACCACATACTCCACTGCTTGTG
CGGGTCCCCGTCAATTCCTTTGAGTTTCAGTCTTGCGACCGTACTCCCCAGGCGGAATGCTTAATGTGT
TAACTTCGGCACCAAGGGTATCGAAACCCCTAACACCTAGCATTCATCGTTTACGGCGTGGACTACCA
GGGTATCTAATCCTGTTTGCTCCCCACGCTTTCGCGCCTCAGCGTCAGTTACAGCCCAGAAAGTCGCCT
TCGCCACTGGTGTTCCTCCACATCTCTACGCATTTCACCGCTACACGTGGAANTTCCACTTTCCTCTTCT
GTACTCAAGCTCTCCAGTTTCCAGTGCGACCCAAGGTTGAGCCTTGGGCTGTGACACCGGACTTAAAA
AGCCGCCTGCGCGCGCTTTACGCCCAATAATTCCGGACAACGCTTGCCCCCTACGTATTACCGCGGCTG
CTGGCACGTAGTTAGCCGGGGCTTT
Pantoea sp. (strain #4) (16S rDNA)
(SEQ ID NO: 6)
GGTATGCACTCCCCGGGTGGCTAGCCACCCTACTTCTTTTGCACCCCCCTCCCTTGTTGTGACGGGGGG
TGTGTACAAGGCCCGGGAAGGTATTACCCGGGGAATTCTGTTCACCGATAACTGGCGATTCCGACTTC
AGGGAGCCGAGTTGCAGATTCCGATCCGGACAACGCCGCATTTTATGAGGTCCGTTGGCTCTCGCGGG
GTCGCTTCTCTTTGTTGGCGCCATGGAAGCACGTGTGTAGCCCTACTCGTAAGGGCCATGTTGCCTTGC
CGTCATCCCCACCTTCCTCCGGTTTATCACCGGCAGTCTCTTTTGAGTTCCCGACCGAATCGCTGGCAA
CAAAGGTTAAGGGTTGCGCTCGTTGCGGGATTTAACCCAACATTTCACAACACGAGCTGCCGACAGCC
ATGCAGCACCTGTCTCAAATTTCCCGAAGGAAAAAAGGAATCTCTGCCTCTTCGTCGGGTTGTCAAGA
GTAGGTAAGGTTCTTCGCGTTGCATCGAATTAAACCACATGCTCCACCCTTGTGCGGGCCCCCCGTCAA
TTCATTTGATTTTAAACCTTGCGGCCGAATTCCCAGGGCGGCCGCTTAACCGCGTAACCTCCGGAACCC
CCTCCCCAGGGAAAAACCCTCCAATCCAAATTCTTTAAGGGGGGGAATAACAGGGGAACCAATCCTG
GTTTCTTCCCACGCCTTCGGCACCGGACGGCAGTCCTCGGTCAAGGGGGCGCCCTTCCCCCCCGGAATT
CCTCCGAACTCCAATCCTTTTACCCCCTCTCCCGGAAATCTAACCCCCTTTAACAAATTTCAAGCCGGC
CGTTTTCAATGGAAGTTCCCGGTTAAAGCCGGGGGCTTTACATTCGAATTTAAAAAACCCCCGGGCGG
CGTTTTAGCCCCAGAATTTCCAATTAAGCTTGGAACCCTCTTAATAACCTCGATGGCTGGACCGATTTA
AACAGAGCCTTTTCCGGGGGGATCGGTCATCCAATG
Pantoea sp. (strain #5) (16S rDNA)
(SEQ ID NO: 7)
GGGGAGTATGCTGCGGGTTGTACCACATAGCTTCGGGAGGGAAAATACTTTCAGTGGGGGTGCTAACA
TTCTTTCAGTGGCCGAGTCGATGACGTTACCCACAGGAGTAGATTCGGGTAACCCCGTGCAAGCGCCC
GCGCTAATTCGGAGGCAGCAGGCCCGATTAGGAGTTAGTGGCCAGAAAGAGTAGGCAGGAGTTGGCG
TAAAGCGCATGCGGACGCCCGGGGCATTCAGATGGGAATGCCCTGGAATCTGGCAGGCAAGAGCATT
GTAAAGGGGGGGAGAATTCCATGTGAGGCGGGGAAAGGAGTAGAGGTGTAGCGGAAAACCGGGGGG
AGAGGCGGCCCCCTGCCGGAAGAGAGGCGGTCAGCTGCGAAAGCGAGGGGAGCAAACAGGATTAGG
TGCCCTGATCATCCACGCTTTGATCGATGTCGACTCCGAGCTTGTTCCGATGTCGACTGGGATCTGGAG
CTCACGCGTTAAGGCGTCCGCAGGGAGAGTACGACCGCAAGGTTAAAACTCAAACGAATGGAAGGGG
ACCCGCACAAGCGGTGGAGCATGTGGTTTAATTCGATGCAACGCGAAGAACCTTACCTACTCTTGACA
AAGAACCTTACCTACAGAGATCATCCAGTGCCTTCGGGAGAGATGAGACAGGTGCTGCATGGCTGTCG
TCAGCTCGTGTTGTGAAATGTTGGGTTAACGCCCGCAACGAGCGCAACCCTTATCCTTTGTTGCCAGCG
ATTCGGTCGGGAACTCAAAGGAGACTGCCGGGGATAAACCGGAGGAAGGTGGGGATGACGACAAGA
CACATGGCCCTTACGAGTAGGGCTACACACGTGCTACAATGGCGCCTACAAAGAGAAGCGACCGCGC
GAGAGCAAGCGGACCTCATAAACTGCGGCGTACGCCGGATCGGAATCTGCAACTCGACCGGGTGAAA
TCGGAATCGCCGGTAATCGGAGATCAGAATCCCACGGTAAATACGTTCCCAGGCCTTGTACACATACG
TTCCCGGACCATGGGAGCAGGTTGCAAAAGAAGATGGGAGTGGGTTGTAAAAGAAGTAGGTAGCTTA
ACCTTCGGGAGGGCGCTACC
Aureobasidium pullulans (strain Froelichia #2)
(SEQ ID NO: 8; NRRL No. B-68181)
CCGTAGGGTGAACCTGCGGAAGGATCATTAAAGAGTAAGGGTGCTCAGCGCCCGACCTCCAACCCTTT
GTTGTTAAAACTACCTTGTTGCTTTGGCGGGACCGCTCGGTCTCGAGCCGCTGGGGATTCGTCCCAGGC
GAGCGCCCGCCAGAGTTAAACCAAACTCTTGTTATCAAACCGGTCGTCTGAGTTAAAATTTTGAATAA
ATCAAAACTTTCAACAACGGATCTCTTGGTTCTCGCATCGATGAAGAACGCAGCGAAATGCGATAAGT
AATGTGAATTGCAGAATTCAGTGAATCATCGAATCTTTGAACGCACATTGCGCCCCTTGGTATTCCGAG
GGGCATGCCTGTTCGAGCGTCATTACACCACTCAAGCTATGCTTGGTATTGGGTGCCGTCCTTAGTTGG
GCGCGCCTTAAAGACCTCGGCGAGGCCTCACCGGCTTTAGGCGTAGTAGAATTTATTCGAACGTCTGT
CAAAGGAGAGGACTTCTGCCGACTGAAACCTTTATTTTTCTAGTTGACCTCGGATCAGGTAGGGATAC
CCGCTGAACTTAAGCATATCAATAAGCGGAGGAA
OVLBP2R Methylobacter sp.
(SEQ ID NO: 9)
TCGAGTTGCAGAGTGCAATCTGAACTGAGACGGTTTTTGGGGATTTGCTCCAGATCGCTCCTTGCGTCC
CACTGTCACCGCCATTGTAGCACGTGTGTAGCCCATCCCGTAAGGGCCATGAGGACTTGACGTCATCC
ACACCTTCCTCGCGGCTTATCACCGGCAGTCTCCCTAGAGTGCCCAACTGAATGATGGCAACTAAGGA
CGTGGGTTGCGCTCGTTGCGGGACTTAACCCAACATCTCACGACACGAGCTGACGACAGCCATGCAGC
ACCTGTGTTCGCGTCCCCGAAGGGAACCCCGGATCTCTCCGGATGGCACGACATGTCAAGGGATGGTA
AGGTTCTGCGCGTTGCTTCGAATTAAACCACATGCTCCACCGCTTGTGCGGGCCCCCGTCAATTCCTTT
GAGTTTTAATCTTGCGACCGTACTCCCCAGGCGGAATGCTTAAAGCGTTAGCTGCGCTACTGCGGTGC
AAGCACCCCAACAGCTAGCATTCATCGTTTACGGCGTGGACTACCAGGGTATCTAATCCTGTTTGCTCC
CCACGCTTTCGCGCCTCAGCGTCAGTAATGGCCCAGTCAGCCGCCTTCGCCACTGGTGTTCTTGCGAAT
ATCTACGAATTTCACCTCTACACTCGCAGTTCCACTGACCTCTGCCATACTCAAGCCAAACAGTATCGA
AGGCAATTCTGTGGTTGAGCCACAGGCTTTCACCCCCGACTTGAATGGCCGCCTACGCGCCCTTTACGC
CCAGTGATTCCGAGCAACGCTAGCCCCCTTCGTATTACCGCGGCTGCTGGCACGAAGTTAGCCGGGGC
TTATTCTTCCGGTACCGTCATTATCGTCCCGGACAAAAGAGCTTTACAACCCTAAGGCCTTCATCACTC
ACGCGGCATGGCTGGATCAGGCTTGCGCCCATTGTCCAATATTCCCCACTGCTGCCTCCCGTAGGAGTC
TGGGCCGTGTCTCAGTCCCAGTGTGGCTGATCATCCTCTCAGACCAGCTACTGATCGTCGCCTTGGTAG
GCCATTACCCCACCAACTAGCTAATCAGACGCGGGCCGATCCTTCGGCAGTAAACCTTTCCCCAGGGC
CAGAGGCCATGGGCGTATCCGGTATTAGCGCTAGTTTCCCAGCGTTATTCCGAACCGAAGGGTACGTT
CCCACGTGTTACTCACCCGTCTGCCGCTGACACCGAAGTGCCCGCTCGACTTCC
OVYP4AD19 ID: Sphingomonas sp.
(SEQ ID NO: 10)
ACTAGCGATTCCGCCTTCATGCTCTCGAGTTGCAGAGAACAATCCGAACTGAGACGGCTTTTGGAGAT
TAGCGCACACTCGCGTGCTTGCTGCCCACTGTCACCGCCATTGTAGCACGTGTGTAGCCCAGCGCGTA
AGGGCCATGAGGACTTGACGTCATCCCCACCTTCCTCCGGCTTATCACCGGCGGTTCCTTTAGAGTCCC
CAACTGAATGATGGTAACTAAAGGCGAGGGTTGCGCTCGTTGCGGGACTTAACCCAACATCTCACGAC
ACGAGCTGACGACAGCCATGCAGCACCTGTGTTCCAGTCCCCGAAGGGAAGAGATCCATCTCTGGAAA
TCGTCCGGACATGTCAAACGCTGGTAAGGTTCTGCGCGTTGCTTCGAATTAAACCACATGCTCCACCGC
TTGTGCAGGCCCCCGTCAATTCATTTGAGTTTTAACCTTGCGGCCGTACTCCCCAGGCGGATAACTTAA
TGCGTTAGCTGCGCCACCCAAAGACCAAGTCCCCGGACAGCTAGTTATCATCGTTTACGGCGTGGACT
ACCAGGGTATCTAATCCTGTTTGCTCCCCACGCTTTCGCACCTCAGCGTCAATACCAGTCCAGTGAGCC
GCCTTCGCCACTGGTGTTCTTCCGAATATCTACGAATTTCACCTCTACACTCGGAATTCCACTCACCTCT
CCTGGATTCAAGCCATGCAGTATCAAAGGCAATTCTGGGGTTGAGCCCCAGGCTTTCACCTCTAACTTA
CAAAGCCGCCTACGTGCGCTTTACGCCCAGTAATTCCGAACAACGCTAGCTCCCTCCGTATTACCGCG
GCTGCTGGCACGGAGTTAGCCGGAGCTTAT
Aa15 ID: Bacillus sp.
(SEQ ID NO: 11)
GCTAATACCGGATAACATTTTGAACTGCATGGTTCGAAATTGAAAGGCGGCTTCGGCTGTCACTTATG
GATGGACCCGCGTCGCATTAGCTAGTTGGTGAGGTAACGGCTCACCAAGGCAACGATGCGTAGCCGAC
CTGAGAGGGTGATCGGCCACACTGGGACTGAGACACGGCCCAGACTCCTACGGGAGGCAGCAGTAGG
GAATCTTCCGCAATGGACGAAAGTCTGACGGAGCAACGCCGCGTGAGTGATGAAGGCTTTCGGGTCGT
AAAACTCTGTTGTTAGGGAAGAACAAGTGCTAGTTGAATAAGCTGGCACCTTGACGGTACCTAACCAG
AAAGCCACGGCTAACTACGTGCCAGCAGCCGCGGTAATACGTAGGTGGCAAGCGTTATCCGGAATTAT
TGGGCGTAAAGCGCGCGCAGGTGGTTTCTTAAGTCTGATGTGAAAGCCCACGGCTCAACCGTGGAGGG
TCATTGGAAACTGGGAGACTTGAGTGCAGAAGAGGAAAGTGGAATTCCATGTGTAGCGGTGAAATGC
GTAGAGATATGGAGGAACACCAGTGGCGAAGGCGACTTTCTGGTCTGTAACTGACACTGAGGCGCGA
AAGCGTGGGGAGCAAACAGGATTAGATACCCTGGTAGTCCACGCCGTAAACGATGAGTGCTAAGTGT
TAGAGGGTTTCCGCCCTTTAGTGCTGAAGTTAACGCATTAAGCACTCCGCCTGGGGAGTA
Aa2 ID: Bacillus sp. NRRL No. 68178
(SEQ ID NO: 12)
GATGGTTCGAAATTGAAAGGCGGCTTCGGCTGTCTTTTATGGATGGACCCGCGTCGCATTAGCTAGTTG
GTGAGGTAACGGCTCACCAAGGCAACGATGCGTAGCCGACCTGAGAGGGTGATCGGCCACACTGGGA
CTGAGACACGGCCCAGACTCCTACGGGAGGCAGCAGTAGGGAATCTTCCGCAATGGACGAAAGTCTG
TCAAGGCTTGCGCTCGTTGCGGGTGTTAACCCAACATCCCACGACACGAGCTGTCGACAACCATGCAC
CACCTGTCACTCTGCTCCCGACCGTGAAGCCCTATCTCTAGGGTTTTCAGAGGAAGTCAAGGCCTGGTA
ACGCTCTAATACGTAGGTGGCAAGCGTTATCATGCTCTACCGCTCGTGCGGCGCCCGGTCGTTTCCTTT
GAATTTTGACCTGGCAGCCGACGTCCCAACGGGGGATGGTCATTGGAAAATGTGAAGCTTGAATGGAG
GAAAGGCCTCTGGAACTTAGTGTTTAGCGTTGAAGGGGGGAGATACCTGGATGACTAACCCTGGTGAA
TCCGCACTCTTTGTCTGCACCTGGCCCTGTAGAGCGAAAACGTGCGGCTCCAACAGGGTTGGATCCCCT
GGTATCTACCGCCTTAAACGATGAGCGTGGAATGTTAGTTGCCTCTCCCCCTTTAAAGTTGACGTGTTC
GCATTGAGCACTCCGGCTGGGGACTAGGGCTTCAAGGTTGAAATTCAAAAGAATTGAGGGGGGGCCT
CACGACCGGTGGAGCATGAG
Aa3a ID: Bacillus sp.
(SEQ ID NO: 13; NRRL No. B68173)
ATTACTAGCGATTCCAGCTTCATGTAGGCGAGTTGCAGCCTACAATCCGAACTGAGAACGGTTTTATG
AGATTAGCTCCACCTCGCGGTCTTGCAGCTCTTTGTACCGTCCATTGTAGCACGTGTGTAGCCCAGGTC
ATAAGGGGCATGATGATTTGACGTCATCCCCACCTTCCTCCGGTTTGTCACCGGCAGTCACCTTAGAGT
GCCCAACTTAATGATGGCAACTAAGATCAAGGGTTGCGCTCGTTGCGGGACTTAACCCAACATCTCAC
GACACGAGCTGACGACAACCATGCACCACCTGTCACTCTGCTCCCGAAGGAGAAGCCCTATCTCTAGG
GTTTTCAGAGGATGTCAAGACCTGGTAAGGTTCTTCGCGTTGCTTCGAATTAAACCACATGCTCCACCG
CTTGTGCGGGCCCCCGTCAATTCCTTTGAGTTTCAGCCTTGCGGCCGTACTCCCCAGGCGGAGTGCTTA
ATGCGTTAACTTCAGCACTAAAGGGCGGAAACCCTCTAACACTTAGCACTCATCGTTTACGGCGTGGA
CTACCAGGGTATCTAATCCTGTTTGCTCCCCACGCTTTCGCGCCTCAGTGTCAGTTACAGACCAGAAAG
TCGCCTTCGCCACTGGTGTTCCTCCATATCTCTACGCATTTCACCGCTACACATGGAATTCCACTTTCCT
CTTCTGCACTCAAGTCTCCCAGTTTCCAATGACCCTCCACGGGTTGAGCCGTGGGCTTTCACATCAGAC
TTAAGAAACCACCTGCGCGCGCTTTACGCCCAATAATTCCGGATAACGCTTGCCACCTACGTATTACCG
CGGCTGCTGGCACGTAGTTAGCCGTGGCTTTCTGGGTT
OMYESP3B ID: Terribacillus sp.
(SEQ ID NO: 14; NRRL No. B-68179)
GATTCCGGCTTCATGCAGGCGAGTTGCAGCCTGCAATCCGAACTGAGAATGGTTTTATGGGATTTGCTT
AGCCTCGCGGCTTCGCTGCCCTTTGTACCATCCATTGTAGCACGTGTGTAGCCCAGGTCATAAGGGGCA
TGATGATTTGACGTCATCCCCACCTTCCTCCGGTTTGTCACCGGCAGTCACTCTAGAGTGCCCAACTGA
ATGCTGGCAACTAGAATCAAGGGTTGCGCTCGTTGCGGGACTTAACCCAACATCTCACGACACGAGCT
GACGACAACCATGCACCACCTGTCACGCTGTCCCCGAAGGGAACGCCTTGTCTCCAAGGTTGTCAGCG
GATGTCAAGACCTGGTAAGGTTCTTCGCGTTGCTTCGAATTAAACCACATGCTCCACCGCTTGTGCGGG
CCCCCGTCAATTCTTTTGAGTTTCAGCCTTGCGGCCGTACTCCCCAGGCGGAGTGCTTAATGCGTTAAC
TTCAGCACTAAGGGGCGGAAACCCCCTAACACCTAGCACTCATCGTTTACGGCGTGGACTACCAGGGT
ATCTAATCCTGTTTGCTCCCCCACGCTTTCGCGCCTCAGCGTCAGTTACAGACCAGAGAGTCGCCTTCG
CCACTGGTGTTCCTCCACATATCTACGCATTTCACCGCTACACGTGGAATTCCACTCTCCTCTTCTGCAC
TCAAGTTCCCCAGTTTCCAATGACCCTCCACAGTTAAGCTGTGGGCTTTCACATCA
OMPDAP5BK ID: Bacillus sp.
(SEQ ID NO: 15; NRRL No. B-68180)
CGGATAGTTCCTTGAACCGCATGGTTCAAGGATGAAAGACGGTTTCGGCTGTCACTTACAGATGGACC
CGCGGCGCATTAGCTAGTTGGTGGGGTAATGGCTCACCAAGGCGACGATGCGTAGCCGACCTGAGAG
GGTGATCGGCCACACTGGGACTGAGACACGGCCCAGACTCCTACGGGAGGCAGCAGTAGGGAATCTT
CCGCAATGGACGAAAGTCTGACGGAGCAACGCCGCGTGAGTGATGAAGGTTTTCGGATCGTAAAGCT
CTGTTGTTAGGGAAGAACAAGTGCGAGAGTAACTGCTCGCACCTTGACGGTACCTAACCAGAAAGCCA
CGGCTAACTACGTGCCAGCAGCCGCGGTAATACGTAGGTGGCAAGCGTTGTCCGGAATTATTGGGCGT
AAAGGGCTCGCAGGCGGTTTCTTAAGTCTGATGTGAAAGCCCCCGGCTCAACCGGGGACGGTCATTGG
AAACTGGGAAACTTGAGTGCAGAAGAGGAGAGTGGAAGTACACGTGTAGCGGTGAAATGCGTAGAGA
TGTGGAGAAACAGCGGTGGA
Pp16 ID: Pseudomonas sp.
(SEQ ID NO: 16)
CTAGCGATTCCGACTTCACGCAGTCGAGTTGCAGACTGCGATCCGGACTACGATCGGTTTTATGGGATT
AGCTCCACCTCGCGGCTTGGCAACCCTCTGTACCGACCATTGTAGCACGTGTGTAGCCCAGGCCGTAA
GGGCCATGATGACTTGACGTCATCCCCACCTTCCTCCGGTTTGTCACCGGCAGTCTCCTTAGAGTGCCC
ACCATAACGTGCTGGTAACTAAGGACAAGGGTTGCGCTCGTTACGGGACTTAACCCAACATCTCACGA
CACGAGCTGACGACAGCCATGCAGCACCTGTCTCAATGTTCCCGAAGGCACCAATCTATCTCTAGAAA
GTTCATTGGATGTCAAGGCCTGGTAAGGTTCTTCGCGTTGCTTCGAATTAAACCACATGCTCCACCGCT
TGTGCGGGCCCCCGTCAATTCATTTGAGTTTTAACCTTGCGGCCGTACTCCCCAGGCGGTCAACTTAAT
GCGTTAGCTGCGCCACTAAAAGCTCAAGGCTTCCAACGGCTAGTTGACATCGTTTACGGCGTGGACTA
CCAGGGTATCTAATCCTGTTTGCTCCCCACGCTTTCGCACCTCAGTGTCAGTATTAGTCCAGGTGGTCG
CCTTCGCCACTGGTGTTCCTTCCTATATCTACGCATTTCACCGCTACACAGGAAATTCCACCACCCTCT
ACCATACTCTAGTCAGTCAGTTTTGAATGCAGTTCCCAGGTTGAGCCCGGGGATTTCACATCCAACTTA
ACAAACCACCTACGCGCGCTTTACGCCCAGTAA
PP21 ID: Exiguobacterium sp.
(SEQ ID NO: 17)
ACCGAATAGTTCTTCAGACCGCATGGTCTGATGATGAAAGGCGCTCCGGCGTCACCTTGGGATGGCCT
TGCGGTGCATTAGCTAGTTGGTGGGGTAATGGCCCACCAAGGCGACGATGCATAGCCGACCTGAGAG
GGTGATCGGCCACACTGGGACTGAGACACGGCCCAGACTCCTACGGGAGGCAGCAGTAGGGAATCTT
CCACAATGGACGAAAGTCTGATGGAGCAACGCCGCGTGAGTGATGAAGGTTTTCGGATCGTAAAACTC
TGTTGTAAGGGAAGAACAAGTACGAGAGGTAATGCTCGTACCTTGACGGTACCTTGCGAGAAAGCCA
CGGCTAACTACGTGCCAGCAGCCGCGGTAATACGTAGGTGGCAAGCGTTGTCCGGAATTATTGGGCGT
AAAGCGCGCGCAGGCGGCCTTTTAAGTCTGATGTGAAAGCCCCCGGCTCAACCGGGGAGGGTCATTGG
AAACTGGAAGGCTTGAGTACAGAAGAGAAGAGTGGAATTCCATGTGTAGCGGTGAAATGCGTAGAGA
TGTGGAGGAACACCAGTGGCGAAGGCGACTCTTTGGTCTGTAACTGACGCTGAGGCGCGAAAGCGTG
GGGAGCAAACAGGATTAGATACCCTGGTAGTCCACGCCGTAAACGATGAGTGCTAGTGTTGGGGGGTT
TCCGCCCCTCAGTGCTGAAGCTAACGCATTAAGCACTCCGCCTGGGGAGTACGGCCGCAAGGCTGAAA
CTCAAGGAATTGACGGGGACCCGCACAAGCGGTGGAGCATGTGGTTTAATTCGA
Pp4F ID. Pseudomonas sp.
(SEQ ID NO: 18)
TAGCTACTTCTGGTGCAACCCACTCCCATGGTGTGACGGGCGGTGTGTACAAGGCCCGGGAACGTATT
CACCGCGACATTCTGATTCGCGATTACTAGCGATTCCGACTTCACGCAGTCGAGTTGCAGACTGCGATC
CGGACTACGATCGGTTTTGTGAGATTAGCTCCACCTCGCGGCTTGGCGACCCTCTGTACCGACCATTGT
AGCACGTGTGTAGCCCAGGCCGTAAGGGCCATGATGACTTGACGTCATCCCCACCTTCCTCCGGTTTGT
CACCGGCAGTCTCCTTAGAGTGCCCACCATAACGTGCTGGTAACTAAGGACAAGGGTTGCGCTCGTTA
CGGGACTTAACCCAACATCTCACGACACGAGCTGACGACAGCCATGCAGCACCTGTGTCAGAGTTCCC
GAAGGCACCAATCCATCTCTGGAAAGTTCTCTGCATGTCAAGGCCTGGTAAGGTTCTTCGCGTTGCTTC
GAATTAAACCACATGCTCCACCGCTTGTGCGGGCCCCCGTCAATTCATTTGAGTTTTAACCTTGCGGCC
GTACTCCCCAGGCGGTCAACTTAATGCGTTAGCTGCGCCACTAAAATCTCAAGGATTCCAACGGCTAG
TTGACATCGTTTACGGCGTGGACTACCAGGGTATCTAATCCTGTTTGCTCCCCACGCTTTCGCACCTCA
GTGTCAGTATCAGTCCAGGTGGTCGCCTTCGCCACTGGTGTTCCTTCCTATATCTACGCATTTCACCGCT
ACACAGGAAATTCCACCACCCTCTACTGTACTCTAGCTTGCCAGTTTTGGATGCAGTTCCCAGGTTGAG
CCCGGGGCTTTCACATCCAACTTAACAAACCACCTACGCGCGCTTTACGCCCAGTAATTCCGATTAACG
CTTGCACCCTCTGTATTACCGCGGCTGCTGGCACAGAGTTAGCCGGTGCTTATTCTGTCGGTAACGTCA
AAACAGCAAGGTATTCGCTTACTGCCCTTCCTCCCAACTTAAAGTGCTTTACAATCCGAAGACCTTCTT
CACACACGCGGCATGGCTGGATCAGGCTTTCGCCCATTGTCCAATATTCCCCACTGCTGCCTCCCGTAG
GAGTCTGGACCGTGTCTCAGTTCCAGTGTGACTGATCATCCTCTCAGACCAGTTACGGATCGTCGCTT
GGTGAGCCATTACCCCACCAACTAGCTAATCCGACCTAGGCTCATCTGATAGCGCAAGGCCCGAAGGT
CCCCTGCTTTCTCCCGTAGGACGTATGCGGTATTAGCGTTCCTTTCGAAACGTTGTCCCCCACTACCAG
GCAGATTCCTAGGCATTACTCACCCGTCCGCCGCTGAATCGAAGAGCAAGC
Isolate 7 (16F, 27) Pantoea sp.
(SEQ ID NO: 19)
TGCAAGTCGGACGGTAGCACAGAGAGCTTGCTCTCGGGTGACGAGTGGCGGACGGGTGAGTAATGTC
TGGGGATCTGCCCGATAGAGGGGGATAACCACTGGAAACGGTGGCTAATACCGCATAACGTCGCAAG
ACCAAAGAGGGGGACCTTCGGGCCTCTCACTATCGGATGAACCCAGATGGGATTAGCTAGTAGGCGG
GGTAATGGCCCACCTAGGCGACGATCCCTAGCTGGTCTGAGAGGATGACCAGCCACACTGGAACTGA
GACACGGTCCAGACTCCTACGGGAGGCAGCAGTGGGGAATATTGCACAATGGGCGCAAGCCTGATGC
AGCCATGCCGCGTGTATGAAGAAGGCCTTCGGGTTGTAAAGTACTTTCAGCGGGGAGGAAGGCGATG
GGGTTAATAACCCTGTCGATTGACGTTACCCGCAGAAGAAGCACCGGCTAACTCCGTGCCAGCAGCCG
CGGTAATACGGAGGGTGCAAGCGTTAATCGGAATTACTGGGCGTAAAGCGCACGCAGGCGGTCTGTT
AAGTCAGATGTGAAATCCCCGGGCTTAACCTGGGAACTGCATTTGAAACTGGCAGGCTTGAGTCTTGT
AGAGGGGGGTAGAATTCCAGGTGTAGCGGTGAAATGCGTAGAGATCTGGAGGAATACCGGTGGCGAA
GGCGGCCCCCTGGACAAAGACTGACGCTCAGGTGCGAAAGCGTGGGGAGCAAACAGGATTAGATACC
CTGGTAGTCCACGCCGTAAACGATGTCGACTTGGAGGTTGTTCCCTTGAGGAGTGGCTTCCGGAGCTA
ACGCGTTAAGTCGACCGCCTGGGGAGTACGGCCGCAAGGTTAAAACTCAAATGAATTGACGGGGGCC
CGCACAAGCGGTGGAGCATGTGGTTTAATTCGATGCAACGCGAAGAA
isolate 8 (16R, 1492 Pantoea sp.
(SEQ ID NO: 20)
GGTAGCGCCCTCCCGAAGGTTACGTTCCCTACTTTTTTCTACCCCCTCTCCTTTGGTCCCACTCCCGTGG
TGTACAAGGCCCGGGGAAGTAGGCACCGTGGCATACTGATCGACGATTTCTGGCGATTCCGACTTCAC
GGTTTCGAGTTGCAGGCTCCGATCCGGAGAACGCCGCACTTTATGAGATCCGCTTGCTCTCGCGAGGT
CGCTTCTCTTTGTATGCGCCATTGTAGCACGTGTGTAGCCCTACTCGTAAGGGCCATGTTGTCTTGGCG
TCATCCCCACCTTCCTCCGGTTTATCACCGGCAGTCTCCTTTGAGTTCCCGACCGAATCGCTGGCAACA
AAGGGCAAGGGTTGCGCTCGTTGCGGGGCTTAACCCAACATTTCACAACACGAGCTGACGAACACGA
GCTGACGACAGCCATGCAGCACCTGTCTGCACGCACCCGAAGGTGCTAAAGCATCTCTATGTCAAGAG
TAGGATGTCAAGAGTAGGTAAGATTCTTCGCGTTGCATCGAATTAAACCACATGCTCCACCGCTTGTG
CGGGCCCCCGTCAATTCATTTGAGTTTTAACCTTGCGGCCGTACTCCCCAGGCGGTCGACTTAACGCGT
TAGCTCCGGAAGCCACTCCTCAAGGGAACAACCTCTAAGTCGACATCGTTTACGGCGTGGACTACCAG
GGTATCTAATCCTGTTTGCTCCCCACGCTTTCGCACCTGAGCGTCAGTCTTCGTCCAGGGGGCCGCCTT
CGCCACCGGTATTCCTCCAGATCTCTACGCATTTCACCGCTACACCAGAAATTCTACCCCCCTCTACGA
GATTCAAGCCTGCCGGTTTTAAATGCAGTTCCCAGGGTCAGCCCGGGGATTTCACATCTGATTCAACA
GAACGCCTGCGTGCGCTTTACGCCCAGGAATTCCGATTAACGCTTGCACCCTCCGTATTACCGGGGCTG
CTGGTACGGAGATAGCCGGAGCTTCTCCTGCGGGGAATGGCGATCGAATA
isolate 9 (16R, 1492) Pantoea sp.
(SEQ ID NO: 21)
AGCGCCCTCCCGAAGGTTAAGCTACCTACTTCTTTTGCAACCCACTCCCATGGTGTGACGGGCGGTGTG
TACAAGGCCCGGGAACGTATTCACCGTGGCATTCTGATCCACGATTACTAGCGATTCCGACTTCACGG
AGTCGAGTTGCAGACTCCGATCCGGACTACGACGCACTTTATGAGGTCCGCTTGCTCTCGCGAGGTCG
CTTCTCTTTGTATGCGCCATTGTAGCACGTGTGTAGCCCTACTCGTAAGGGCCATGATGACTTGACGTC
ATCCCCACCTTCCTCCGGTTTATCACCGGCAGTCTCCTTTGAGTTCCCGACCGAATCGCTGGCAACAAA
GGATAAGGGTTGCGCTCGTTGCGGGACTTAACCCAACATTTCACAACACGAGCTGACGACAGCCATGC
AGCACCTGTCTCAGAGTTCCCGAAGGCACCAAAGCATCTCTGCTAAGTTCTCTGGATGTCAAGAGTAG
GTAAGGTTCTTCGCGTTGCATCGAATTAAACCACATGCTCCACCGCTTGTGCGGGCCCCCGTCAATTCA
TTTGAGTTTTAACCTTGCGGCCGTACTCCCCAGGCGGTCGACTTAACGCGTTAGCTCCGGAAGCCACTC
CTCAAGGGAACAACCTCCAAGTCGACATCGTTTACGGCGTGGACTACCAGGGTATCTAATCCTGTTTG
CTCCCCACGCTTTCGCACCTGAGCGTCAGTCTTCGTCCAGGGGGCCGCCTTCGCCACCGGTATTCCTCC
AGATCTCTACGCATTTCACCGCTACACCTGGAATTCTACCCCCCTCTACGAGACTCAAGCCTGCCAGTT
TCAAATGCAGTTCCCAGGTTAAGCCCGGGGA
isolate 10 (16R, 1492) Pantoea sp.
(SEQ ID NO: 22)
TACTRTTTTTGCAACCCACTCCCATGGNTGTGACGGGCGGTGTGTACAAGGCCCGGGAACGTATTCAC
CGTGGCATTCTGATCCACGATTACTAGCGATTCCGACTTCACGGAGTCGAGTTGCAGACTCCGATCCG
GACTACGACGCACTTTATGAGGTCCGCTTGCTCTCGCGAGGTCGCTTCTCTTTGTATGCGCCATTGTAG
CACGTGTGTAGCCCTACTCGTAAGGGCCATGATGACTTGACGTCATCCCCACCTTCCTCCGGTTTATCA
CCGGCAGTCTCCTTTGAGTTCCCGACCGAATCGCTGGCAACAAAGGATAAGGGTTGCGCTCGTTGCGG
GACTTAACCCAACATTTCACAACACGAGCTGACGACAGCCATGCAGCACCTGTCTCAGAGTTCCCGAA
GGCACCAAAGCATCTCTGCTAAGTTCTCTGGATGTCAAGAGTAGGTAAGGTTCTTCGCGTTGCATCGA
ATTAAACCACATGCTCCACCGCTTGTGCGGGCCCCCGTCAATTCATTTGAGTTTTAACCTTTGCGGCCGT
ACTCCCCAGGCGGTCGACTTAACGCGTTAGCTCCGGAAGCCACTCCTCAAGGGAACAACCTCCAAGTC
GACATCGTTTACGGCGTGGACTACCAGGGTATCTAATCCTGTTTGCTCCCCACGCTTTCGCACCTGAGC
GTCAGTCTTCGTCCAGGGGGCCGCCTTCGCCACCGGTATTCCTCCAGATCTCTACGCATTTCACCGCTA
CACCTGGAATTCTACCCCCCTCTACGAGACTCAAGCCTGCCAGTTTCAAATGCAGTTCCCAGGTTTAAGC
CCGGGGATTTCACATCTGACTTAACAGACCGCCTGCGTGCGCTTTACGCCCAGTAATTTCCGATTAACG
CTTGCA
Isolate 11 (16F, 27) Staphylococcus sp.
(SEQ ID NO: 23)
TGCAAGTCGAGCGAACAGATAAGGAGCTTGCTCCTTTGACGTTAGCGGCGGACGGGTGAGTAACACGT
GGGTAACCTACCTATAAGACTGGGATAACTTCGGGAAACCGGAGCTAATACCGGATAACATTTGGAAC
CGCATGGTTCTAAAGTGAAAGATGGTTTTGCTATCACTTATAGATGGACCCGCGCCGTATTAGCTAGTT
GGTAAGGTAACGGCTTACCAAGGCGACGATACGTAGCCGACCTGAGAGGGTGATCGGCCACACTGGA
ACTGAGACACGGTCCAGACTCCTACGGGAGGCAGCAGTAGGGAATCTTCCGCAATGGGCGAAAGCCT
GACGGAGCAACGCCGCGTGAGTGATGAAGGGTTTCGGCTCGTAAAACTCTGTTATTAGGGAAGAACA
AATGTGTAAGTAACTGTGCACATCTTGACGGTACCTAATCAGAAAGCCACGGCTAACTACGTGCCAGC
AGCCGCGGTAATACGTAGGTGGCAAGCGTTATCCGGAATTATTGGGCGTAAAGCGCGCGTAGGCGGTT
TCTTAAGTCTGATGTGAAAGCCCACGGCTCAACCGTGGAGGGTCATTGGAAACTGGGAAACTTGAGTG
CAGAAGAGGAAAGTGGAATTCCATGTGTAGCGGTGAAATGCGCAGAGATATGGAGGAACACCAGTGG
CGAAGGCGACTTTCTGGTCTGTAACTGACGCTGATGTGCGAAAGCGTGGGGATCAAACAGGATTAGAT
ACCCTGGTAGTCCACGCCGTAAACGATGAGTGCTAAGTGTTAGGGGGTTTCCGCCCCTTAGTGCTGCA
GCTAACGCATTAAGCACTCCGCCTGGGGAGTACGACCGCAAGGTTGAAACTCAAAGGAATTGACGGG
GACCCGCACAAGCGGTGGAGCATGTGGTTTAATTCGAAGCAACGCGAAGAA
Isolate 13 (1492) Pantoea sp,
(SEQ ID NO: 24)
GGTAAGCGCCCTCCCGAAGGTTAAGCTACCTACTTCTTTTGCAACCCACTCCCATGGTGTGACGGGCG
GTGTGTACAAGGCCCGGGAACGTATTCACCGTGGCATTCTGATCCACGATTACTAGCGATTCCGACTTC
ACGGAGTCGAGTTGCAGACTCCGATCCGGACTACGACGCACTTTATGAGGTCCGCTTGCTCTCGCGAG
GTCGCTTCTCTTTGTATGCGCCATTGTAGCACGTGTGTAGCCCTACTCGTAAGGGCCATGATGACTTGA
CGTCATCCCCACCTTCCTCCGGTTTATCACCGGCAGTCTCCTTTGAGTTCCCGACCGAATCGCTGGCAA
CAAAGGATAAGGGTTGCGCTCGTTGCGGGACTTAACCCAACATTTCACAACACGAGCTGACGACAGCC
ATGCAGCACCTGTCTCAGAGTTCCCGAAGGCACCAAAGCATCTCTGCTAAGTTCTCTGGATGTCAAGA
GTAGGTAAGGTTCTTCGCGTTGCATCGAATTAAACCACATGCTCCACCGCTTGTGCGGGCCCCCGTCAA
TTCATTTGAGTTTTAACCTTGCGGCCGTACTCCCCAGGCGGTCGACTTAACGCGTTAGCTCCGGAAGCC
ACTCCTCAAGGGAACAACCTCCAAGTCGACATCGTTTACGGCGTGGACTACCAGGGTATCTAATCCTG
TTTGCTCCCCACGCTTTCGCACCTGAGCGTCAGTCTTCGTCCAGGGGGCCGCCTTCGCCACCGGTATTC
CTCCAGATCTCTACGCATTTCACCGCTACACCTGGAATTCTACCCCCCTCTACGAGACTCAAGCCTGCC
AGTTTCAAATGCAGTTCCCAGGTTAAGCCCGGGGATTTCACATCTGACTTAACAGACCGCCTGCGTGC
GCTTACGCCCAGTAATTCCGATTAACGCTTGCACCCTCCGTATTACCGCGGCTGCTGGCACGGAGTTA
GCCGGTGCTTCTTCTGCGGGTAACGTCAATCGA
Isolate 14 (16F, 27) Paenibacillus sp.
(SEQ ID NO: 25)
AGAAGCTTGCTTCTTTGATAGCGTTAGCGGCGGACGGGTGAGTAACACGTAGGCAACCTGCCCTCAAG
TTTGGGACAACTACCGGAAACGGTAGCTAATACCGAATAGTTGTTTTCTTCGCCTGAAGGAAACTGGA
AAGACGGAGCAATCTGTCACTTGGGGATGGGCCTGCGGCGCATTAGCTAGTTGGTGGGGTAACGGCTC
ACCAAGGCGACGATGCGTAGCCGACCTGAGAGGGTGATCGGCCACACTGGGACTGAGACACGGCCCA
GACTCCTACGGGAGGCAGCAGTAGGGAATCTTCCGCAATGGGCGAAAGCCTGACGGAGCAATGCCGC
GTGAGTGATGAAGGTTTTCGGATCGTAAAGCTCTGTTGCCAGGGAAGAACGCTTGGGAGAGTAACTGC
TCTCAAGGTGACGGTACCTGAGAAGAAAGCCCCGGCTAACTACGTGCCAGCAGCCGCGGTAATACGT
AGGGGGCAAGCGTTGTCCGGAATTATTGGGCGTAAAGCGCGCGCAGGCGGTCATTTAAGTCTGGTGTT
TAATCCCGGGGCTCAACCCCGGATCGCACTGGAAACTGGGTGACTTGAGTGCAGAAGAGGAGAGTGG
AATTCCACGTGTAGCGGTGAAATGCGTAGATATGTGGAGGAACACCAGTGGCGAAGGCGACTCTCTG
GGCTGTAACTGACGCTGAGGCGCGAAAGCGTGGGGAGCAAACAGGATTAGATACCCTGGTAGTCCAC
GCCGTAAACGATGAGTGCTAGGTGTTAGGGGTTTCGATACCCTTGGTGCCGAAGTTAACACATTAAGC
ACTCCGCCTGGGGAGTACGGTCGCAAGACTGAAACTCAAAGGAATTGACGGGGACCCGCACAAGCAG
TGG
Isolate 16 (16F-16R) Pantoea sp.
(SEQ ID NO: 26)
AAGCGCCCTCCCGAAGGTTAAGCTACCTACTTCTTTTGCAACCCACTCCCATGGTGTGACGGGCGGTGT
GTACAAGGCCCGGGAACGTATTCACCGTGGCATTCTGATCCACGATTACTAGCGATTCCGACTTCACG
GAGTCGAGTTGCAGACTCCGATCCGGACTACGACGCACTTTATGAGGTCCGCTTGCTCTCGCGAGGTC
GCTTCTCTTTGTATGCGCCATTGTAGCACGTGTGTAGCCCTACTCGTAAGGGCCATGATGACTTGACGT
CATCCCCACCTTCCTCCGGTTTATCACCGGCAGTCTCCTTTGAGTTCCCGACCGAATCGCTGGCAACAA
AGGATAAGGGTTGCGCTCGTTGCGGGACTTAACCCAACATTTCACAACACGAGCTGACGACAGCCATG
CAGCACCTGTCTCAGAGTTCCCGAAGGCACCAAAGCATCTCTGCTAAGTTCTCTGGATGTCAAGAGTA
GGTAAGGTTCTTCGCGTTGCATCGAATTAAACCACATGCTCCACCGCTTGTGCGGGCCCCCGTCAATTC
ATTTGAGTTTTAACCTTGCGGCCGTACTCCCCAGGCGGTCGACTTAACGCGTTAGCTCCGGAAGCCACT
CCTCAAGGGAACAACCTCCAAGTCGACATCGTTTACGGCGTGGACTACCAGGGTATCTAATCCTGTTT
GCTCCCCACGCTTTCGCACCTGAGCGTCAGTCTTCGTCCAGGGGGCCGCCTTCGCCACCGGTATTCCTC
CAGATCTCTACGCATTTCACCGCTACACCTGGAATTCTACCCCCCTCTACGAGACTCAAGCCTGCCAGT
TTCAAATGCAGTTCCC
isolate 17 (16R, 1492) Pantoea sp,
(SEQ ID NO: 27)
GGGTAGCGCCCTCCCGAAGGTTAAGCTACCTACTTCTTTTGCAACCCACTCCCATGGTGTGACGGGCG
GTGTGTACAAGGCCCGGGAACGTATTCACCGTGGCATTCTGATCCACGATTACTAGCGATTCCGACTTC
ACGGAGTCGAGTTGCAGACTCCGATCCGGACTACGACGCACTTTATGAGGTCCGCTTGCTCTCGCGAG
GTCGCTTCTCTTTGTATGCGCCATTGTAGCACGTGTGTAGCCCTACTCGTAAGGGCCATGATGACTTGA
CGTCATCCCCACCTTCCTCCGGTTTATCACCGGCAGTCTCCTTTGAGTTCCCGACCGAATCGCTGGCAA
CAAAGGATAAGGGTTGCGCTCGTTGCGGGACTTAACCCAACATTTCACAACACGAGCTGACGACAGCC
ATGCAGCACCTGTCTCAGAGTTCCCGAAGGCACCAAAGCATCTCTGCTAAGTTCTCTGGATGTCAAGA
GTAGGTAAGGTTCTTCGCGTTGCATCGAATTAAACCACATGCTCCACCGCTTGTGCGGGCCCCCGTCAA
TTCATTTGAGTTTTAACCTTGCGGCCGTACTCCCCAGGCGGTCGACTTAACGCGTTAGCTCCGGAAGCC
ACTCCTCAAGGGAACAACCTCCAAGTCGACATCGTTTACGGCGTGGACTACCAGGGTATCTAATCCTG
TTTGCTCCCCACGCTTTCGCACCTGAGCGTCAGTCTTCGTCCAGGGGGCCGCCTTCGCCACCGGTATTC
CTCCAGATCTCTACGCATTTCACCGCTACACCTGGAATTCTACCCCCCTCTACGAGACTCAAGCCTGCC
AGTTTCAAATGCAGTTCCCAGGTTTAAGCCCGGGGATTTCACATCTGACTTAACAGACCGCCTGCGTGC
GCTTACGCCCAGTAATTCCGATTAACGCTTGCACCCTCCGTATTACCGCGGCTGCTGGCACGGAGTTA
GCCGGTGCTTCTTCTGCGGGTAACGTCAATCGA
isolate 18 (16F, 27) Xanthomonas sp.
(SEQ ID NO: 28)
CATGCAGTCGAACGGCAGCACAGGAGAGCCTTTGCTCTCTGGGTGGCGAGTGGCGGACGGGTGAGGAA
TACATCGGAATCTACCTTTTCGTGGGGGATAACGTAGGGAAACTTACGCTAATACCGCATACGACCTT
AGGGTGAAAGCGGAGGACCTTCGGGCTTCGCGCGGATAGATGAGCCGATGTCGGATTAGCTAGTTGG
CGGGGTAAAGGCCCACCAAGGCGACGATCCGTAGCTGGTCTGAGAGGATGATCAGCCACACTGGAAC
TGAGACACGGTCCAGACTCCTACGGGAGGCAGCAGTGGGGAATATTGGACAATGGGCGCAAGCCTGA
TCCAGCCATGCCGCGTGGGTGAAGAAGGCCTTCGGGTTGTAAAGCCCTTTTGTTGGGAAAGAAAAGCA
GTCGGTTAATACCCGATTGTTCTGACGGTACCCAAAGAATAAGCACCGGCTAACTTCGTGCCAGCAGC
CGCGGTAATACGAAGGGTGCAAGCGTTACTCGGAATTACTGGGCGTAAAGCGTGCGTAGGTGGTTGTT
TAAGTCCGTTGTGAAAGCCCTGGGCTCAACCTGGGAATTGCAGTGGATACTGGGCAACTAGAGTGTGG
TAGAGGATGGCGGAATTCCCGGTGTAGCAGTGAAATGCGTAGAGATcuGGAGGAACATCTGTGGCGA
AGGCGGCCATCTGGACCAACACTGACACTGAGGCACGAAAGCGTGGGGAGCAAACAGGATTAGATAC
CCTGGTAGTCCACGCCCTAAACGATGCGAACTGGATGTTGGGTGCAACTTGGCACGCAGTATCGAAGC
TAACGCGTTAAGTTCGCCGCCTGGGGAGTACGGTCGCAAGACTGAAACTCAAAGGAATTGACGGGGG
CCCGCACAAGCGGTGGAGTATGTGGTTTAATTCGATGCAACGCGAAGAACC
Isolate 19 (16, 27) Staphylococcus sp.
(SEQ ID NO: 29)
TGCAAGTCGAGCGAACAGGATAAGGAGCTTGCTCCTTTGAAGTTAGCGGCGGACGGGTGAGTAACAC
GTGGGTAACCTACCTATAAGACTGGAATAACTTCGGGAAACCGGAGCTAATGCCGGATAACATATAG
AACCGCATGGTTCTATAGTGAAAGATGGTTTTGCTATCACTTATAGATGGACCCGCGCCGTATTAGCTA
GTTGGTAAGGTAAAGGCTTACCAAGGCGACGATACGTAGCCGACCTGAGAGGGTGATCGGCCACACT
GGAACTGAGACACGGTCCAGACTCCTACGGGAGGCAGCAGTAGGGAATCTTCCGCAATGGGCGAAAG
CCTGACGGAGCAACGCCGCGTGAGTGATGAAGGTTTTCGGATCGTAAAACTCTGTTATTAGGGAAGAA
CAAATGCGTAAGTAACTGTGCGCATCTTGACGGTACCTAATCAGAAAGCCACGGCTAACTACGTGCCA
GCAGCCGCGGTAATACGTAGGTGGCAAGCGTTATCCGGAATTATTGGGCGTAAAGCGCGCGTAGGCG
GTTTCTTAAGTCTGATGTGAAAGCCCACGGCTCAACCGTGGAGGGTCATTGGAAACTGGGAAACTTGA
GTGCAGAAGAGGAAAGTGGAATTCCATGTGTAGCGGTGAAATGCGCAGAGATAATGGAGGAACACCAG
TGGCGAAGGCGACTTTCTGGTCTGTAACTGACGCTGATGTGCGAAAGCGTGGGGATCAAACAGGATTA
GATACCCTGGTAGTCCACGCCGTAAACGATGAGTGCTAAGTGTTAGGGGGTTTCCGCCCCTTAGTGCT
GCAGCTAACGCATTAAGCACTCCGCCTGGGGAGTACGACCGCAAGGTTGAAACTCAAAGGAATTGAC
GGGGACCCGCACAAGCGGTGGAGCATGTGGGTTTAATTCGAAGCAACGCGAAGAACC
Isolate 20 (27, 16F) Methylobacterium sp.
(SEQ ID NO: 30)
CGGGGTCAGCGGCGGACGGGTGAGTAACGCGTGGGAACGTGCCTTCTGGTTCGGAATAACCCTGGGA
AACTAGGGCTAATACCGGATACGCCCTTATGGGGAAAGGTTTACTGCCGGAAGATCGGCCCGCGTCTG
ATTAGCTAGTTGGTGGGGTAACGGCCTACCAAGGCGACGATCAGTAGCTGGTCTGAGAGGATGATCAG
CCACACTGGGACTGAGACACGGCCCAGACTCCTACGGGAGGCAGCAGTGGGGAATATTGGACAATGG
GCGCAAGCCTGATCCAGCCATGCCGCGTGAGTGATGAAGGCCTTAGGGTTGTAAAGCTCTTTTATCCG
GGACGATAATGACGGTACCGGAGGAATAAGCCCCGGCTAACTTCGTGCCAGCAGCCGCGGTAATACG
AAGGGGGCTAGCGTTGCTCGGAATCACTGGGCGTAAAGGGCGCGTAGGCGGCGTTTTAAGTCGGGGG
TGAAAGCCTGTGGCTCAACCACAGAATGGCCTTCGATACTGGGACCGCTTGAGTATGGTAGAGGTTGGT
GGAACTGCGAGTGTAGAGGTGAAATTCGTAGATATTCGCAAGAACACCGGTGGCGAAGGCGGCCAAC
TGGACCATTACTGACGCTGAGGCGCGAAAGCGTGGGGAGCAAACAGGATTAGATACCCTGGTAGTCC
ACGCCGTAAACGATGAATGCCAGCTGTTGGGGTGCTTGCACCGCAGTAGCGCAGCTAACGCTTTGAGC
ATTCCGCCTGGGGAGTACGGTCGCAAGATTAAAACTCAAAGGAATTGACGGGGGCCCGCACAAGCGG
TGGAGCATGTGGTTTAATTCGAAGCAACGCGCAGAACCTTACCATCCTTTGACATGGCGTGTTACCCA
GAGAGATTTGGGGTCCACTTCGGTGGCGCGCACAGGTGCTGCATGGCTGTCGTCAGCTCGTGTCGT
GAGA
Isolate 21 (16F-16R) Pantoea sp.
(SEQ ID NO: 31)
GCCTTCCGGCGGGTGAAACTACCTACTTCTTTTGCAACCCACTCCCATGGGGTGGAGGGCGGTGTGTA
CAAGGCCCGGGAACGTATTCACCGTGGCATTCTGATCCACGATTACTAGCGATTCCGACTTCACGGAG
TCGAGTTGCAGACTCCGATCCGGACTACGACGCACTTTATGAGGTCCGCTTGCTCTCGCGAGGTCGCTT
CTCTTTGTATGCGCCATTGTAGCACGTGTGTAGCCCTACTCGTAAGGGCCATGATGACTTGACGTCATC
CCCACCTTCCTCCGGTTTATCACCGGCAGTCTCCTTTGAGTTCCCGACCGAATCGCTGGCAACAAAGGA
TAAGGGTTGCGCTCGTTGCGGGACTTAACCCAACATTTCACAACACGAGCTGACGACAGCCATGCAGC
ACCTGTCTCATCGATCCCGAAGGCCCGCAAAAATCTCTCCGGATATCTCCGGATGTCAAGAGTAGGTA
AGGTTCTTCGCGTTGCATCGAATTAAACCACATGCTCCACCGCTTGTGCGGGCCCCCGTCAATTCATTT
GAGTTTTAACCTTGCGGTCGTACTCCCCAGGCGGTCGACTTAACGCGTTAGCTCCGGAAGCCACTCCTC
AAGGGAACAACCTCGTAGTCGACATCGTTTACGGCGTGGACTACCAGGGTATCTAATCCTGTTTGCTC
CCCACGCTTTCGCACCTGACCGTCAGTCTTCGTCCAGGGGGCCGCCTTCGCCACCGGTATTCCTCCCCA
CCTCTACGCATTTGTCCGCTACACCTGTAATTCTACCCCGCTCTACTACACTCAAGCCCGCGTGTTTCCA
ATGCAGTTCCCAGGTTAAGCCCGGGGATTTCCTCTCTGAATTTACAGACCGCCTGCGTGCGCTTTACGC
CCAGTAGTTTCCAATTAACGCTTGCCCCCTACGTATTACCGCCGACGCTTGGCACGCAGTTAGCCGTCG
CTTCTTCTGCGGTTAACGTCATTCGA
Isolate 22 (16F-16R) Pantoea sp.
(SEQ ID NO: 32)
GTAGGCGCCGTCCTCGCGGGGGATAACCCTACTTCTTTTTTTTCCCACTCCCTTGGTGTGAGGGGCGGT
GTGTACATGGCCCGGGCAGGTATTTACCGAGGCATTCTGTTCGACGATTACTAGCGATTCCGACTTCAC
GGACGCGAGTTGCATGCTCCGACCGATACTACGACGCACTTTTATGAGGTCCGTTTGCTCTCGCGAGGT
CGCTTCTCTTTGTATGCGCCATTGTAGCACGTGTGTAGCCCTACTCGTAAGGGCCATGCTGGCTTGACG
TCATCCATACCTTCCTCCGGTTTATCACCGGCAGTCTCCTTTGAGTTCCCGACCGAATCGCTGGCAACA
AAGGAAAAGGGTTGCGCTCGTTGCGGGCGTTAACCCAACATTTCACAACACGAGCTGGCGACAGCCAT
GCAGCACCTGTCTGTCTATTTCCCGAAGGAAGGACAAAATCTCTCTCTGCTTFCCGGGATGTCAAGAGT
AGGTAAGTATCTTCGCGTTGCATCGAATTAAACCACATGCTCCACCGCCCGTGCGGGCCCCCGTCAAT
CAATTCAAGTTTGAACCTTGCGGGCGTACTCCCCACGCGGTCGATTTAACGCGCTAGCTCCGGAAGCA
ACTCCTCCAGGGAAGGACCTCCCACTCGATCTCCTTCGTTGCGTGCGTGGCCTAGGTAGCTAACCCTGC
TTGTTTCCTCCGCTTGCTTACCTGACCGACCGTCTTCCTCCGTGGGGGCGGCCTCCCTCCCGGCCGGCCT
CCCTACCTCTCTCCACTTCTTTGCCCGCTCCGCCTGTCTATCCCCCTCCCTCAAACACAATCCAGCCAGT
TTCTTTCGAATGTCCCTTCTTAGTTCAGGGCGGTGACTATCCGTCTGTATTAAGCGACCGCGCGCGCGT
TACTCCCAGCAAGTATTACCTATTCGCGCTTCCACCCTCCTTCCTACCTTGGTTGCTGGGACTGAGTTTA
GAGAGTGCTTCGTCGGCTGCGTCAGTCAATCGAGGAAGTTGCTTCTTCACATCCTCTCCCCCCCTAATG
AAGTTAATTACCAGCCGAAGCCCACATCCGAATCGCGCAATTGGTCGTCCCAT
Pantoea sp. Strain 4
(MG100861; SEQ ID NO: 33)
ATCCAGACACGGAGGCAGAGATGCTTTGGTGCCTTCGGGAACTCTGAGACAGGTGCTGCA
TGGCTGTCGTCAGCTCGTGTTGTGAAATGTTGGGTTAAGTCCCGCAACGAGCGCAACCCT
TATCCTTTGTTGCCAGCGATTCGGTCGGGAACTCAAAGGAGACTGCCGGTGATAAACCGG
AGGAAGGTGGGGATGACGTCAAGTCATCATGGCCCTTACGAGTAGGGCTACACACGTGCT
ACAATGGCGCATACAAAGAGAAGCGACCTCGCGAGAGCAAGCGGACCTCATAAAGTGCGT
CGTAGTCCGGATCGGAGTCTGCAACTCGACTCCGTGAAGTCG
Pantoea sp. Strain 5
(MG100862.1; SEQ ID NO: 34)
ACTGAGACAGGTGCTGCATGGCTGTCGTCAGCTCGTGTTGTGAAATGTTGGGTTAAGTCCCGCAACGA
GCGCAACCCTTATCCTTTGTTGCCAGCGATTCGGTCGGGAACTCAAAGGAGACTGCCGGTGATAAACC
GGAGGAAGGTGGGGATGACGTCAAGTCATCATGGCCCTTACGAGTAGGGCTACACACGTGCTACAAT
GGCGCATACAAAGAGAAGCGACCTCGCGAGAGCAAGCGGACCTCATAAAGTGCGTCGTAGTCCGGAT
CGGAGTCTGCAACTCGACTCCGTGAAGTCGGAATCGCTAGTAATCGTGGATCAGAATGCCACGGTGAA
TACGTTCCCGGGCCTTGTACACACCGCCCGTCACACCATGGGAGTGGGTTGCAAAAGAAGTAGGTAGC
TTAACCTTCGGGAGGGCGCTACC
Pantoea sp. Strain12
(MG100863.1; SEQ ID NO: 35)
GAATCAAGAGACAGGTGCTGCATGGCTGTCGTCAGCTCGTGTTGTGAAATGTTGGGTTAAGTCCCGCA
ACGAGCGCAACCCTTATCCTTTGTTGCCAGCGATTCGGTCGGGAACTCAAAGGAGACTGCCGGTGATA
AACCGGAGGAAGGTGGGGATGACGTCAAGTCATCATGGCCCTTACGAGTAGGGCTACACACGTGCTA
CAATGGCGCATACAAAGAGAAGCGACCTCGCGAGAGCAAGCGGACCTCATAAAGTGCGTCGTAGTCC
GGATCGGAGTCTGCAACTCGACTCCGTGAAGTC
16S rDNA Micrococcus luteus
(SEQ ID NO: 36; NRRL No. B-68176)
GGTCTAATACCGGATAGGAGCGTCCACCGCATGGTGGGTGTTGGAAAGATTTATCGGTTTTGGATGGA
CTCGCGGCCTATCAGCTTGTTGGTGAGGTAATGGCTCACCAAGGCGACGACGGGTAGCCGGCCTGAGA
GGGTGACCGGCCACACTGGGACTGAGACACGGCCCAGACTCCTACGGGAGGCAGCAGTGGGGAATAT
TGCACAATGGGCGAAAGCCTGATGCAGCGACGCCGCGTGAGGGATGACGGCCTTCGGGTTGTAAACC
TCTTTCAGTAGGGAAGAAGCGAAAGTGACGGTACCTGCAGAAGAAGCACCGGCTAACTACGTGCCAG
CAGCCGCGGTAATACGTAGGGTGCGAGCGTTATCCGGAATTATTGGGCGTAAAGAGCTCGTAGGCGGT
TTGTCGCGTCTGTCGTGAAAGTCCGGGGCTTAACCCCGGATCTGCGGTGGGTACGGGCAGACTAGAGT
GCAGTAGGGGAGACTGGAATTCCTGGTGTAGCGGTGGAATGCGCAGATATCAGGAGGAACACCGATG
GCGAAGGCAGGTCTCTGGGCTGTAACTGACGCTGAGGAGCGAAAGCATGGGGAGCGAACAGGATTAG
ATACCCTGGTAGTCCATGCCGTAAACGTTGGGCACTAGGTGTGGGGACCATTCCACGGTTTCCGCGCC
GCAGCTAACGCATTAAGTGCCCCGCCTGGGGAGTACGGCCGCAAGGCTAAAACTCAAAGGAATTGAC
GGGGGCCCGCACAAGCGGCGGAGCATGCGGATTAATTCGATGCAACGCGAAGAACCTTACCAAGGCT
TGACATGTTCCCGATCGCCGTAGAGATACGATTTCCCCTTTGGGGCGGGTTCACAGGTGGTGCATGGTT
GTCGTCAGCTCGTGTCGTGAGATGTTGGGTTAAGTCCCGCAACGAGCGCAACCCTCGTTCCATGTTGCC
AGCACGTAATGGTGGGGACTCATGGGAGACTGCCGGGGTCAACTCGGAGGAAGGTGAGGACGACGTC
AAATCATCATGCCCCTTATGTCTTGGGCTTCACGCA

As used herein, “sequence identity” generally refers to the percent identity of nucleotide bases or amino acids comparing a first polynucleotide or polypeptide to a second polynucleotide or polypeptide using algorithms having various weighting parameters. Sequence identity between two polynucleotides or two polypeptides can be determined using sequence alignment by various methods and computer programs (e.g., BLAST, CS-BLAST, FASTA, HMMER, L-ALIGN, and the like) available through the worldwide web at sites including but not limited to GENBANK (on the world wide web at ncbi.nlm.nih.gov/genbank/) and EMBL-EBI (on the world wide web at ebi.ac.uk.). Sequence identity between two polynucleotides or two polypeptide sequences is generally calculated using the standard default parameters of the various methods or computer programs. A high degree of sequence identity, as used herein, between two polynucleotides or two polypeptides is typically between about 90% identity and 100% identity, for example, about 90% identity or higher, preferably about 95% identity or higher, more preferably about 98% identity or higher. A moderate degree of sequence identity, as used herein, between two polynucleotides or two polypeptides is typically between about 80% identity to about 85% identity, for example, about 80% identity or higher, preferably about 85% identity. A low degree of sequence identity, as used herein, between two polynucleotides or two polypeptides is typically between about 50% identity and 75% identity, for example, about 50% identity, preferably about 60% identity, more preferably about 75% identity.

The terms “promoting plant growth” and “stimulating plant growth” are used interchangeably herein, and refer to the ability to enhance or increase at least one of the plant's height, weight, leaf size, root size, shoot length, stem size, competition with competitor plants, resistance to fungal infection, increased protein yield from the plant or increased grain yield of the plant.

Particular formulations to be applied in spraying forms such as water dispersible concentrates or wettable powders may contain surfactant such as wetting and dispersing agents, e.g., the condensation product of formaldehyde with naphthalene sulphonate, an alkyl-aryl-sulphonate, a lignin sulphonate, a fatty alkyl sulphate an ethoxylated alkylphenol and an ethoxylated fatty alcohol.

As used herein the terms “spray” or “spraying” include the technique of applying to an exterior surface an ejected liquid material.

As used herein, the terms “coat” or “coating” include application, typically of a liquid or flowable solid, to an exterior surface such as a seed.

As used herein, a “stabilizer” includes a chemical compound that can be added to a formulation to prolong the stability and/or viability of components of the formulation, a critical aspect of product shelf-stability. A stabilizer can be one of a variety of compounds, such as a desiccant.

As used herein, a “preservative” includes any chemical compound and/or physical conditions that prevent the decomposition of organic constituents of seeds treated with formulations. Chemical preservatives could include, for example, synthetic or non-synthetic antioxidants and physical preservatives could include, for example, refrigeration, freeze-drying or drying.

According to an embodiment the at least one dispersing agent can be in the range of about 2% to about 60% on a dry weight by weight basis. Various dispersing agents are commercially available for use in agricultural compositions, such as those marketed by Rhone Poulenc, Witco, Westvaco, International Speciality products, Croda chemicals, Borregaard, BASF, Rhodia, etc. According to an embodiment the dispersing agents which can be used in the agricultural composition can be chosen from a group comprising polyvinylpyrrolidone, polyvinylalcohol, lignosulphonates, phenyl naphthalene sulphonates, ethoxylated alkyl phenols, ethoxylated fatty acids, alkoxylated linear alcohols, polyaromatic sulfonates, sodium alkyl aryl sulfonates, glycerol, glyceryl esters, maleic anhydride copolymers, phosphate esters, condensation products of aryl sulphonic acids and formaldehyde, condensation products of alkylaryl sulphonic acids and formaldehyde, addition products of ethylene oxide and fatty acid esters, salts of addition products. of ethylene oxide and fatty acid esters, sulfonates of condensed naphthalene, addition products of ethylene oxide and fatty acid esters, salts of addition products of ethylene oxide and fatty acid esters, lignin derivatives, naphthalene formaldehyde condensates, sodium salt of isodecylsulfosuccinic acid half ester, polycarboxylates, sodium alkylbenzenesulfonates, sodium salts of sulfonated naphthalene, ammonium salts of sulfonated naphthalene, salts of polyacrylic acids, salts of phenolsulfonic acids and salts of naphthalene sulfonic acids. However, those skilled in the art will appreciate that it is possible to utilize other dispersing agents known in the art without departing from the scope of the claims of the present invention.

In some embodiments, a bacterial endophyte is a seed-origin bacterial endophyte. As used herein, a “seed-origin” or “seed-vectored” bacterial endophyte” refers to a population of bacteria associated with or derived from the seed of a host plant. For example, a seed-origin bacterial endophyte can be found in mature, dry, undamaged (e.g., no cracks, visible fungal infection, or prematurely germinated) seeds. The bacteria can be associated with or derived from the surface of the seed; alternatively, or in addition, it can be associated with or derived from the interior seed compartment (e.g., of a surface-sterilized seed) or from a seedling. In some cases, a seed-origin bacterial endophyte is capable of replicating within the plant tissue, for example, the interior of the seed. Also, in some cases, the seed-origin bacterial endophyte is capable of surviving desiccation.

Seed-origin or seed-vectored means that the microbe entity is obtained directly or indirectly from the seed surface or seed interior compartment or is obtainable from a seed surface or seed interior compartment. For example, a seed-origin bacterial entity can be obtained directly or indirectly from a seed surface or seed interior compartment when it is isolated, or isolated and purified, from a seed preparation; in some cases, the seed-origin bacterial entity which has been isolated, or isolated and purified, may be cultured under appropriate conditions to produce a purified bacterial population consisting essentially of a seed-origin bacterial endophyte. A seed-origin bacterial endophyte can be considered to be obtainable from a seed surface, a seedling, or seed interior compartment if the bacteria can be detected on or in, or isolated from, a seed surface or seed interior compartment of a plant.

In some embodiments, the present invention contemplates methods of manually or mechanically combining an endophyte described herein with one or more plant elements, such as a seed, a leaf, or a root, in order to confer an improved agronomic trait or improved agronomic trait potential to said plant element or host plant. In some embodiments, the present invention contemplates methods of manually or mechanically combining a plurality of endophytes described herein with one or more plant elements.

As used herein, a “synthetic combination” is the combination of a plant element, seedling, or whole plants and a plurality of endophytes, combined by human endeavor, in which one or more of the plurality of endophytes are heterologously disposed, said combination which is not found in nature. In some embodiments, the synthetic combination includes two or more endophytes that synergistically interact providing a benefit to an agricultural seed, seedling, or plant derived thereby. In some embodiments, a synthetic combination is used to refer to a treatment formulation comprising an isolated, purified population of endophytes heterologously disposed to a plant element. In some embodiments of the present invention, “synthetic combination” refers to a purified population of endophytes in a treatment formulation comprising additional compositions with which said endophytes are not found associated in nature.

As used herein, an endophyte is “heterologously disposed” when mechanically or manually applied, artificially inoculated or disposed onto or into a plant element, seedling, plant or onto or into a plant growth medium or onto or into a treatment formulation so that the endophyte exists on or in said plant element, seedling, plant, plant growth medium, or treatment formulation in a manner not found in nature prior to the application of the endophyte, e.g., said combination which is not found in nature. In some embodiments, such a manner is contemplated to include: the presence of the endophyte; presence of the endophyte in a different number, concentration, or amount; the presence of the endophyte in or on a different plant element, tissue, cell type, or other physical location in or on the plant; the presence of the endophyte at different time period, e.g. developmental phase of the plant or plant element, time of day, time of season, and combinations thereof. In some embodiments, plant growth medium is soil, a hydroponic apparatus, or artificial growth medium such as commercial potting mix. In some embodiments, the plant growth medium is soil in an agricultural field. In some embodiments, the plant growth medium is commercial potting mix. In some embodiments, the plant growth medium is an artificial growth medium such as germination paper. As a non-limiting example, if the plant element or seedling or plant has an endophyte normally found in the root tissue but not in the leaf tissue, and the endophyte is applied to the leaf, the endophyte would be considered to be heterologously disposed. As a non-limiting example, if the endophyte is naturally found in the mesophyll layer of leaf tissue but is applied to the epithelial layer, the endophyte would be considered to be heterologously disposed. As a non-limiting example, an endophyte is heterologously disposed at a concentration that is at least 1.5 times, between 1.5 and 2 times, 2 times, between 2 and 3 times, 3 times, between 3 and 5 times, 5 times, between 5 and 7 times, 7 times, between 7 and 10 times, 10 times greater, or even greater than 10 times higher number, amount, or concentration than that which is naturally present. As a non-limiting example, an endophyte is heterologously disposed on a seedling if that endophyte is normally found at the flowering stage of a plant and not at a seedling stage.

The compositions provided herein are preferably stable. The seed-origin bacterial endophyte is optionally shelf stable, where at least 10% of the CFUs are viable after storage in desiccated form (i.e., moisture content of 30% or less) for 1, 2, 3, 4, 5, 6, 7, 8, 9, 10 or greater than 10 weeks at 4° C. or at room temperature. Optionally, a shelf stable formulation is in a dry formulation, a powder formulation, or a lyophilized formulation. In some embodiments, the formulation is formulated to provide stability for the population of bacterial endophytes. In one embodiment, the formulation is substantially stable at temperatures between about 0° C. and about 50° C. for at least about 1, 2, 3, 4, 5, or 6 days, or 1, 2, 3 or 4 weeks, or 1, 2, 3, 4, 5, 6, 7, 8, 9, 10, 11 or 12 months, or one or more years. In another embodiment, the formulation is substantially stable at temperatures between about 4° C. and about 37° C. for at least about 5, 10, 15, 20, 25, 30 or greater than 30 days.

In some embodiments, plants (including seeds and other plant elements) treated in accordance with the present invention are monocots. In some embodiments, plants (including seeds or other plant elements) treated in accordance with the present invention are dicots. In some embodiments, plants treated in accordance with the present invention include, but are not limited to: agricultural row, agricultural grass plants or other field crops: wheat, rice, barley, buckwheat, beans (soybean, snap, dry), corn (grain, seed, sweet corn, silage, popcorn, high oil), cotton, canola, peas (dry, succulent), peanuts, safflower, sunflower, alfalfa hay, forage crops (alfalfa, clover, vetch, and trefoil), berries and small fruits (blackberries, blueberries, currants, elderberries, gooseberries, huckleberries, loganberries, raspberries, strawberries, bananas and grapes), bulb crops (garlic, leeks, onions, shallots, and ornamental bulbs), citrus fruits (citrus hybrids, grapefruit, kumquat, lines, oranges, and pummelos), cucurbit vegetables (cucumbers, melons, gourds, pumpkins, and squash), flowers, bedding plants, ornamentals, fruiting vegetables (eggplant, sweet and hot peppers, tomatillos, and tomatoes), herbs, spices, mints, hydroponic crops (cucumbers, tomatoes, lettuce, herbs, and spices), leafy vegetables and cole crops (arugula, celery, chervil, endive, fennel, lettuce (head and leaf), parsley, radicchio, rhubarb, spinach, Swiss chard, broccoli, Brussels sprouts, cabbage, cauliflower, collards, kale, kohlrabi, and mustard greens), asparagus, legume vegetable and field crops (snap and dry beans, lentils, succulent and dry peas, and peanuts), pome fruit (pears and quince), root crops (beets, sugarbeets, red beets, carrots, celeriac, chicory, horseradish, parsnip, radish rutabaga, salsify, and turnips), deciduous trees (maple and oak), pine, small grains (rye, wheat, sorghum, millet, stone fruits (apricots, cherries, nectarines, peaches, plums, and prunes), tree nuts (almonds, beech nuts, Brazil nuts, butternuts, cashews, chestnuts, filberts, hickory nuts, macadamia nuts, pecans, pistachios, and walnuts), tuber crops (potatoes, sweet potatoes, yams, artichoke, cassava, and ginger), and turfgrass (turf, sports fields, parks, established and new preparation of golf course tees, greens, fairways and roughs, seed production and sod production). Preferred target species of agricultural plants include species of Malvaceae (cotton family): Cotton (Gossypium spp.), Okra Abelmoschus esculentus, Cacao (Theobroma cacao), Kenaf (Hibiscus cannabinus) and Kola nut (Cola spp.). Target species also include other dicot crops, including but not limited to, Coffee (Coffea spp.), Tobacco (Nicotiana tabacum), Potato (Solanum tuberosum), Tomato (Solanum lycopersicum), Sweet potato (Ipomoea batatas), Beans (Phaseolus spp.), Soybeans (Glycine max), Sunflowers (Helianthus spp.) and Rapeseed (Brassica napus).

As used herein, an agricultural grass plant includes, but is not limited to, maize (Zea mays), common wheat (Triticum aestivum), spelt (Triticum spelta), einkorn wheat (Triticum monococcum), emmer wheat (Triticum dicoccum), durum wheat (Triticum durum), Asian rice (Oryza sativa), African rice (Oryza glabaerreima), wild rice (Zizania aquatica, Zizania latifolia, Zizania palustris, Zizania texana), barley (Hordeum vulgare), Sorghum (Sorghum bicolor), Finger millet (Eleusine coracana), Proso millet (Panicum miliaceum), Pearl millet (Pennisetum glaucum), Foxtail millet (Setaria italic), Oat (Avena sativa), Triticale (Triticosecale), rye (Secale cereal), Russian wild rye (Psathyrostachys juncea), bamboo (Bambuseae), grasses, including Agrostis spp., Poa spp., Festuca spp., Lolium spp., Cynodon spp., Zoysia spp., Koleria spp., Danthonia spp., or sugarcane (e.g., Saccharum arundinaceum, Saccharum barberi, Saccharum bengalense, Saccharum edule, Saccharum munja, Saccharum officinarum, Saccharum procerum, Saccharum ravennae, Saccharum robustum, Saccharum sinense, or Saccharum spontaneum).

A “host plant” includes any plant, particularly an agricultural plant, which an endophytic microbe such as a bacterial endophyte can colonize. As used herein, a microbe is said to “colonize” a plant or seed when it can be stably detected within the plant or seed over a period time, such as one or more days, weeks, months or years; in other words, a colonizing microbe is not transiently associated with the plant or seed.

As used herein, a “reference agricultural plant” is an agricultural plant of the same species, strain, or cultivar to which a treatment, formulation, composition or endophyte preparation as described herein is not administered/contacted. Exemplary reference agricultural plants are described herein. A reference agricultural plant, therefore, is identical to the treated plant with the exception of the presence of the endophyte and can serve as a control for detecting the effects of the endophyte that is conferred to the plant.

A “plant element” is intended to generically reference either a whole plant or a plant component, including but not limited to plant tissues, parts, and cell types. A plant element is preferably one of the following: whole plant, seedling, meristematic tissue, ground tissue, vascular tissue, dermal tissue, seed, leaf, root, shoot, stem, flower, fruit, stolon, bulb, tuber, corm, kelkis, shoot, bud. As used herein, a “plant element” is synonymous to a “portion” of a plant, and refers to any part of the plant, and can include distinct tissues and/or organs, and may be used interchangeably with the term “tissue” throughout.

“Biomass” means the total mass or weight (fresh or dry), at a given time, of a plant tissue, plant tissues, an entire plant, or population of plants. Biomass is usually given as weight per unit area. The term may also refer to all the plants or species in the community (community biomass).

A “bacterial network” means a plurality of endophyte entities (e.g., bacteria, fungi, or combinations thereof) co-localized in an environment, such as on or within a grass agricultural plant. Preferably, a bacterial network includes two or more types of endophyte entities that synergistically interact, such synergistic endophytic populations capable of providing a benefit to the agricultural seed, seedling, or plant derived thereby.

An “increased yield” can refer to any increase in biomass or seed or fruit weight, seed size, seed number per plant, seed number per unit area, bushels per acre, tons per acre, kilo per hectare, or carbohydrate yield. Typically, the particular characteristic is designated when referring to increased yield, e.g., increased grain yield or increased seed size.

The terms “pathogen” and “pathogenic” in reference to a bacterium includes any such organism that is capable of causing or affecting a disease, disorder or condition of a host containing the organism.

As used herein, an “agricultural seed” is a seed used to grow a plant typically used in agriculture (an “agricultural plant”). The seed may be of a monocot or dicot plant, and may be planted for the production of an agricultural product, for example grain, food, fiber, etc. As used herein, an agricultural seed is a seed that is prepared for planting, for example, in farms for growing.

In some cases, the present invention contemplates the use of microbes that are “compatible” with agricultural chemicals, for example, a fungicide, an anti-bacterial compound, or any other agent widely used in agricultural which has the effect of killing or otherwise interfering with optimal growth of microbes. As used herein, a microbe is “compatible” with an agricultural chemical when the microbe is modified, such as by genetic modification, e.g., contains a transgene that confers resistance to an herbicide, or is adapted to grow in, or otherwise survive, the concentration of the agricultural chemical used in agriculture. For example, a microbe disposed on the surface of a seed is compatible with the fungicide metalaxyl if it is able to survive the concentrations that are applied on the seed surface.

In some embodiments, an agriculturally compatible carrier can be used to formulate an agricultural formulation or other composition that includes a purified bacterial preparation. As used herein an “agriculturally compatible carrier” refers to any material, other than water, which can be added to a seed or a seedling without causing or having an adverse effect on the seed (e.g., reducing seed germination) or the plant that grows from the seed, or the like.

As used herein, a “portion” of a plant refers to any part of the plant, and can include distinct tissues and/or organs, and is used interchangeably with the term “tissue” throughout.

A “population” of plants, as used herein, can refer to a plurality of plants that were subjected to the same inoculation methods described herein, or a plurality of plants that are progeny of a plant or group of plants that were subjected to the inoculation methods. In addition, a population of plants can be a group of plants that are grown from coated seeds. The plants within a population will typically be of the same species, and will also typically share a common genetic derivation.

A “reference environment” refers to the environment, treatment or condition of the plant in which a measurement is made. For example, production of a compound in a plant associated with a purified bacterial population (e.g., a seed-origin bacterial endophyte) can be measured in a reference environment of drought stress, and compared with the levels of the compound in a reference agricultural plant under the same conditions of drought stress. Alternatively, the levels of a compound in plant associated with a purified bacterial population (e.g., a seed-origin bacterial endophyte) and reference agricultural plant can be measured under identical conditions of no stress.

As used herein, a “colony-forming unit” (“CFU”) is used as a measure of viable microorganisms in a sample. A CFU is an individual viable cell capable of forming on a solid medium a visible colony whose individual cells are derived by cell division from one parental cell.

In part, the present invention describes preparations of novel endophytes, and the creation of synthetic combinations of agricultural seeds and/or seedlings with heterologous endophytes and formulations containing the synthetic combinations, as well as the recognition that such synthetic combinations display a diversity of beneficial properties present in the agricultural plants and the associated endophyte populations newly created by the present inventors. Such beneficial properties include metabolism, transcript expression, proteome alterations, morphology, and the resilience to a variety of environmental stresses, and the combination of a plurality of such properties.

Provided herein are novel compositions, methods, and products related to our invention's ability to overcome the limitations of the prior art in order to provide reliable increases in crop yield, biomass, germination, vigor, stress resilience, and other properties to agricultural crops.

In some embodiments, microbes can confer beneficial properties across a range of concentrations.

In some embodiments, combinations of one or more heterologously disposed endophytes confer additive advantages to plants, including multiple functional properties and resulting in seed, seedling, and plant hosts that display single or multiple improved agronomic properties. In some embodiments, combinations of heterologously disposed endophytes confer synergistic advantages to plants, including multiple functional properties and resulting in seed, seedling, and plant hosts that display single or multiple improved agronomic properties.

In one aspect, the present invention contemplates a synthetic combination of a plant element of a plant that is coated with an endophyte on its surface. The plant element can be any agricultural plant element, for example an agricultural seed. In one embodiment, the plant element of the first plant is from a monocotyledonous plant. For example, the plant element of the first plant is from a cereal plant. The plant element of the first plant can be selected from the group consisting of a maize plant, a wheat plant, a barley plant, an onion plant, a sorghum plant, or a rice plant. In an alternative embodiment, the plant element of the first plant is from a dicotyledonous plant. The plant element of the first plant can be selected from the group consisting of a cotton plant, a Brassica napus plant, a tomato plant, a pepper plant, a cabbage plant, a lettuce plant, a melon plant, a strawberry plant, a turnip plant, a watermelon plant, a peanut plant, or a soybean plant. In still another embodiment, the seed of the first plant can be from a genetically modified plant. In another embodiment, the seed of the first plant can be a hybrid seed.

The Examples below are provided to illustrate certain embodiments of the invention. They are not intended to limit the invention in any way.

### Example I

### Endobiome Interference

The process of degradation of microbes within roots has been termed ‘rhizophagy’ (meaning ‘root eating’) (Paungfoo-Lonhienne et al., 2013). The cyclic process where symbiotic bacteria alternate between a free-living soil phase and an intracellular endophytic phase has been termed ‘rhizophagy cycle’ or ‘rhizophagy symbiosis’ (Verma and White, 2018). It seems reasonable—that the primary function of the rhizophagy cycle is the transport of nutrients via microbes from the rhizosphere to the plant root where nutrients are extracted from microbes (Hill et al., 2011; Beltrán-García et al., 2014; Prieto et al., 2017). It is also logical that microbes that are symbiotic with plants and function in the rhizophagy cycle are adapted to the host plant and likely show the following features: 1) possess the capacity to enter plant cell walls at the root tip meristem; 2) release electrolytes to plant cells on exposure to ROS secreted by root cell plasma membranes; 3) ability to survive ROS exposure in its host; 4) triggers root hair elongation to exit the hair as it elongates; and 5) are attracted back to the root exudate zone at root tip meristems.

### Endobiome Interference

Our results show that microbes of the endobiome of a particular plant appear to be adapted to the internal conditions of that plant, and that the conditions in the endospheres of plants may differ between species of plants. The removal of endobiome microbes from hosts to which they are adapted, and transference to seedling hosts to which they are not adapted, results in: 1) internal colonization, 2) interference with the functioning of other microbes of the endobiome, 3) interference with plant development, or 4) increases in seedling mortality. Perturbations in seedling development or increases in seedling mortality as a result of colonization by non-adapted microbes may result from ‘endobiome interference’.

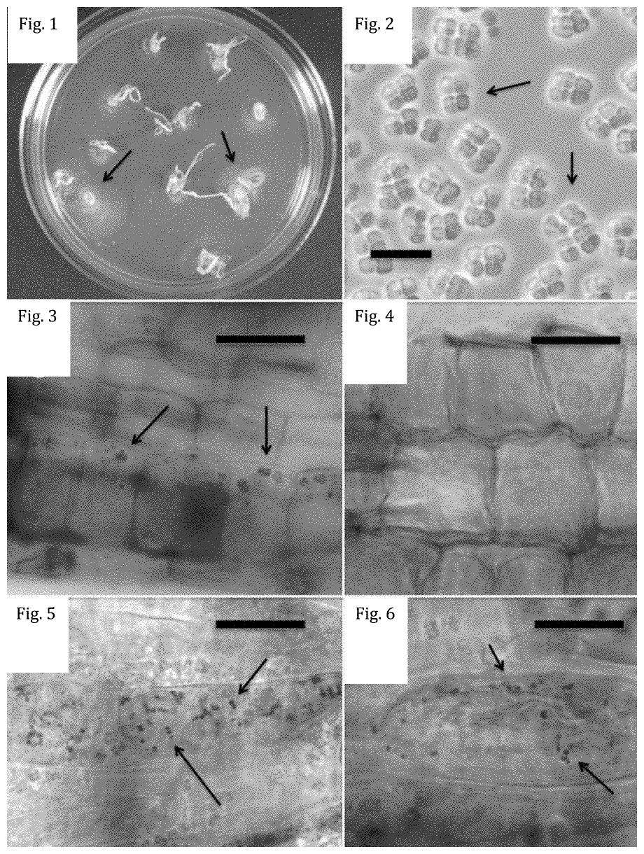

To evaluate whether ‘endobiome interference’ occurs we conducted a series of experiments where we removed microbes (bacteria and yeasts) from seeds of plants (including species Abrus precatorius, Froelichia gracilis, Lycopersicum esculentum and Poa annua) and inoculated them onto axenic seedlings in agarose; we then assessed internal colonization of seedling roots, root growth, and seedling mortality (Table 1; FIGS. 1-18). Test seedlings included dandelion (Taraxacum officionale), curly dock (Rumex crispus) and clover (Trifolium repens). Some experiments were also done where microbes were inoculated onto seedlings of Amaranthus hypochondriacus and Amaranthus viridis. Microbes included yeasts Rhodotorula sp. (strain Abrus #1; SEQ ID NO: 1) and Aureobasidium pullulans (strain Froelichia #2; (SEQ ID NO: 8), and bacteria Sphingomonas sp. (strain Abrus #3; (SEQ ID NO:2), Rhodococcus sp. (strain AbrusR; SEQ ID NO:3; NRRL No. B-68175), Micrococcus luteus (strain Lycopersicon #1; (SEQ ID NO: 36), Curtobacterium sp. (strain Froelichia #4; SEQ ID NO: 4) and Paenibacillus sp. (strain PA-NA-2B1; SEQ ID NO: 5). None of these microbes appeared to be pathogenic or inhibitory of root growth in their original hosts based on growth of seedlings containing microbes on agarose media. In fact, Micrococcus luteus was found to be growth promotional in tomato seedlings, resulting in intracellular colonization and increased root hair length. See Table 2. All of the microbes were found to become intracellular in seedling root cells when inoculated onto germinating seeds (FIGS. 3, 5-18). The occurrence of effects that we termed “endobiome interference” depended on the microbe, and the host seedling the microbe was inoculated into. The two most potent microbes in terms of increased mortality in seedlings after 3 weeks included the yeast Aureobasidium pullulans (Froelichia #2) and bacterium Micrococcus luteus (Lycopersicum #1). In terms of inhibition of root growth Rhodotorula sp. (strain Abrus #1), Sphingomonas sp. (strain Abrus #3) and Micrococcus luteus (Lycopersicum #1) were more inhibitory. Curtobacterium (strain Froelichia #4) was growth promotional in all three species, increasing root growth and reducing seedling mortality in test seedlings. The mechanisms of inhibition of root growth or increase in seedling root growth are not clear.

TABLE 1
Endobiome interference results summary

| Microbe | Host origin | Target host | Intracellular | Δ Root length* | Δ Mortality |
|---|---|---|---|---|---|
| Rhodotorula | A. precatorius | Dandelion | Yes | −40% | +18% |
| Rhodotorula | A. precatorius | Curly dock | Yes | −45% | −27% |
| Rhodotorula | A. precatorius | Clover | Yes | −64% | +24% |
| Sphingomonas | A. precatorius | Dandelion | Yes | −28% | +39% |
| Sphingomonas | A. precatorius | Curly dock | Yes | −19% | 0% |
| Sphingomonas | A. precatorius | Clover | Yes | −40% | −6% |
| Rhodococcus | A. precatorius | Dandelion | Yes | −7% | +50% |
| Rhodococcus | A. precatorius | Curly dock | Yes | −23% | −3% |
| Rhodococcus | A. precatorius | Clover | Yes | −13% | 0% |
| Aureobasidium | F. gracilis | Dandelion | Yes | +46% | +44% |
| Aureobasidium | F. gracilis | Curly dock | Yes | −17% | +57% |
| Aureobasidium | F. gracilis | Clover | Yes | +2% | +10% |
| Curtobacterium | F. gracilis | Dandelion | Yes | +15% | −13% |
| Curtobacterium | F. gracilis | Curly dock | Yes | +10% | −13% |
| Curtobacterium | F. gracilis | Clover | Yes | +7% | −7% |
| Micrococcus | L. esculentum | Dandelion | Yes | −60% | +80% |
| Micrococcus | L. esculentum | Curly dock | Yes | −30% | −14% |
| Micrococcus | L. esculentum | Clover | Yes | −27% | +31% |
| Paenibacillus | P. annua | Dandelion | Yes | −12% | +51% |
| Paenibacillus | P. annua | Curly dock | Yes | −30% | −14% |
| Paenibacillus | P. annua | Clover | Yes | — | — |

*Percentages are from means of 40 seeds/seedlings; mortality includes germination suppression and seedling death after 3 weeks on agarose; Δ designates change (Δ Root length = change in root length compared to control, and Δ Mortality = change in mortality compared to control).

TABLE 2
Micrococcus luteus is Growth Promotional in Tomato Seedlings

| Micrococcus-treated seedlings | Non-treated seedlings |
|---|---|
| Root 22.6 ± 4.5 mm long | Root 22.86 ± 5.95 mm long |
| N = 20 | N = 21 |
| Root hair lengths | Root hair lengths |
| Field 1 (n = 16) | Field 1 (n = 9) |
| 634 ± 94.02μ | 214.16 ± 54.78μ |
| Field 2 (n = 15) | Field 2 (n = 14) |
| 578.49 ± 57.92μ | 294.15 ± 95.9μ |
| Field 3 (n = 14) | Field 3 (n = 17) |
| 574.8 ± 81.08μ | 208.23 ± 70.19μ |

Data expressed as mean ± standard deviation. Results from tomato seedling experiment (7 days growth on agarose)

However, two factors seem relevant, including: 1) entry of microbes into root cells, and 2) resistance of microbes to reactive oxygen species (ROS) secreted by the host. Microbes that are highly resistant to ROS secreted by root cells may be difficult to control once they are in the endosphere—and especially when they become intracellular. Microbes that enter root cells and situate in close contact with root cell plasma membranes may be able to extract more nutrients from plant cells and may more frequently trigger cell death. Micrococcus luteus and Aureobasidium pullulans are good examples where this may be occurring. Both microbes are resistant to ROS due to production of antioxidants. Micrococcus luteus produces antioxidant carotenoids, catalases, peroxidases and other antioxidant enzymes that reduce the negative effects of host secreted ROS (Mohanna, Thippeswamy and Abhishek, 2013). Similarly, Aureobasidium pullulans possesses antioxidant cell wall components mannans and glucans (Machova and Bystricky, 2013) and because they are eukaryotic, their plasma membranes are reinforced with ergosterol to stabilize the membrane and prevent passage of ROS into the cytoplasm (White et al., 2018). This oxidative resistance appears to enable Micrococcus luteus and Aureobasidium pullulans to proliferate within root cells in an unregulated manner. Overgrowth of these microbes within root cells and tissues results in diversion of seedling nutrients from support of seedling growth to microbe replication—resulting in seedling growth suppression. This is especially evident in the case of Micrococcus luteus where inoculated seedlings on agarose were found to have repressed root growth with bacteria accumulating en masse around seedling roots.

Mode of Entry of Micrococcus luteus Entry into Root Cells

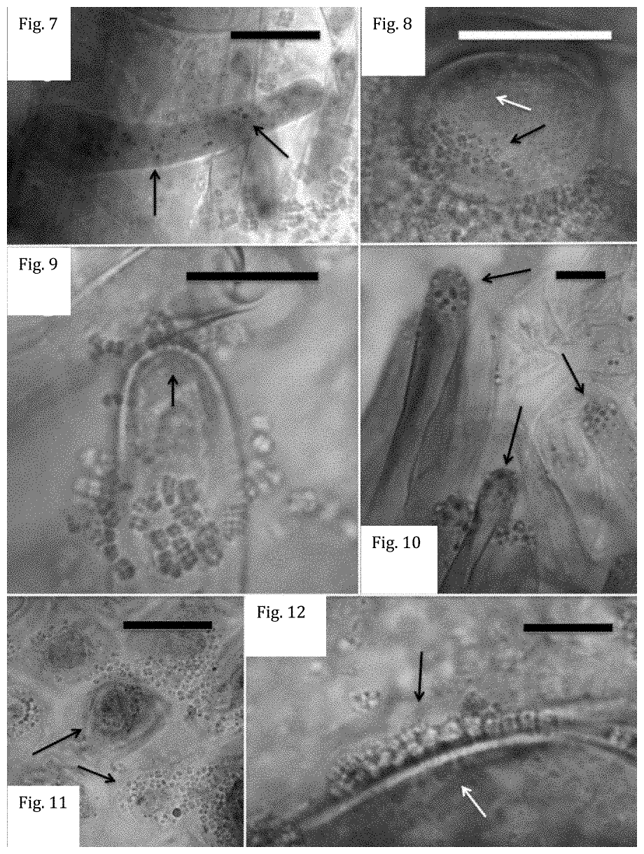

We tracked Micrococcus luteus through seedling tissues and cells in the previously described ‘endobiome interference’ experiments. Micrococcus luteus initially infected root meristem cells—entering periplasmic spaces of outer layers of root tip meristem cells as walled tetrads (FIGS. 2 and 3). As root cells matured the tetrads converted to unicellular cells—likely L-forms. Spherical cells (wall-less L-forms) were visible in periplasmic spaces of root epidermal cells and root hairs when they formed (FIGS. 5-8, 12). The spherical cells did not swell or lose capacity to stain with aniline blue, suggesting that plant ROS was not degrading the intracellular bacterial cells. This is an indication that Micrococcus luteus is resistant to ROS produced by NOX on the root cell plasma membranes. When less oxidatively-resistant pseudomonads are used, L-forms in periplasmic spaces are seen to swell and they lose interior staining with aniline blue due to loss of cell contents by the L-forms (White et al., 2014; White et al., 2017). The spherical bacteria of Micrococcus luteus in primordial root hairs were seen to exit root hair tips through channels in the plant cell walls; once outside bacteria reformed walls and tetrad shapes (FIGS. 8-12). This route of bacteria through root tissues is what has been observed for bacteria in the rhizophagy cycle (Prieto et al., 2018). It seems evident that microbes that show endobiome interference are partially compatible with host plants, but they are not adapted to the host like native symbiotic microbes—and rather than increase growth and survival of seedlings, they reduce growth and/or increase seedling mortality.

Intracellular Phases of Aureobasidium pullulans and Rhodotorula sp.

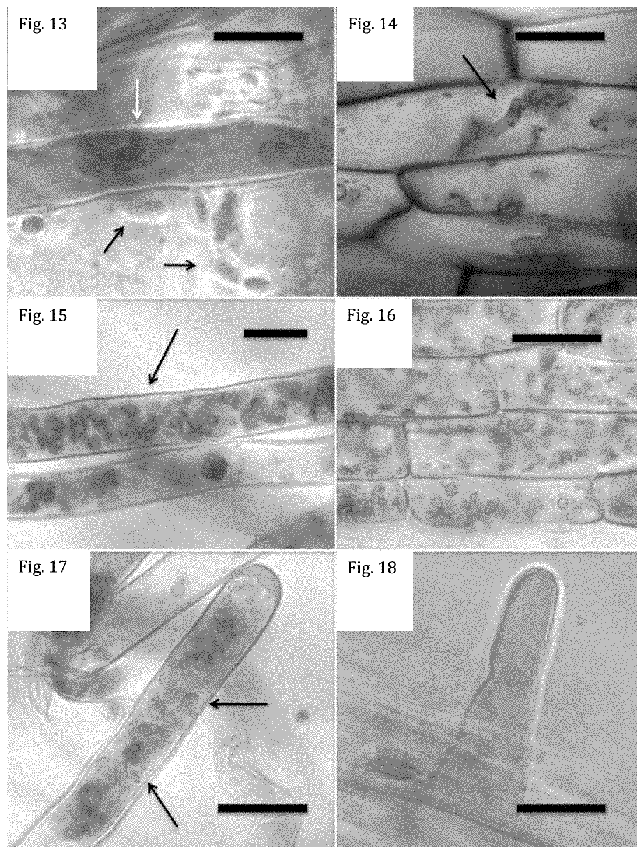

Atsatt and Whiteside (2014) demonstrated that Aureobasidium pullulans and Rhodotorula pinicola develop an intracellular phase in plants. The intracellular phase includes cells that retain cell walls and those forms that lack cell walls termed ‘mycosomes’. Our experiments with various Amaranthaceae indicate that Aureobasidium pullulans may be a frequent endophyte in this family of plants. In Abrus precatorius Rhodotorula sp. appears to be a common seed-vectored endophyte. Mycosomes appear to behave like bacterial L-forms in that they bud or ‘bleb’ sequentially to form chains (Atsatt and Whiteside, 2014). The wall-less mycosome phase may also be a response to plant-produced reactive oxygen or to particular nutrients to which fungi are exposed to in plant tissues. Mycosomes have also been reported to spontaneously revert to the walled cell phase. Intracellular walled Aureobasidium cells are visible in FIGS. 13 and 14, while mycosomes are seen in FIGS. 15-17. Yeasts appear to be entering root cells at the root tip meristems, similar to bacteria based on presence of mycosomes in meristematic cells in our inoculation experiments.

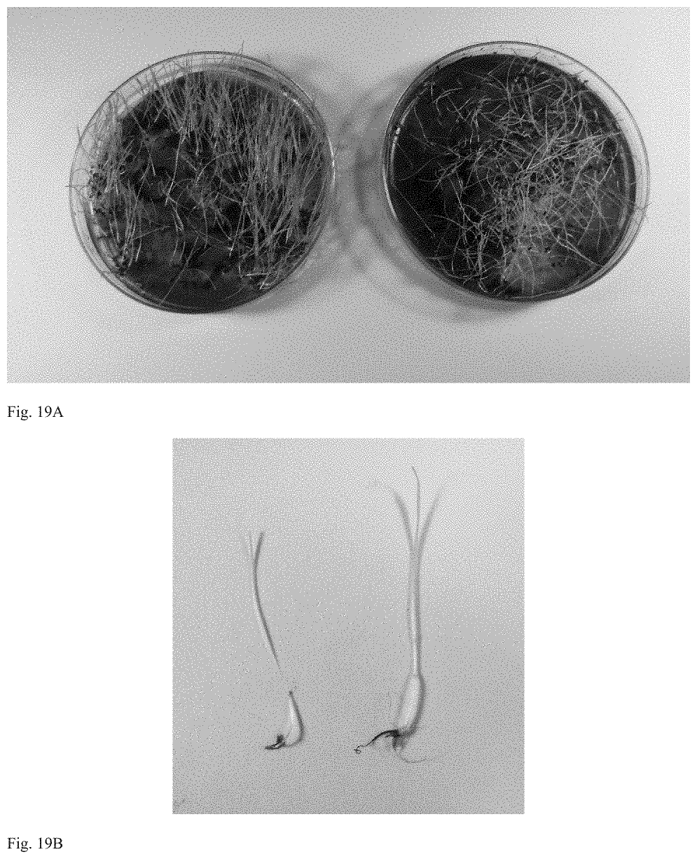

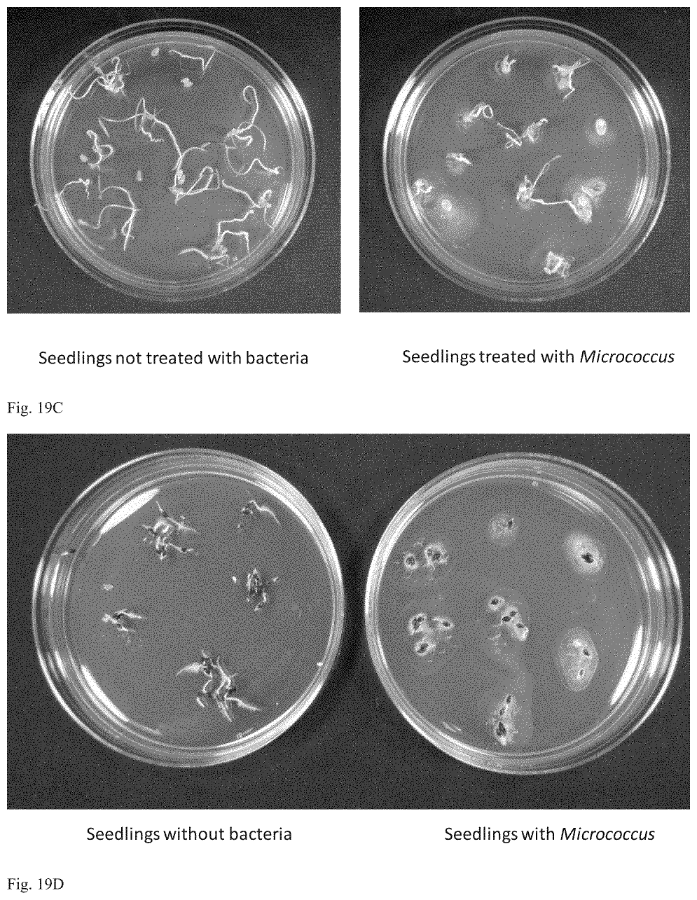

FIGS. 19A to 19D show the effects of M. luteus treatment on root length/growth in a variety of different species. FIG. 19A. Micrococcus-treated Poa annua seedlings do not grow properly in the agarose assays. Seedling roots are undeveloped and seedlings lodge rather than stand upright. FIG. 19B. Suppression of root development is seen in Micrococcus-treated Poa annua seedlings (arrows indicate root tips; seedlings are 10-days-old; stained with DAB). FIG. 19C. Carrot (Daucus carota; Apiaceae) Seedlings are Inhibited by Micrococcus. FIG. 19D. Japanese knotweed (Fallopia japonica Polygonaceae) seedling growth is also inhibited by M. luteus. Taraxacum officionale and Amaranthus caudatus seedling growth is also inhibited by treatment with M. luteus.

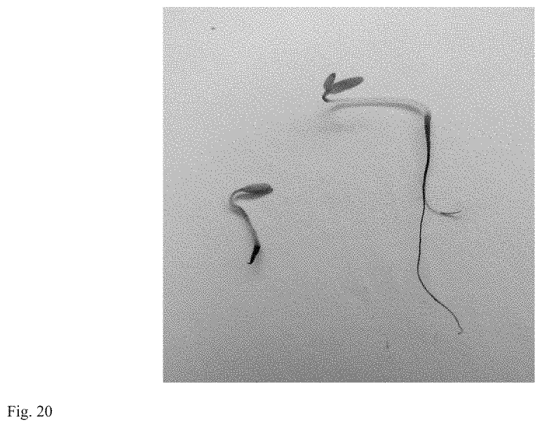

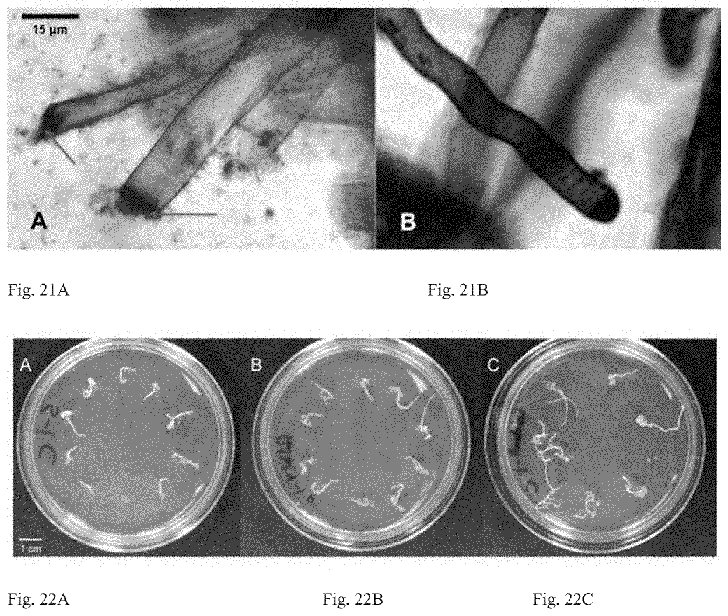

FIG. 20 shows the effects of treatment with yeast Aureobasidium (Froelichia #2)-inoculated seedling (left) compared to control seedling (right) of Amaranthus hypochondriacus containing only native endophytic bacteria. Seedlings were stained overnight with DAB to visualize reactive oxygen in roots (brown coloration). Both seedlings are 7 days old.

### Endobiome Interference Affects Plant-Plant Interactions

Some plants may maintain microbial symbionts and nourish them within tissues and cells as defensive or offensive weapons that can be employed against competitor plant species. The plants from which we obtained seed-vectored microbes in the endobiome interference experiment are generally aggressive weedy species. Notably, tomato plants are known to have allelopathic properties—where tomato plants may suppress growth of some other plant species. Abrus precatorius, Froelichia gracilis and Poa annua are competitive, and may be invasive. We suggest that these species use their endobiomes against competitor plant species—where microbes may colonize competitor seedlings and reduce their growth and persistence. This possibility seems likely when it is considered that microbes in the rhizophagy cycle alternate between an endophytic/intracellular phase and a free-living soil phase (Prieto et al., 2017; Verma et al., 2018; White et al. In press). These microbes may move out from the plant, forming a zone around plants where certain vulnerable competitor species cannot grow. Seedlings of competitor species that begin to grow in that zone would be colonized and their nutrients used by the microbes for their own reproduction; return of bacteria to the original host plant and reentry into the endosphere of that plant may deliver nutrients that were extracted from the competitor plant species. In a previous study (White et al., 2017) of seed-vectored pseudomonads from invasive Phragmites australis pseudomonads were seen to promote the growth of grass seedlings but were seen to inhibit growth of competitor dicot species (Taraxacum officionale and Rumex crispus). It is also conceivable that plant species that share endobiome microbes where those microbes are growth promotional in both plant species may grow together; endobiome interference may force plants apart.

### Applications of Endobiome Interference to Control Invasive or Weedy Plant Species

Invasive and weedy plant control generally employs use of chemical herbicides. Endobiome interference offers a non-chemical means whereby particular weeds could be controlled without herbicides (Kowalski et al., 2014). Thus, growth of crop species can be enhanced, and growth of weedy competitor species simultaneously repressed through applications of microbes that growth promotional in crops—but produce endobiome interference in competitor plants. Such an approach should reduce applications of agrochemicals in crops with economic and environmental benefits.

### Conclusions

Seed-vectored microbes play roles in modulation of seedling development, defense from abiotic and biotic stresses, defense from pathogens and herbivores, and nutrient acquisition. We have identified endobiome interference as a means whereby symbiotic microbes of one plant suppress growth of competitor plant species by reducing seedling growth and increasing seedling mortality. One mechanism of endobiome interference involves oxidative resistance of the microbe which reduces the capacity of host cells to control intracellular microbes using ROS produced by NOX enzymes on root cell plasma membranes. Endobiome interference is a factor in plant-plant interactions in natural plant communities and a strategy that can be employed successfully to control invasive or weedy plant species.

### Example II

### Inhibitory Endophytes in Grasses

Plants possess seed-transmitted host-adapted native endophytic microbes that associate with plants in the ‘rhizophagy symbiosis’. In the rhizophagy symbiosis microbes enter into root cells at the root tip meristem, becoming located within the periplasmic spaces, between the cell wall and plasma membrane, where root cell plasma membranes secrete superoxide onto bacteria, degrading them. Oxidative degradation of microbes in the rhizophagy symbiosis is thought to be a source of nutrients for plants. The microbes involved in the rhizophagy symbiosis also play roles in modulation of plant development, including stimulation of root gravitropic response (trigger roots to grow downward) and increasing root growth. Introduction of alien endophytic microbes from other hosts into a plant may displace native endophytes and disrupt functions of the rhizophagy symbiosis.

In this study of endobiome interference in seedlings of the grass Poa annua var. reptans, we first removed microbes from seeds through surface disinfection (40 min in 4% NaOCl), then we inoculated seeds with endophytic microbes obtained from several other plant species and assessed seedling growth on agarose after three days. Results of this experiment show: 1) two yeasts from invasive plants Froelichia gracilis and Abrus precatorius, respectively, entered into root cells and induced the highest gravitropic response in roots (indicating symbiotic compatibility) and the highest root growth repression (64% and 55.2% root growth repression; indicating endobiome interference), 2) the bacterium Micrococcus luteus induced a 51% root growth repression, 3) bacteria from several hosts were less effective in improving gravitropic response in seedlings or reducing root growth (with root growth repressions below 50%, 4) several of the microbes also were seen to reduce H₂O₂ secretion by roots, and 5) all microbes were microscopically confirmed in tissues of seedling roots. We hypothesize that suppression of H₂O₂ secretion from roots may be due to production of antioxidants by the microbes. The most effective microbes in suppression of root growth were the two yeasts, followed by Micrococcus luteus. The yeasts are known to produce higher levels of antioxidants (catalases, peroxidases, carotenoids and antioxidant cell wall polysaccharides) than many prokaryotes (Micrococcus luteus is an exception since it also produces high levels of antioxidants). Resistance of the two yeasts and Micrococcus luteus to degradation by reactive oxygen (superoxide) produced by the root cells enables them to proliferate within root cells and tissues without regulation by host roots, resulting in greater internal microbe growth and repression of root elongation. Essentially, these oxidatively-resistant microbes divert nutrients from root development to microbe development, resulting in root growth repression.

Endophytic microbes obtained from roots of seedlings obtained from surface disinfected seeds of several plants (Table 3A). Microbes suspended in water and inoculated onto surface-disinfected seeds of Poa annua var. reptans on agarose. After three days seedling root gravitropic response and root lengths were determined, and agarose plates stained for H₂O₂ using diaminobenzidine tetrachloride. Roots were examined microscopically to confirm intercellular and intracellular location of microbes in plant roots.

TABLE 3A
Gravitropic response (%), root length growth, and root hydrogen peroxide secretion
after three days of growth of poa annua var. reptans seedlings inoculated
with microbes obtained from seedlings of several other plants

| | | Gravitropic | | |
|---|---|---|---|---|
| Strain | Host | resp.* | Root length | H₂O₂^{t} |
| No microbes | N/A | 18.29% (n = 66) | 8.7 ± 1.6 mm (n = 21) | +++ |
| Rhodotorula | Abrus sp. | 83.3% (n = 30) | 3.1 ± 1.2 mm (n = 14) | + |
| Aureobasidium | Froelichia sp. | 79.1% (n = 43) | 3.9 ± 1.3 mm (n = 21) | ++ |
| Micrococcus sp. | Lycopersicum | 70.6% (n = 34) | 4.2 ± 1.6 mm (n = 16) | + |
| Rhodococcus | Abrus sp. | 75% (n = 48) | 4.5 ± 1.5 mm (n = 21) | ++ |
| Curtobacterium | Abrus sp. | 69.3% (n = 39) | 4.6 ± 1.9 mm (n = 19 | ++ |
| Paenibacillus | Poa annua | 63% (n = 31) | 4.7 ± 1.7 mm (n = 17) | + |

*Gravitropic response (%) was calculated as number of seedlings with roots growing downward/total number of roots × 100.
^{t}H₂O₂ intensity in medium scored as +++ = high H₂O₂ secretion, ++ = moderate H₂O₂ secretion, + = low H₂O₂ secretion.

We performed additional experiments using seeds of Kentucky bluegrass (Poa pratensis), common ragweed (Ambrosia sp.) and oregano (Origanum sp.) The results are shown in table 3B below.

TABLE 3B
Weed inhibitor endophytes from seeds of Kentucky bluegrass (Poa pratensis),
common ragweed (Ambrosia sp.) and oregano (Origanum sp.)

| Strain | | Plants | | | | |
|---|---|---|---|---|---|---|
| name | Source | Inhibited | SEQ ID | | | |
| (genus) | (seeds) | (roots) | NO: | Disclosures | Protease | Phosphatase |
| PP16 (Pseudomonas sp.) | Poa pratensis | Dandelion | (16) | None | + | + |
| PP21 (Exiguobacterium sp.) | Poa pratensis | Dandelion | (17) | None | + | − |
| PP4-F (Pseudomonas sp.) | Poa pratensis | Clover | (18) | None | − | + |
| AA3A (Bacillus sp.) | Ambrosia sp. | Clover, Dandelion | (13) | None | + | − |
| Aa2 (Bacillus sp.) | Ambrosia sp. | Clover | (12) | None | + | − |
| AA15 (Bacillus sp.) | Ambrosia sp. | Clover, Dandelion | (11) | None | + | − |
| OVLBP2R (Methylobacter sp.) | Oregano | Dandelion | (9) | None | + | + |
| OVYP4AD19 (Sphingomonas sp.) | Oregano | Dandelion | (10) | None | + | − |
| OMPDAP5BK (Bacillus sp.)* | Oregano | Dandelion | (15) | None | + | − |
| OMYESP3B (Terribacillus sp.) | Oregano | Dandelion | (14) | None | + | − |

*Isolate was stimulatory to corn, wheat and potato.

### Example III

### Bacteria Associated with Smooth Crabgrass (Digitaria ishcaemum) Seed Inhibit Competitor Plant Species

Digitaria (crabgrass) species are some of the most competitive C₄ weeds of agricultural, horticultural and turfgrass landscapes in tropical and temperate regions. Digitaria ischaemum and D. sanguinalis (smooth and large crabgrass, respectively) are the some of most problematic weed species in the United States and are particularly well adapted to turfgrass systems where as a C₄ species they often outcompete C₃ grasses and forbs in the summertime (Kim et al. 2002). Digitaria sanguinalis is known to produce allelochemicals that may contribute to its competitiveness but these have not been studied extensively (Zhou et al. 2013a,b).

Poa annua is another prolific early successional C₃ plant that is extremely competitive in turfgrass and horticultural systems and can be found on all seven continents (Chwedorzewska et al. 2015). The success of P. annua as a weed is attributed to genotypic variability, prolific seed production, and a short life cycle (Beard 1978).

The weed microbiome may also contribute to weed competitiveness. Communities of bacteria and fungi, which colonize internal tissues as commensals or mutualists are referred to as endophytes and are ubiquitous in plants (reviewed in Hardoim et al. 2008, Truyens et al. 2015, Wilson 1995). A wide range of endophytes are commonly found in plants, although there are several potential mechanisms that reduce microbial endophyte density and diversity when compared with the root rhizosphere (Hardoim et al. 2008, Compant et al. 2010). These endophytes can affect tolerance to abiotic and biotic stressors such as disease, drought, heat and salinity (Podolich et al 2015, Rodriguez et al. 2009).

The well-studied Epichloë endophyte symbionts are known to confer enhanced drought tolerance and resistance to insect herbivory in grasses (Clay 1990, Schardl 2001). These fungi are vertically transmitted through seed of the host plant. It is thought that early-successional weeds may rely on associations with non-clavicipitaceous endophytes to increase their competitiveness, although these have not been studied extensively (Trognitz et al. 2016). Two exceptions are endophytes associated with Centaurea stoebe and Phragmites australis, which can be invasive outside of their native range. A sampling of fungal endophytes associated with C. stoebe achenes (seeds) in the invaded range (North America) found that they were more diverse and were taxonomically different than those associated with plants in the native (European) range (Shipunov et al. 2008). Other researchers found C. stoebe infected with a fungal endophyte from the native range and another endophyte common to the non-native range suppressed competitor grasses of the invaded range more than grasses in the native range (Aschehoug et al. 2012). There is considerable diversity among fungal endophytes of P. australis in North America as well, although the contribution of these endophytes to fitness of mature plants is unknown (Clay et al. 2016). However, other researchers have demonstrated that P. australis seed-associated bacteria and fungi from native and invaded ranges can enhance germination, seedling growth and antagonize other species (Ernst et al. 2003; Shearin et al. 2017, White et al. 2017).

Although Digitaria ischaemum and Poa annua are not classified as invasive weeds like P. australis and C. stoebe, they are very prolific in North America outside of their native Eurasian range (Anton and Connor 1995, Kim et al. 2002). However, it is not known whether endophytes affect competitiveness of Digitaria spp. or P. annua. Poa annua endophytes have not been reported, but this weed has been found to cause changes in the soil microbial community that affect the fitness of mid-successional species (Kardol et al. 2007). Previous research has examined fungal endophytes of Digitaria spp., but not seed-associated bacteria. Zhou et al. (2015) found over 20 different fungal taxa endophytic to roots of D. ischaemum grown in a geothermal soil in China. They found most of these endophytic fungi of D. ischaemum were also found in the rhizospheric soil, but there were some species found only in the plant, including Curvularia protuberata, suggesting endophytes were vertically or horizontally transmitted. Other researchers have demonstrated that C. protuberata colonized by a virus increases thermotolerance of Dichanthelium lanuginosum (panic grass) (Redman et al. 1999, 2002, Mirquez et al. 2007). This previous research with Digitaria spp. endophytes did not examine their role in antagonizing competitor plants.

Compared to endophytes of root and shoot tissues, considerably less research has been conducted on seed-associated bacteria. Prolific seed production is a key strategy for P. annua and D. ischaemum survival. Where P. annua populations are high, seedbank densities have been reported at between 20,000 and 200,000 seeds per m² (Lush 1988). D. ischaemum and D. sanguinalis are annuals that survive by prolific seed production and can produce up to 188,000 seeds per plant (Kim et al. 2002). Bacterial endophytes have been isolated from seed of several food crop species including rice (Oryza sativa), maize (Zea mays) as well as certain grass species (reviewed by Truyens et. al 2015). These endophytes can be important for seedling growth and development and can contribute to the endophytic community of a mature plant (Puente et al. 2009, Ringelberg et al. 2012). Fungal endophytes can be vertically transmitted via seed in forbs as demonstrated by Hodgson et al. (2014), who observed cultivable fungal endophytes in true leaves of various forb seedlings grown in aseptic conditions after surface-sterilization. In grasses, bacterial endophyte transmission from mature maize parents to seed offspring was demonstrated by Liu et al. 2012. It is possible that these endophytes are vertically transmitted because they benefit the host plant. Cultivable diazotrophic endophytes of Pennisetum purpureum, a perennial C₄ plant that is capable of producing large amounts of biomass under low or high N2 fertilization were found to produce indole acetic acid and solubilize phosphate and may play a role in the competitiveness of this C₄ grass in the wild (Videira et al. 2012).

We tested whether bacteria and fungi associated with D. ischaemum and P. annua seed antagonize competitor species and enhance the ability of host seedlings to grow.

### Materials and Methods for Example III

### Seed Collection

Digitaria ischaemum seed was collected from a single site at the Rutgers Horticultural Research Farm No. 2 in North Brunswick, N.J. (40°45′25″N 74°47′67″W). The site consisted of a mixed stand of D. ischaemum and Lolium perenne maintained as a mowed stand of turfgrass for several years. Mowing was suspended in October to allow inflorescence production and maturity prior to harvest in November. Seed was collected from a 300 m² area using a leaf sweeper. Seeds were stored at 13° C. until they were moved to storage at −20° C. for one week prior to preparation to break seed dormancy. Poa annua seed was collected from a single site in University Park, Pa. (40°81′09″N 77°86′73″W) that was maintained as a mowed turfgrass stand for several years. Seeds were stored at 13° C. until they were moved to storage at −20° C. for one week prior to preparation to break seed dormancy.

### Surface Sterilization and Endophyte Isolation

P. annua and D. ischaemum seeds were surface sterilized by placing 5 g of seed in a 200 mL container filled with a 160 mL solution of DI water and 4.125% (v/v) NaOCl based on the methods of White et al. (2017). This container was placed on an orbital shaker to vigorously agitate the solution for 40 minutes. The bleach solution was then decanted and seeds were rinsed at least five times with sterile DI water in a laminar flow hood. Seeds were then placed on Petri dishes containing yeast extract sucrose agar (YESA) and the plates were incubated at room temperature. Four seeds were placed on each plate and there were 10 replicates. The process was repeated with D. ischaemum seed one week later with 8 replicates; a second 5 g sample of seed was sterilized using the same process except that 5 μL of polysorbate 20 (Tween20, Thermo Fisher Scientific, Waltham, Mass.) was added to the 160 mL of 4.125% (v/v) NaOCl solution. Outgrowing fungi were observed after 48 h of incubation and isolated for further study. After 7 to 14 d of incubation, bacteria were observed and isolated for further study. No outgrowing fungi or bacteria were observed in surface-sterilized P. annua seed. Therefore, using the same methods described above except without NaOCl, P. annua seeds were agitated in sterile water for 5 minutes and then the water was decanted and seeds were rinsed with sterile water before placing on YESA to isolate bacteria.

### Bacterial Identification and Characterization

Genomic DNA from bacteria was isolated using GenElute Bacterial Genomic DNA Kits (SigmaAldrich, St. Louis, Mo.). Bacterial identifications were made by obtaining 16S rDNA sequences after methods employed by Lane (1991) using universal primers 16SF (5′-AGAGTTTGATCCTGGCTCAG-3′; SEQ ID NO:37) and 16SR (5′-CTACGGCTACCTTGTTACGA-3′; SEQ ID NO:38). Amplified PCR products were resolved by electrophoresis in 1.5% (w/v) agarose gel stained with SYBR safe for visual examination. The PCR products were purified using a PCR purification kit (Qiagen, USA) and sent to Genewiz Inc. (South Plainfield, N.J.) for sequencing.

Sequences were compared to GenBank accessions using BLAST on the world wide web at ncbi.nlm.nih.gov. Sequences for isolates 4, 5, and 12 were deposited in GenBank under accession numbers MG100861-MG100863.

Experiment 1: Effect of Bacterial Isolates on Taraxacum officinale Seedling Mortality

In turfgrass systems, Taraxacum officinale is a common competitor forb and was selected for use in these experiments. T. officinale seeds were surface sterilized using the same process described above for D. ischaemum surface sterilization (agitation with 4.125% NaOCl for 40 min). Ten T. officinale seeds were plated onto each experimental unit, which consisted of a Petri dish (85 mm diameter) filled with 0.7% agarose media. Isolates were maintained on trypticase soy agar (TSA) and streaked onto Luria-Bertani (LB) agar 12 to 24 h before inoculation. The bacteria were then removed from the agar with an inoculation loop and suspended in 1 mL of sterile water. One 3 μl drop of bacterial suspension was pipetted onto each seed within 1 h of placement on agarose. Each isolate was evaluated in triplicate on a total of 30 seeds. A non-treated axenic control was included for comparison. A Pseudomonas fluorescens (Sandy LB4; GenBank No. KX665565) and Pantoea sp. isolate (RiLB4; GenBank No. KX752781) isolated from Phragmites australis seed by White et al. (2017) were included as standards of comparison. The Sandy LB4 isolate has been shown to increase mortality of competitor forbs while RiLB4 did not affect mortality.

T. officinale seedlings were assessed as healthy, injured or dead at 14 days after treatment. Seedlings were considered healthy if cotyledons and leaves were green in color, turgid and not displaying any symptoms of cell membrane leakage (necrosis or greasy, off-color leaf tissues). Seedlings were considered dead if they were completely necrotic. Seedlings were scored as injured if they displayed some injury symptoms but were not completely dead. The number of healthy, injured, and dead plants was assessed in each Petri dish and this number was used to determine the percentage of healthy, injured or dead plants in each experimental unit (Petri dish) based on the total number of plants that germinated. Germination was considered to have occurred if a radicle at least 1 mm in length was visible. Not all bacterial isolates were evaluated on the same date. Therefore, separate non-treated axenic controls were used in each run for comparison. Using isolates that increased mortality compared to the non-treated control, this experiment was repeated on T. officinale and T. repens. T. repens is also a common competitor species in turfgrass. T. repens seeds were surface-sterilized using a similar method as T. officinale except that a 2% (v/v) NaOCl solution was used instead of a 4.125% solution. To ensure this method effectively sterilized clover seed, 100 seeds were placed on LB agar and no bacteria or fungi were observed after 10 d of incubation.

After T. officinale plants were evaluated at 14 days after treatments, the agarose plates containing seedlings were flooded with a 2 mmol/L solution of 3,3-diaminobenzidine tetrahydrochloride (DAB; Sigma Aldrich, St. Louis, Mo.) 12 h prior to observation to aid in visual observation of bacteria (White et al. 2014). Randomly selected plants were removed from the agarose and squash prepared with aniline blue (0.01%) for microscope observation.

Experiment 2: Effect of Bacterial Isolates on D. ischaemum Germination and Seedling Mortality

Based on the results of Experiment 1, certain bacterial isolates were evaluated against surface sterilized D. ischaemum seedlings. To successfully remove cultivable bacteria from D. ischaemum seeds required several iterations of various sterilization procedures before finding an effective method. Seeds were placed on mesh screen and a wooden block was used to rub the seeds through the plastic screen, which removed the paleas and lemmas. These seeds were then placed on a finer plastic screen and a wooden block wrapped in the same screen was rubbed on the seed to remove the seed coat. The naked seeds were separated from the debris and put into a 2 mL microcentrifuge tube filled with 1.5 mL of a 1.5% (v/v) NaOCl solution. The tube was vortexed for 5 min, the NaOCl solution was removed and fresh solution was added before vortexing again for 5 min. Seeds were then rinsed several times with sterile water. To ensure this method effectively sterilized D. ischaemum seed, 100 seeds were placed on LB agar. No bacteria were observed after 10 d of incubation and a Curvularia sp. was observed outgrowing from 2/100 seeds.

Surface-sterilized D. ischaemum seeds were placed on agarose and inoculated with bacteria in the same manner as described in Experiment 1. T. officinale seeds were also included in the experiment as a standard of comparison to Experiment 1. This experiment was conducted once, but was repeated with Isolates 4 and 5 within Experiment 3.

Experiment 3: Effect of Bacterial Isolates Alone and in Combination with Curvularia sp. on D. ischaemum, T. Repens and P. annua Seedlings.

The effects of certain bacterial isolates alone and in combination with a Curvularia sp. on germination and mortality of D. ischaemum and T. repens were then evaluated. This experiment was conducted twice on separate dates.

Surface-sterilized seeds were placed on agarose and inoculated as described previously. Seeds were inoculated with bacterial isolates 4 and 5, the combination of 4+5, RiLB4 (standard), or no bacteria alone and in combination with a Curvularia sp. isolate collected outgrowing from D. ischaemum seed forming a factorial treatment design. Bacterial isolates were prepared and inoculated onto seeds in the same manner as described for Experiment 1; isolates 4 and 5 were combined by taking an aliquot of each bacterial suspension and combining them in a 1:1 ratio. A suspension of Curvularia conidia was prepared by gently washing a potato dextrose agar lawn culture with a solution of sterile water and 0.05% polysorbate 20 and lightly scraping with an inoculation loop. This resulted in a suspension that contained some hyphae but was primarily conidia. Four 10 μl aliquots were sampled and evaluated with a hemocytometer grid to determine the conidia concentration. Within 2 h of spore suspension preparation, a 2 or 4 μl drop (run A and B, respectively) was applied to each seed to inoculate 10³±200 conidia per seed.

The effect of each treatment on germination and seedling mortality was evaluated as previously described in Experiment 1. P. annua was used as a model plant to evaluate the effect of these treatments on root gravitropism and root length based on previous research (Verma et al. 2017, White et al. 2017). For each P. annua seedling, it was determined whether the root penetrated vertically into the agarose or grew horizontally along the surface of the agarose at 14 days after inoculation. Roots penetrating the agarose were determined to have a positive gravitropic response and the percentage of roots demonstrating a positive gravitropic response is presented (Verma et al. 2017). P. annua root length was measured by removing the plant from the agarose and measuring the length of the primary root with a ruler.

### Statistical Analysis

Experimental units were arranged in a completely randomized design in all experiments. For each experiment, the ANOVA was conducted using the GLM procedure in SAS (SAS Institute, Cary, N.C.) v9.4 (p<0.05). Means were separated using Fisher's Protected LSD test at the 0.05 level.

### Bacterial and Fungal Isolates

Nine morphologically unique bacterial isolates were selected from non-surface sterilized P. annua seed. No bacteria or fungi were observed outgrowing from surface sterilized P. annua seed. Fifteen isolates were selected from surface sterilized D. ischaemum seeds (Table 4). Of these fifteen isolates, twelve were morphologically similar. Of these twelve morphologically similar isolates (5, 8, 9, 10, 12, 16, 17, 18, 21, 22, 23), two were sequenced (isolates 5 and 12) and determined to be two genetically different Pantoea spp. (Genbank No. MG100862 and MG100863). Isolate 4 was morphologically distinct and was also determined to be a Pantoea sp. (Genbank MG100861). Two unique fungal species were isolated and determined to be Epicoccum and Curvularia spp. through morphological characterization (Barnett and Hunter, 1998). A Curvularia sp. was observed on 55% and 28% of the seeds in the first and second experimental run, respectively, and was isolated for further experimentation given its prevalence on surface-sterilized seed in this experiment and previous reports of Curvularia sp. affecting thermotolerance (Redman et al. 1999, 2002, Mirquez et al. 2007). An Epicoccum sp. was observed outgrowing from 4 of 40 seeds in the first run and 10 out of 32 seeds in the second run.

TABLE 4
Effect of bacteria collected outgrowing from surface-sterilized
Digitaria ischaemum seeds and non-sterile annual bluegrass
(Poa annua) on dandelion (Taraxacum officinale) seedling
mortality in axenic agarose culture 14 days after inoculation.
Isolates 1 to 6, 7 to 12, 13 to 18, and 19 to 24 were evaluated
in separate experiments in Run A. A non-treated control was
included in each experiment. Sandy LB4 and RiLB4 (Genbank No.
KX752781 and KX665565, respectively) were included as standards
and evaluated with isolates 7 to 12.

| | | Seedling | Seedlings |
|---|---|---|---|
| | | mortality | injured |
| Isolate No. | Isolated from | (%)^{†} | (%) |
| 1 (*) | P. annua | 0 | 21 |
| 2 (*) | P. annua | 0 | 5 |
| 3 (*) | P. annua | 0 | 7 |
| 4 (33) | D. ischaemum | 19*^{§} | 44* |
| 5 (34) | D. ischaemum | 47* | 87* |
| 6 (*) | P. annua | 0 | 6 |
| No bacteria | — | 0 | 18 |
| 7 (19) | P. annua | 0 | 11 |
| 8 (20) | D. ischaemum | 29 | 69* |
| 9 (21) | D. ischaemum | 13 | 42* |
| 10 (22) | D. ischaemum | 8 | 67* |
| 11 (23) | P. annua | 0 | 30* |
| 12 (36) | D. ischaemum | 10 | 67* |
| No bacteria | — | 0 | 3 |
| 13 (24) | D. ischaemum | 21 | 54 |
| 14 (25) | P. annua | 0 | 31 |
| 15 (*) | P. annua | 0 | 16 |
| 16 (26) | D. ischaemum | 10 | 27 |
| 17 (27) | D. ischaemum | 14 | 52 |
| 18 (28) | D. ischaemum | 23 | 40 |
| No bacteria | — | 0 | 22 |
| 19 (29) | P. annua | 0 | 45 |
| 20 (30) | D. ischaemum | 0 | 41 |
| 21 (31) | D. ischaemum | 39* | 80* |
| 22 (32) | D. ischaemum | 37* | 79* |
| 23 (*) | D. ischaemum | 0 | 36 |
| 24 (*) | D. ischaemum | 0 | 46* |
| RiLB4 | P. australis | 0 | 11 |
| Sandy LB4 | P. australis | 8 | 35 |
| No bacteria | — | 0 | 38 |

^{†}Percent mortality is the percentage of emerged seedlings that were determined by visual assessment to be completely dead. Seedlings were scored as injured if they displayed some injury symptoms but were not completely dead.
^{§}An asterisk indicates that the level of mortality or injury was significantly different from the non-treated control according to Fisher’s Protected LSD test (p = 0.05). Isolates were evaluated in four separate experiments; Numbers in parentheses are SEQ ID NOS:
*indicates not yet sequenced.

Experiment 1: Effect of Bacterial Isolates on Taraxacum officinale Seedling Mortality

Of the nine bacteria isolated from P. annua seed, none caused T. officinale seedling mortality (Table 4). Isolate 11 caused 30% T. officinale seedling injury, which was different than the non-treated control. Injury caused by other P. annua isolates was not different from the bacteria free control. This experiment indicates that bacteria isolated from non-surface-sterilized P. annua seed do not increase T. officinale seedling mortality.

While P. annua isolates had limited or no effects on T. officinale, D. ischaemum isolates 4, 5, 21 and 22 of caused seedling mortality of 19 to 47%. Isolates 4, 5, 8, 9, 10, 12, 21, 22, and 24 caused seedling injury that was greater than the bacteria free control.

When selected D. ischaemum isolates were evaluated in a second experimental run, isolates 5 and 8 caused 39 and 17% T. officinale seedling mortality, respectively (Table 5). All D. ischaemum isolates caused injury to >75% of T. repens seedlings at 7 days after inoculation and these seedlings likely would have completely died if observed 14 days after inoculation. In subsequent experiments mortality of inoculated seedlings increased between 7 and 14 days after inoculation. In previous research evaluating bacteria isolated from Phragmites australis, White et al. (2017) demonstrated that Pseudomonas fluorescens strain Sandy LB4 caused >70% T. officinale seedling mortality while a Pantoea sp. strain RiLB4 did not increase mortality compared to the axenic control. In our experiments, Sandy LB4 nor RiLB4 increased T. officinale mortality compared to the bacteria free control.

TABLE 5
Effect of bacteria collected outgrowing from surface-sterilized
Digitaria ischaemum seeds on dandelion (Taraxacum officinale)
seedling mortality 14 days after inoculation and white clover
(Trifolium repens) 7 days after inoculation in axenic agarose
culture. Only certain isolates were evaluated based on the results
of Run A. Isolates RiLB4 and Sandy LB4 (Genbank No. KX752781 and
KX665565, respectively) were isolated from Phragmites australis
and were included as standards.

| | T. officinale | | T. repens | |
|---|---|---|---|---|
| | Seedling | | Seedling | |
| | mortality | Seedlings | mortality | Seedlings |
| Isolate No. | (%)^{†} | injured (%) | (%) | injured (%) |
| 4 | 12 | 49* | 16* | 88* |
| 5 | 39*^{§} | 68* | 5 | 76* |
| 8 | 17* | 42* | 8 | 83* |
| 10 | 3 | 19 | 8 | 84* |
| 12 | 11 | 33* | 12 | 93* |
| 13 | 11 | 22 | 8 | 78* |
| 17 | 4 | 40* | 7 | 67* |
| 18 | 0 | 29* | 49* | 84* |
| 21 | 4 | 17 | 7 | 89* |
| 22 | 4 | 40* | 0 | 96* |
| RiLB4 | — | — | 0 | 36 |
| Sandy LB4 | 0 | 22 | 0 | 23 |
| None | 0 | 4 | 0 | 34 |

^{†}Percent mortality is the percentage of emerged seedlings that were determined by visual assessment to be completely dead. Seedlings were scored as injured if they displayed some injury symptoms but were not completely dead.
^{§}An asterisk indicates that this level of mortality was significantly different from the non-treated control according to Fisher’s Protected LSD test (p = 0.05).

Bacteria were observed in squash preparations of T. officinale root tips treated with isolates 4 and 5. Root hairs of seedlings treated with isolates 4 and 5 were malformed and the membrane at the tip of the root hair was often completely destroyed where bacteria were present (FIG. 21). Intact root hairs were observed in the axenic controls. Based on the results of this experiment, we selected certain isolates for further study.

Experiment 2: Effect of Bacterial Isolates on D. ischaemum Germination and Seedling Mortality.

Isolate 22 and the combination of isolates 4 and 5 reduced D. ischaemum germination to 33 and 20%, respectively (Table 6). Other isolates did not reduce germination compared to the bacteria free control. Isolates 8 and 22 increased D. ischaemum seedling mortality at 14 days after inoculation compared to the bacteria free control. Low germination prevented a proper assessment of the effect of the isolate 4+5 combination on D. ischaemum seedling mortality; these data were removed from the statistical analysis and are not presented. T. officinale was included to aid comparison to other experiments. All isolates except isolate 18 increased T. officinale mortality; a similar response was observed in Experiment 1. Based on the results of Experiments 1 and 2, we selected isolates 4 and 5 for further study.

TABLE 6
Effect of Pantoea spp. isolates on Digitaria ischaemum germination
and seedling mortality 14 and 28 days after inoculation in axenic agarose
culture. Ten seeds were placed in each Petri dish and each treatment was
replicated in three Petri dishes. Taraxacum officinale seeds were
also inoculated in separate Petri dishes and included for comparison;
mortality was evaluated at 21 days after treatment.

| | | | Seedling mortality (%)^{†} | | | | |
|---|---|---|---|---|---|---|---|
| Bacterial | D. ischaemum | | D. ischaemum | | | T. officinale | |
| isolate | Germination (%) | | 14 days | | 28 days | 21 days | |
| 4 | 40 | abc^{§} | 0 | B | 29 | 71 | a |
| 5 | 53 | Ab | 6 | ab | 13 | 86 | a |
| 8 | 43 | Ab | 18 | A | 43 | 78 | a |
| 18 | 43 | Ab | 0 | ab | 7 | 33 | b |
| 22 | 33 | Bc | 19 | A | 17 | 79 | a |
| 4 + 5 | 20 | C | — | — | — | 72 | a |
| None | 57 | A | 0 | B | 0 | 17 | b |

^{†}Percent mortality is the percentage of emerged seedlings that were determined by visual assessment to be completely dead.
^{§}Means followed by the same letter are not significantly different according to Fisher's Protected LSD test (p = 0.05). In columns where no letters are present, the ANOVA determined that the treatment effect was not significant (p ≤ 0.05).

Effect of Bacterial Isolates Alone and in Combination with Curvularia sp. on D. ischaemum, T. Repens and P. annua Seedling Mortality

Germination of P. annua and T. repens was 93 and 83%, respectively and was not affected by bacteria or Curvularia treatment (data not presented). D. ischaemum germination was reduced from 71% to 34% by Curvularia, but was not affected by bacterial treatment (data not presented). Among seedlings that germinated, the main effect interaction of bacteria and Curvularia treatment was significant for T. repens seedling mortality 2 weeks after inoculation, (Table 7). Bacterial isolates 4 and 5 alone or in combination with each other caused between 57 and 81% T. repens mortality compared to 0 and 4% for RiLB4 and the bacteria free control (FIG. 22). When inoculated with Curvularia, seedling mortality was similar across all treatments (64 to 87%).

TABLE 7
Effect of Pantoea spp. isolates alone and in combination with
Curvularia sp. spores outgrowing from surface-sterilized Digitaria
ischaemum seeds on Trifolium repens seedling mortality 14 days after
inoculation in axenic agarose culture. Ten seeds were placed in each
Petri dish and each treatment was replicated in three Petri dishes per
experimental run. Combined results of two experimental runs are
presented. A Pantoea sp. (RiLB4; Genbank No. KX752781)
isolated from Phragmites australis and was included as a standard.

| Bacterial | | Seedling mortality (%)^{†} | |
|---|---|---|---|
| isolate | Curvularia | T. repens | D. ischaemum |

| | | | | | |
|---|---|---|---|---|---|
| 4 | No | 67 | a^{§} | 19 | b |
| 5 | No | 81 | A | 31 | B |
| 4 + 5 | No | 57 | A | 2 | B |
| RiLB4 | No | 0 | B | 0 | B |
| None | No | 4 | B | 3 | B |
| 4 | Yes | 73 | A | 77 | A |
| 5 | Yes | 87 | A | 63 | A |
| 4 + 5 | Yes | 87 | A | 68 | A |
| RiLB4 | Yes | 64 | A | 77 | A |
| None | Yes | 73 | A | 83 | A |

^{†}Percent mortality is the percentage of emerged seedlings that were determined by visual assessment to be completely dead.
^{§}Means followed by the same letter are not significantly different according to Fisher’s Protected LSD test (p = 0.05).

Curvularia also increased D. ischaemum mortality regardless of bacteria treatment. When averaged across bacterial treatments, Curvularia increased D. ischaemum mortality from 11% to 73%. Bacterial isolates 4 and 5 alone or in combination did not affect D. ischaemum mortality compared to RiLB4 and the bacteria free treatment, although there is a non-significant trend that bacteria 4 and 5 alone increased mortality compared to the combination of 4+5, RiLB4 and the bacteria free control.

The bacteria treatments did not affect P. annua mortality (data not presented). The interaction of bacteria and Curvularia treatment on P. annua mortality and root gravitropic response was not statistically significant and therefore will not be presented. However, the main effect of Curvularia was significant. When averaged across all bacterial treatments, Curvularia increased P. annua mortality from 0 to 6% and the fraction of plants injured from 5 to 10%. Curvularia sp. treatment increased the positive gravitropic response of P. annua roots. When averaged across bacterial treatments, 57% of roots inoculated with Curvularia demonstrated a positive gravitropic response compared to 21% of roots without Curvularia. Bacteria treatments did not affect root gravitropism (data not presented). Curvularia nor bacteria treatments affected P. annua root length.

### Observation of Bacteria in Seedling Roots

T. repens and T. officinale root hairs stained with DAB after inoculation with isolate 5 were often malformed and bacteria were observed around root hairs but not usually in the cytoplasm; observations of root hairs treated with isolate 4 were similar except that L-forms of bacteria were occasionally observed in root hair cytoplasm. In every observation (n>20) of DAB stained roots of seeds inoculated with bacteria, large numbers of bacterial rods were present in the rhizosphere, while no bacteria were observed in the rhizosphere of axenic controls. Conclusions from microscopic observations are limited, and the mechanism by which these bacteria kill T. repens and T. officinale should be investigated in more detail.

### Discussion

Our experiments demonstrate that D. ischaemum seed contains cultivable bacteria of the Pantoea genus and at least two cultivable fungi in genera Epicoccum and Curvularia. Several Pantoea spp. isolates increased seedling mortality of competitor forbs more than D. ischaemum in axenic culture indicating some selectivity. Pantoea spp. have been isolated as epiphytes from the phyllosphere of many plant species and non-sterilized Oryza sativa and Phragmites australis seed (Cottyn et al. 2001, Walterson and Stavrinides 2015, White et al. 2017). Ferreira et al. (2008) demonstrated that a P. agglomerans strain can colonize Eucalyptus seedlings after being inoculated onto the seed. As plant epiphytes, Pantoea spp. can behave as growth promoters, plant pathogens, and disease suppressors; some strains are registered as commercial products (reviewed by Walterson and Stavrinides 2015). However, we are not aware of any research demonstrating the efficacy of Pantoea spp. for selective weed control. Research evaluating seed-associated bacteria as antagonists of competitor forbs is also limited. White et al. (2017) found that mixtures of certain bacteria associated with Phragmites australis seed increased mortality of T. officinale seedlings in axenic culture to a similar degree as bacteria evaluated in these experiments. Previous research investigating deleterious rhizobacteria of plants evaluated bacterial strains further if they reduced root length of the target and non-target species by more than 30% and 10%, respectively, in Petri dish culture (Kennedy 1991, Kremer and Kennedy 1996, Kennedy et al. 2016). We did not measure root length in our experiments, but forb:crabgrass mortality ratios are between 2:1 and 5:1.

These data demonstrate that Pantoea spp. isolated from D. ischaemum seed have the capacity to antagonize seedlings of competitor forbs in axenic culture. Pantoea isolates consistently caused necrosis indicative of membrane leakage in T. repens and T. officinale cotyledons beginning about 7 days after inoculation and progressing until complete death was observed 14 to 21 days after inoculation. In our analysis, RiLB4 was included as a standard control and did not increase mortality of T. repens and T. officinale while several Pantoea spp. isolates from D. ischaemum caused 50 to 80% mortality of T. repens and T. officinale seedlings. The effect of these isolates on D. ischaemum seedlings was inconsistent, but results indicate that they may increase seedling mortality. However, in some experiments, mortality was reduced when isolates 4 and 5 were combined. It is possible that the method of D. ischaemum seed surface sterilization that required seed coat removal and sterilization of a naked seed increased the susceptibility of D. ischaemum to these bacteria and reduced the selectivity of these bacteria. The combination of isolates 4 and 5 demonstrated the greatest amount of selectivity.

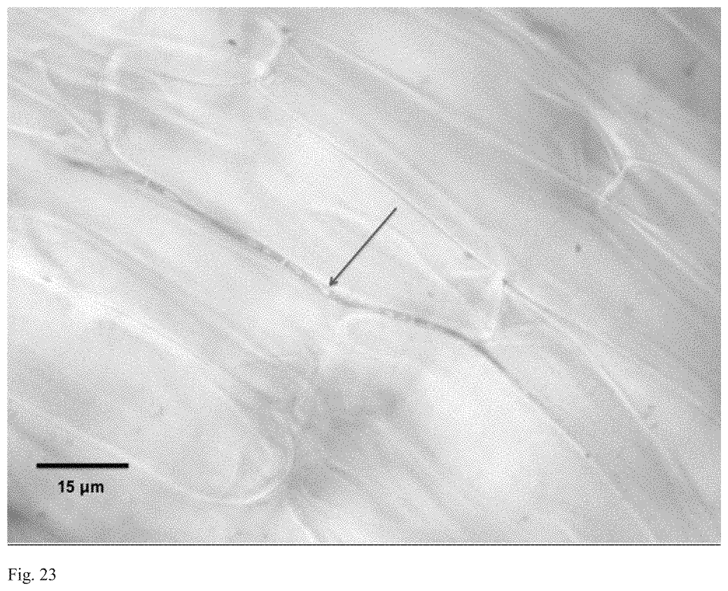

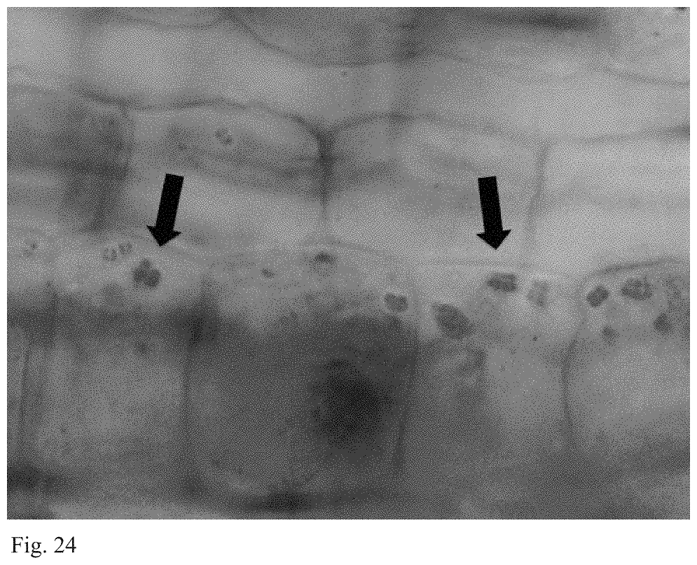

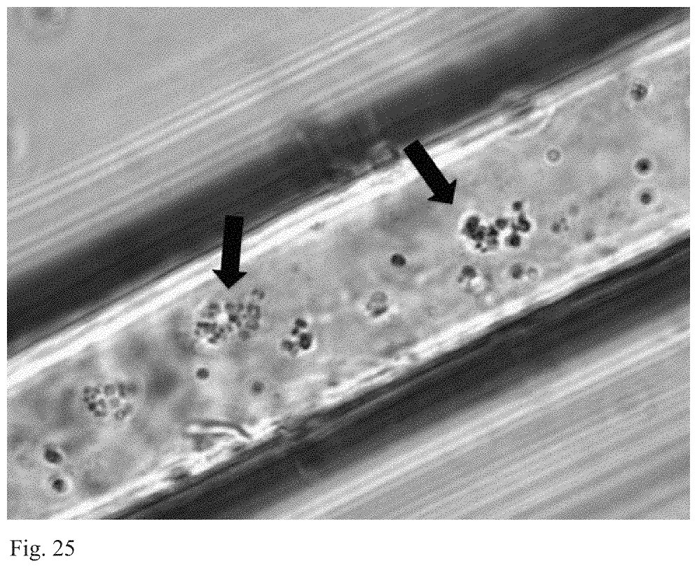

In our experiments Curvularia functioned primarily as a pathogen of T. repens and D. ischaemum, although with a different combination of bacterial cohorts it may function as a symbiont (Podolich et al. 2015). Curvularia was much less pathogenic to P. annua and increased the positive gravitropic response of P. annua roots. To potentially avert the pathogenic effect against D. ischaemum, more mature seedlings could be tested, perhaps allowing plants to develop at least one true leaf before inoculating with this Curvularia sp. isolate to evaluate stress responses similar to Redman et al. (2002) and Mirquez et al. (2007). Seeds inoculated with Curvularia sp. in these experiments developed segmented hyphae as the bacteria appear to colonize intercellular spaces of inoculated P. annua and D. ischaemum root cortex tissue which suggests it has endophytic capabilities (FIG. 23).

These experiments demonstrate that Digitaria ischaemum seeds contain bacteria that antagonize competitor species in Petri dish experiments. The Pantoea spp. isolates evaluated in these experiments may provide D. ischaemum a competitive advantage against competitor species.

### Example IV

### Application of Combinations of Heterologous Endophytic Bacteria to Improve Agronomic Traits

As described in the previous example, the endophytic bacteria listed in Table 1 can be used alone or in combination with other bacteria or agents to control, or suppress growth of competitor plant species, thereby conferring growth advantages to plants of interest. These advantages include one or more of an increase in root growth promotion, shoot growth promotion, resistance to salt stress, via increased competition with undesirable plant species in a plant produced from the seed, as compared to a reference plant which is not treated with the inventive bacterial combination. The bacteria can act synergistically in combination or their effects may be additive in achieving the advantages set forth above. Such combinations can include 1, 2, 3, 4, 5, 6, 7, or all of the strains listed in Table 1 or Table 4. However, in certain embodiments the combinations lack Curtobacterium (strain Froelichia #4) as this strain has been found to promote the growth of invasive weed species. In cases where Curtobacterium (strain Froelichia #4 provides a growth advantage to the target plant of interest, it may be included in the formulations of the invention. Combinations can include one or more strains in Table 1 and other strains known to confer beneficial growth properties to plants. The strains may be present in differing amounts or ratios, e.g., 1:1, 1:2, 1:3, 1:4, 1:2:1, 1:5:1, etc. Exemplary combinations include, without limitation:

Combination 1: the yeast Aureobasidium pullulans (Froelichia #2) and bacterium Micrococcus luteus (Lycopersicum #1) where strains complement one another, and the mixture shows maximum seedling mortality;
combination 2: the yeast Rhodotorula sp. (strain Abrus #1), Sphingomonas sp. (strain Abrus #3) and Micrococcus luteus (Lycopersicum #1) which were each effective to inhibit root growth; and
combination 3: all of the members of combinations 1 and 2.

To maximize inhibition of undesirable weeds, the following strains can be employed:

Combination 4: Strain #5 (Pantoea sp. from crabgrass which inhibits dandelion)+strain PP4F (Pseudomonas sp. from Poa pratenses) (that inhibits clover)+strain Froelichia #2 (Aureobasidium pullulans) (that inhibits curly dock).

To maximize use on grass hosts (like turf grasses) and inhibit competitor weeds use:

Combination 5: Strain #4 (Pantoea sp. from crabgrass which inhibits dandelion)+strain PA-NA-2B1 (Paenibacillus sp. from Poa annua) (inhibiting dandelion)+strain PP4-F (Pseudomonas sp. from Poa pratensis for inhibiting clover)
Combination 6: Strain PP4F (Pseudomonas sp. from Poa pratenses) (that inhibits clover)+Strain PA-NA-2B1 (Paenibacillus sp. from Poa annua) (inhibiting dandelion)+Strain Froelichia #2 (Aureobasidium pullulans) (that inhibits curly dock)

The combined microbes may be formulated to facilitate administration to target plants of interest, using methods described herein above. They may be lyophilized, and optionally formulated into synthetic alginate beads for distribution into soil. Alternatively, they can be formulated as an aerosol for spraying on areas to be treated. Such methods are known to those of skill in the art of plant and crop propagation.

The formulations described above can also be added to certain fertilizer compositions, such as the controlled release fertilizer composition described in U.S. Pat. No. 9,266,787. Such fertilizer compositions can optionally comprise one or more reagents selected from urea, ammonia, ammonium nitrate, ammonium sulfate, calcium nitrate, diammonium phosphate, monoammonium phosphate, potassium nitrate and sodium nitrate. monopotassium phosphate, dipotassium phosphate, tetrapotassium pyrophosphate, and potassium metaphosphate and optionally a macronutrient selected from the group consisting of sulfur, calcium and magnesium and/or micronutrients including boron, copper, iron, manganese, molybdenum and zinc provided that such reagent does not interfere with the growth promoting action of the endophytic bacteria described herein.

These aforementioned formulations and compositions can further comprise a dispersing agent, such as those disclosed in U.S. Pat. No. 8,241,387.

### REFERENCES

Atsatt P R, Whiteside M D (2014) Novel Symbiotic Protoplasts Formed by Endophytic Fungi Explain Their Hidden Existence, Lifestyle Switching, and Diversity within the Plant Kingdom. PLoS ONE 9(4): e95266. https://doi.org/10.1371/journal.pone.0095266
Bacon C, White J F. (2015) Functions, mechanisms and regulation of endophytic and epiphytic microbial communities of plants. Symbiosis DOI: 10.13140/RG.2.1.1956.9124.
Badri D V, Vivanco J M. (2009) Regulation and function of root exudates. Plant, Cell and Environment 32: 666-681.
Beltrán-García, MJ, White J F, Prado F M, Prieto K R, Yamaguchi L F, Torres M S, Kato M J, Medeiros M H G, Di Mascio P. (2014) Nitrogen acquisition in Agave tequilana from degradation of endophytic bacteria. Scientific reports 4, 6938
Beran V, Havelkova M, Kaustova J, Dvorska L, Pavlik I (2006) Cell wall deficient forms of mycobacteria: a review. Veterinami Medicina 51: 365-389.
Buer C S, Sukumar P, Muday G K. (2006) Ethylene modulates flavonoid accumulation and gravitropic responses in roots of Arabidopsis. Plant Physiology 140: 1384-1396. http://doi.org/10.1104/pp. 105.075671.
Bowsher A W, Ali R, Harding S A, Tsai C-J, Donovan L A. (2016). Evolutionary Divergences in Root Exudate Composition among Ecologically-Contrasting Helianthus Species. PLoS ONE, 11(1), e0148280. http://doi.org/10.1371/journal.pone.0148280
Broeckling C D, Broz A K, Bergelson J, Manter D K, Vivanco J. M. (2008) Root exudates regulate soil fungal community composition and diversity. Appl. Environ. Microbiol. 74: 738-744.
Cabiscol E, Tamarit J, Ros J. (2000) Oxidative stress in bacteria and protein damage by reactive oxygen species. Internat. Microbiol. 3: 3-8.
Clarkson D, Marschner H. (1995) Mineral Nutrition of Higher Plants. Second edition, London, Academic Press, 889 pp.
Clay K. (1988) Fungal endophytes of grasses: A defensive mutualism between plants and fungi. Ecol. 69: 10-16.
Clay K, Holah J, Rudgers J A. (2005) Herbivores cause a rapid increase in hereditary symbiosis and alter plant community composition. PNAS 102: 12465-12470.
Compant S, Clement C, Sessitsch A. (2010) Plant growth-promoting bacteria in the rhizo- and endosphere of plants: Their role, colonization, mechanisms involved and prospects for utilization. Soil Biol Biochem 42: 669-678.
Cox N A, McHan F, Bailey J B, Shotts E B. (1994) Effect of butyric or lactic acid on the In vivo colonization of Salmonella typhimurium. J. Appl. Poult. Res. 3: 315-318.
Cook D, Gardner D R, Pfister J A. (2014) Swainsonine-containing plants and their relationship to endophytic fungi J. Ag. and Food Chemistry 62: 7326-7334. DOI: 10.1021/jf501674r.
Cook D, Donzelli B G G, Creamer R, Baucom D L, Gardner D R, Pan J, Schardl C L. (2017). Swainsonine biosynthesis genes in diverse symbiotic and pathogenic fungi. G3: Genes|Genomes|Genetics 7: 1791-1797. http://doi.org/10.1534/g3.117.041384.
Doty S L (2017) Functional importance of the plant microbiome: Implications for agriculture, forestry and bioenergy. Pages 1-5 in: Doty S L (Ed.), Functional Importance of the Plant Microbiome. Springer, Amsterdam, Netherlands.
Environmental Justice Foundation (2007). The Deadly Chemicals in Cotton, Environmental Justice Foundation in collaboration with Pesticide Action Network UK, London, UK. ISBN No. 1-904523-10-2.
Errington J, Mickiewicz K, Kawai Y, Wu L J. (2016) L-form bacteria, chronic diseases and the origins of life. Phil. Trans. R. Soc. B 2016 371 20150494; DOI: 10.1098/rstb.2015.0494. Funk-Jensen D, Hockenhull J. (1984) Root exudation, rhizosphere microorganisms and disease control. Växtskyddsnotiser 48: 49-54.
Gond S K, Bergen M, Torres M S, White J F. (2015) Effect of bacterial endophyte on expression of defense genes in Indian popcorn against Fusarium moniliforme. Symbiosis 66: 133-140. DOI: 10.1007/s13199-015-0348-9.
Hamilton C E, Gundel P E, Helander M, Saikkonen K. (2012) Endophytic mediation of reactive oxygen species and antioxidant activity in plants: a review. Fungal Diversity 54: 1-10.
Hardoim P R, van Overbeek L S, Berg G, Pirttilä A M, Compant S, Campisano A, Döring M, Sessitsch A. (2015) The hidden world within plants: ecological and evolutionary considerations for defining functioning of microbial endophytes. Microbiol. Mol. Biol. Rev. 79: 293-320. doi:10.1128/MMBR.00050-14.
Hill P W, Quilliam R S, DeLuca T H, Farrar J, Farroll M. et al. (2011) Acquisition and assimilation of nitrogen as peptide-bound and D-enantiomers of amino acids by wheat. PLoS ONE 6(4): e19220. doi:10.1371/journal.pone.0019220.
Holland M A. 1997. Methylobacterium and plants. Recent Res Dev in Plant Physiol 1: 207-213.
Hurek T, Handley L L, Reinhold-Hurek B, Piché Y. (2002) Azoarcus grass endophytes contribute fixed nitrogen to the plant in an unculturable state. Molecular Plant-Microbe Interactions 15: 233-242.
Irizarry I, White J F. (2017) Application of bacteria from non-cultivated plants to promote growth, alter root architecture and alleviate salt stress of cotton. J. Appl. Microbiol. 122: 1110-1120; doi: 10.1111/jam.13414.
Irizarry I, White J F. (2018). Bacillus amyloliquefaciens alters gene expression, ROS production, and lignin synthesis in cotton seedling roots. J. Applied Microbiology 124: 1589-1603.
Johnstone T C, Nolan E M (2015) Beyond iron: Non-classical biological functions of bacterial siderophores. Daltan Trans. 44: 6320-6339. http://dxdoi.org/10.1039/c4dt03559c.
Johnston-Monje D, Raizada M N. (2011) Conservation and diversity of seed associated endophytes in Zea across boundaries of evolution, ethnography and ecology. PLoS ONE 6(6): e20396. doi:10.1371/journal.pone.0020396.
Kandel S L, Joubert P M, Doty L S. (2017) Bacterial endophyte colonization and distribution within plants. Microorganisms 5: 77; doi:10.3390/microorganisms5040077.
Kaul S, Gupta S, Sharma S, Dhar M K. (2017) The fungal endobiome of medicinal plants: A prospective source of bioactive metabolites. In: Agrawal D, Tsay H S, Shyur L F, Wu Y C, Wang S Y. (eds) Medicinal Plants and Fungi: Recent Advances in Research and Development, Medicinal and Aromatic Plants of the World, vol 4, Springer, Singapore.
Kowalski K P, Bacon C, Bickford W, Braun H, Clay K, Leduc-Lapierre M, Lillard E, McCormick M, Nelson E, Torres M, White J F, Wilcox D A. (2015) Advancing the science of microbial symbiosis to support invasive species management: A case study on Phragmites in the Great
Lakes, Frontiers in Microbiology January 2015; 6:95. DOI: 10.3389/fmicb.2015.00095
Kocha T, Yamaguchi M, Ohtaki H, Fukuda T, Aoyagi T. (1997) Hydrogen peroxide-mediated degradation of protein: different oxidation modes of copper- and iron-dependent hydroxyl radicals on the degradation of albumin. Biochimica et Biophysica Acta 1337: 319-326.
Koga R, Nikoh N, Matsuura Y, Meng X-Y, Fukatsu T. (2013) Mealybugs with distinct endosymbiotic systems living on the same host plant. FEMS Microbiol Ecol 83: 93-100.
Kuldau G, Bacon C W. (2008) Clavicipitaceous endophytes: Their ability to enhance grass resistance to multiple stresses. Biological Control 46: 57-71.
Lamb C, Dixon R A. (1997) The oxidative burst in plant disease resistance. Annu. Rev. Plant Physiol. Mol. Biol. 48: 251-275.
Lanzagorta J M A, de la Torre C, Aller P. (1988) The effect of butyrate on cell cycle progression in Allium cepa root meristems. Physiologia Plantarum 72: 775-781.
Machova E, Bystricky S. (2013) Antioxidant capacities of mannans and glucans are related to their susceptibility to free radical degradation. Int. J. Biol. Macromol. 61: 308-311.
Mohanna D C, Thippeswamy S, Abhishek R U. (2013) Antioxidant, antibacterial, and ultraviolet protective properties of carotenoids isolated from Micrococcus spp. Radiat. Prot. Environ. 36: 168-174.
Paungfoo-Lonhienne C, Rentsch D, Robatzrk S, Webb R I, Sagulenko E, Nasholm T, Schmidt S, Lonhienne T G A. (2010) Turning the table: plants consume microbes as a source of nutrients. PLOS ONE 5(7): e11915. doi: 10:1371/journal.pone.0011915.
Paungfoo-Lonhienne, C., Schmidt, S., Webb, R. and Lonhienne, T. (2013) Rhizophagy—A new dimension of plant-microbe interactions, in de Briujn, F. J. (Ed.) Molecular Microbial Ecology of the Rhizosphere. Wiley-Blackwell. Pub John Wiley & Sons, Inc.
Prieto K R, Echaide-Aquino F, Huerta-Robles A, Valerio H P, Macedo-Raygoza G, Prado F M, Medeiros M, Brito H F, da Silva I, Felinto M C F, White J F, Di Masci, P, Beltran-Garcia M. (2017) Endophytic bacteria and rare earth elements; Promising candidates for nutrient use efficiency in plants. Pp. 285-302, in Hossain M, Kamiya T, Burritt D, Tram L-SP, Fujiwara T. (Eds). Plant Macronutrient Use Efficiency. Academic Press, Cambridge, Mass., USA.
Puente M E, Lib C Y, Bashan Y. (2009) Endophytic bacteria in cacti seeds can improve the development of cactus seedlings. Environ. Exp. Bot. 66: 402-408.
Redman R S, Sheehan K B, Stout R G, Rodriguez R J, Henson J M. (2002) Thermotolerance generated by plant/fungal symbiosis. Science 298: 1581.
Reinhold-Hurek B, Hurek T. (2011) Living inside plants: bacterial endophytes. Current Opinion in Plant Biology 14: 435-443.
Rodriguez C E, Mitter B, Barret M, Sessitsch A, Compant S. (2017) Commentary: Seed bacterial inhabitants and their routes of colonization. Plant & Soil 422: 129-134. https://doi.org/10.1007/s11104-017-3368-9.
Rodriguez R J, Woodward C, Kim Y O, Redman R S. (2009) Habitat-adapted symbiosis as a defense against abiotic and biotic stresses. In: White J F Jr, Torres M S (eds) Defensive Mutualism in Microbial Symbiosis, CRC Press, Boca Raton, Fla., USA. pp. 335-346.
Rudrappa T, Czymmek K J, Paré P W, Bais H P. (2008) Root-secreted malic acid recruits beneficial soil bacteria. Plant Physiol. 148:1547-1556.
Schardi C L, Young C A, Pan J, Florea S, Takach J, Panaccione D G, Farman M L, Webb J S, Jaromczyk J, Charlton N D, Nagabhyru P, Chen L, Shi C, Leuchtmann A. (2013) Currencies of mutualisms: Sources of alkaloid genes in vertically transmitted epichloae. Toxins 5: 1064-1088.
Soares M A, Li H, Bergen M, White J F. (2015) Functional role of an endophytic Bacillus amyloliquefaciens in enhancing growth and disease protection of invasive English ivy (Hedera helix L.). Plant and Soil 405: 107-123. DOI: 10.1007/s11104-015-2638-7
Soares M A, Li H-Y, Kowalski K P, Bergen M, Torres M S, White J F. (2016) Functional roles of bacteria from invasive Phragmites australis in promotion of host growth. Microb Ecol 72: 407-17.
Steiner U, Leibner S, Schardl C L, Leuchtmann A, Leistner E. (2011) Periglandula, a new fungal genus within the Clavicipitaceae and its association with Convolvulaceae. Mycologia 103: 1133-1145.
Stone J K, Bacon C W, White J F. (2000) An overview of endophytic microbes: endophytism defined. In: Bacon C W, White J F (eds) Microbial Endophytes, Marcel-Dekker, New York, USA, pp. 3-30.
Sun Y, O'Riordan M. (2013) Regulation of bacterial pathogenesis by intestinal short-chain fatty acids. Pp. 93-113 in Advances in Applied Microbiology. Elsevier, NY.
Tramontano W A, Scanlon C. (1996) Cell cycle inhibition by butyrate in legume root meristems. Phytochemistry 41: 85-88.
Thomas P, Soly T A. (2009) Endophytic bacteria associated with growing shoot tips of banana (Musa sp.) cv. Grand Naine and the affinity of endophytes to the host. Microbial Ecology 58: 953-964.
Thomas P, Reddy K M. (2013) Microscopic elucidation of abundant endophytic bacteria colonizing the cell wall-plasma membrane peri-space in the shoot-tip tissue of banana. AOB Plants 5: plt011, https://doi.org/10.1093/aobpla/plt011.
Torres M S, White J F, Zhang X, Hinton D M, Bacon C W. (2012) Endophyte-mediated adjustments in host morphology and physiology and effects on host fitness traits in grasses. Fungal Ecology 5: 322-330.
Verma S K, Kingsley K, Irizarry I, Bergen M, Kharwar R N, White J F. (2017a) Seed vectored endophytic bacteria modulate development of rice seedlings. J. Applied Microbiology 122: 1680-1691.
Verma S K, Kingsley K, Bergen M, English C, Elmore M, Kharwar R N, White J F. (2017b) Bacterial endophytes from rice cut grass (Leersia oryzoides L.) increase growth, promote root gravitropic response, stimulate root hair formation, and protect rice seedlings from disease. Plant and Soil 422: 223-238. DOI: 10.1007/s11104-017-3339-1.
Verma S K, White J F. (2018) Indigenous endophytic seed bacteria promote seedling development and defend against fungal disease in browntop millet (Urochloa ramosa L.). Journal of Applied Microbiology 124: 764-778. DOI: 10.1111/jam.13673.
Verma S K, Kingsley K L, Bergen M S, Kowalski K P, White J F. (2018) Fungal disease protection in rice (Oryza sativa) seedlings by growth promoting seed-associated endophytic bacteria from invasive Phragmites australis. MDPI: Microorganisms. doi: 10.3390/microorganisms6010021.
Waller F, Achatz B, Baltruschat H, Fodor J, Becker K, Fisher M, Heier T, Huckelhoven R, Neumann C, Wettstein D, Franken P, Kogel K H. (2005) The endophytic fungus Piriformospora indica reprograms barley to salt-stress tolerance, disease resistance, and higher yield. PNAS 102: 13386-13391.
White J F, Cole G T. (1986). Endophyte-host associations in forage grasses. IV. The endophyte of Festuca versuta. Mycologia 78:102-107.
White J F, Chen Q, Torres M S, Mattera R, Irizarry I, Tadych M, Bergen M. (2015) Collaboration between grass seedlings and rhizobacteria to scavenge organic nitrogen in soils. AoB PLANTS 7: plu093. doi:10.1093/aobpla/plu093.
White J F, Crawford H, Torres M S, Mattera R, Irizarry I, Bergen M. (2012). A proposed mechanism for nitrogen acquisition by grass seedlings through oxidation of symbiotic bacteria. Symbiosis 57: 161-171. http://doi.org/10.1007/s13199-012-0189-8.
White J F, Kingsley K, Harper C J, Verma S K, Brindisi L, Chen Q, Chang X, Micci A, Bergen M. (2018) Reactive oxygen defense against cellular endoparasites and the origin of eukaryotes, in: Krings M, Harper C J, Cuneo N R, Rothwell G W (eds.). Transformative Paleobotany: Papers to Commemorate the Life and Legacy of Thomas N. Taylor. Elsevier, Amsterdam, Netherlands.
White J F, Kingsley K L, Kowalski K P, Irizarry I, Micci A, Soares M A, Bergen M S. (2017). Disease protection and allelopathic interactions of seed-transmitted endophytic pseudomonads of invasive seed grass (Phragmites australis). Plant and Soil. 422: 195-208. doi:10.1007/s11104-016-3169-6.
White J F, Torres M S. (2010) Is endophyte-mediated defensive mutualism oxidative stress protection? Physiologia Plantarum 138: 440-446.
White J F, Torres M S, Somu M P, Johnson H, Irizarry I, Chen Q, Zhang N, Walsh E, Tadych M, Bergen M. (2014). Hydrogen peroxide staining to visualize intracellular bacterial infections of seedling root cells. Microscopy Research and Technique 77: 566-573. DOI: 10.1002/jemt.22375.
White J F, Torres M S, Verma S K, Elmore M T, Kowalski K P, Kingsley K L. (In press). Evidence for widespread microbivory of endophytic bacteria in roots of vascular plants through oxidative degradation in root cell periplasmic spaces. In: PGPR Amelioration in Sustainable Agriculture: Food Security and Environmental Management (Eds. Kumar A, Singh A, Singh V), Elsevier.

### Example V

### Bioherbicide Comprising Endophytic Bacteria

### Role of Amino Acid Arginine in the Bioherbicide

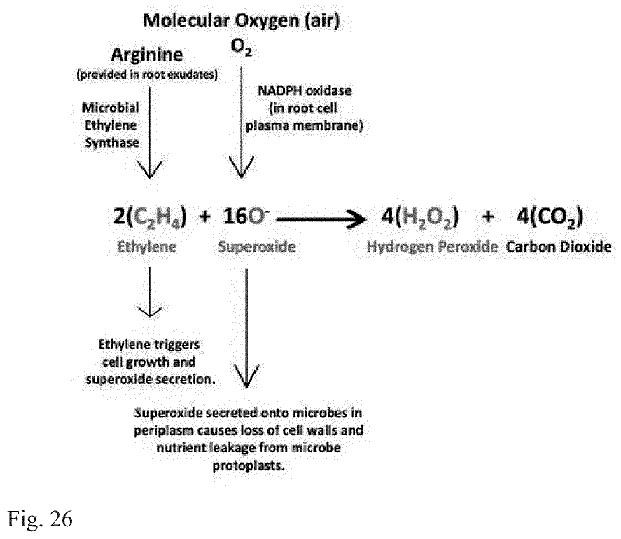

Use of arginine is based on the chemical interactions between microbes and plant cells (FIG. 26; Chang, Kingsley and White, 2021). In this interaction, endophytic microbes (bacteria and fungi) within root cells produce ethylene from arginine provided by plants using microbial ethylene synthase. This microbial ethylene causes root cells to produce superoxide using NADPH oxidases (Nicotinamide Adenine Dinucleotide Phosphate) on root cell plasma membranes adjacent to intracellular microbes. This process is generally under plant control because the plant provides the arginine to microbes and thus regulates ethylene production. Application of excess exogenous arginine permits microbes to overproduce ethylene; this results in excess plant-produced superoxide causing oxidative cellular damage, loss of chlorophyll, overgrowth of microbes within plant cells, and leads to plant death.

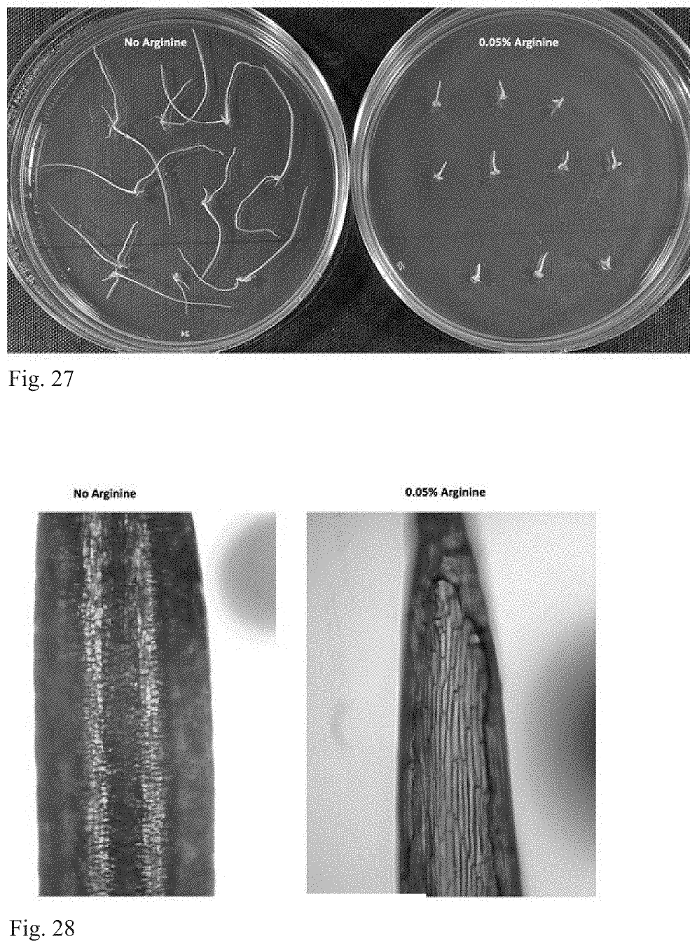

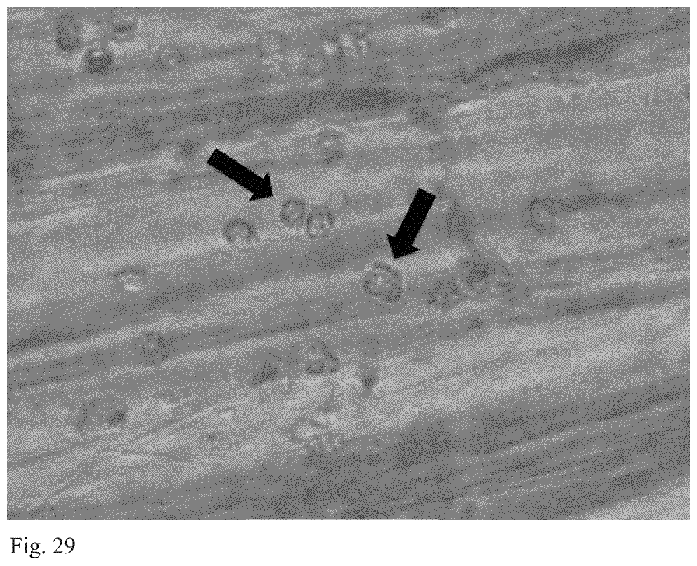

In laboratory experiments, we germinated seeds of the grass Poa reptans on agarose with and without 0.05% arginine. After 7 days of growth, seedlings on the arginine-containing agarose showed repression of shoots and roots (FIG. 27). Shoot cells lack evidence of chlorophylls (FIG. 28), and this is more evidence of oxidative stress in plants; superoxide and other reactive oxygen forms damage chlorophylls and they are degraded (White and Torres, 2010).

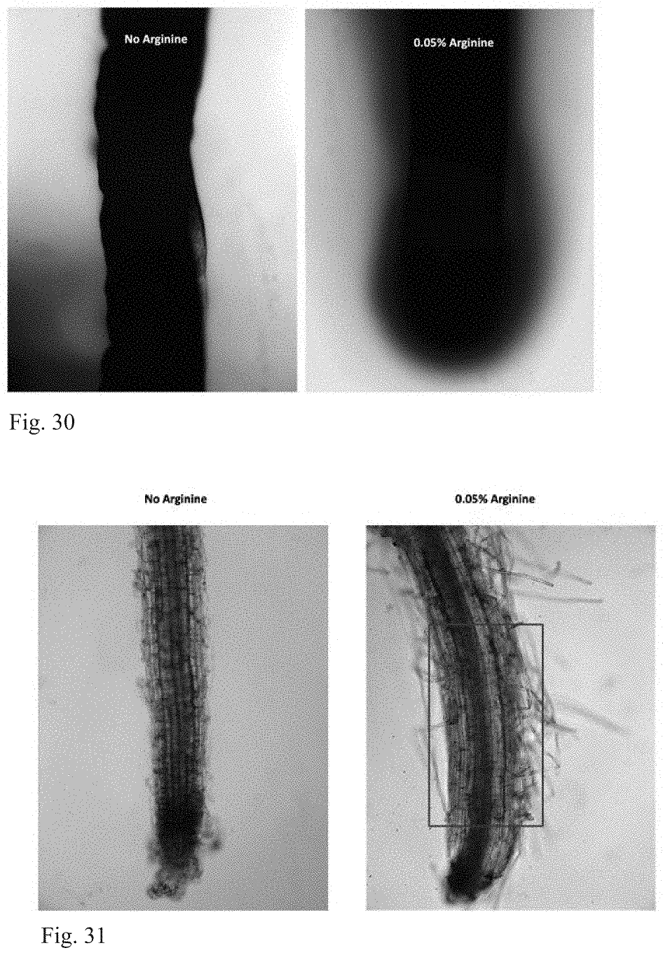

A microscopic examination of cells in leaves of seedlings treated with 0.05% arginine showed that all chloroplasts were colonized by actively motile bacteria giving them an irregular outline (FIG. 29). Seedling roots stained with diaminobenzidine tetrahydrochloride (for protocol see White et al, 2014 and White et al., 2018a) to stain for hydrogen peroxide revealed high levels of hydrogen peroxide around roots treated with arginine (FIG. 30). This is further evidence that exposure of plants to arginine results in excess production of reactive oxygen species (ROS).

Roots treated with arginine showed higher presence of superoxide as evidenced by nitro blue tetrazolium staining (FIG. 31). Production of longer root hairs in the arginine-treated seedlings is more evidence that the arginine enabled bacteria within cells to produce ethylene that served to stimulate growth in the hairs.

### Role of Citrus Oil in the Bioherbicide

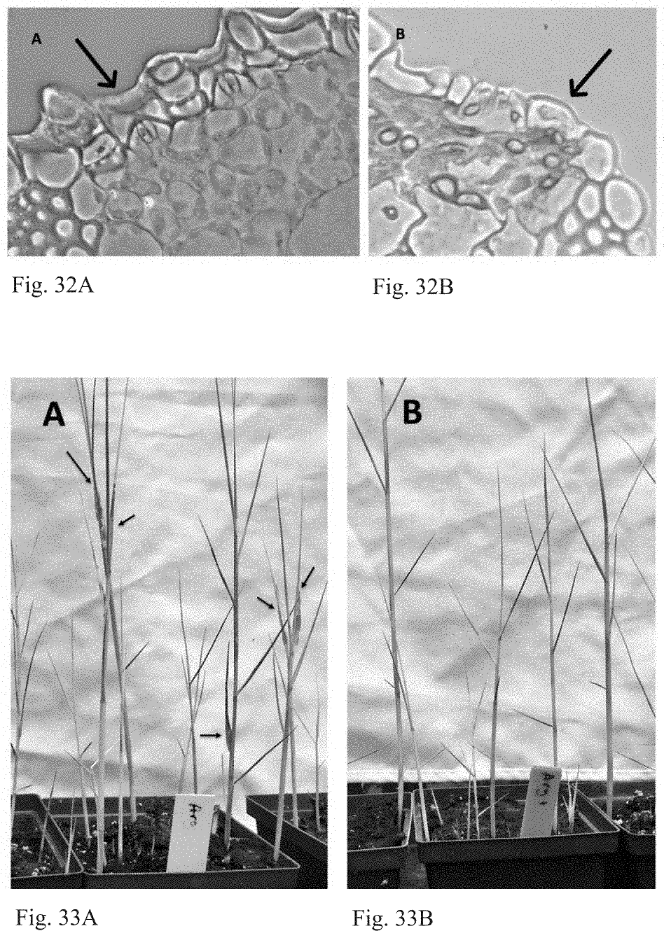

The inclusion of citrus oil extracted from orange or lemon leaves, or a comparable oil, in the bioherbicidal mixture is beneficial The citrus oil solubilizes the waxy cuticle that covers leaves. The cuticle is impregnated with cuticular waxes and covered with epicuticular waxes, composed of mixtures of hydrophobic aliphatic compounds, hydrocarbons with chain lengths typically in the range C16 to C36 (Baker, 1982). Removal of these waxes permits entry of the other components of the bioherbicide into tissues of treated plants. Without simultaneous treatment with oil, the other components of the bioherbicide wash off the surface of treated plants with minimal effects on leaves and stems; although, treatment of roots through drenching results in killing of roots even when citrus oil is not included in the mixture. Removal of the cuticular layer from leaves and stems enables other components to more easily enter tissues and increase stress in plants. In one experiment, we treated Phragmites australis leaves with citrus oil or water alone. This experiment demonstrated that leaves treated only with water had an intact waxy cuticle, while the citrus oil resulted in removal of the cuticle from plants (FIG. 32). In experiments using Phragmites australis plants, when arginine, and organic salts were not included in the mixture with citrus oil and sugar, plants showed only spotty or partial removal of cuticular waxes, with minimal death and rapid recovery from the treatments where necrosis severity ratings around 3 (moderate) were generally seen (Table 8).

TABLE 8
Ratings (1-5; with 5 = most severe) on plant necrosis and death assessed periodically after
treatment with bioherbicide (containing 5% arginine, 15% sugars, 3% citric oil, and 6% organic salts).

| | Jul. 29, | Jul. 30, | Jul. 31, | Aug. 3, | Aug. 11, | Aug. 12, | Aug. 13, | Aug. 14, | Aug. 18, | Aug. 24, | Sep. 1, |
|---|---|---|---|---|---|---|---|---|---|---|---|
| Replicate | 2020 | 2020 | 2020 | 2020 | 2020 | 2020 | 2020 | 2020 | 2020 | 2020 | 2020 |
| 1 | 2 | 4 | 4 | 5 | 5 | 5 | 5 | 5 | 5 | 5 | 5 |
| 2 | 2 | 4 | 4 | 5 | 5 | 5 | 5 | 5 | 5 | 5 | 5 |
| 3 | 2 | 5 | 5 | 5 | 5 | 5 | 5 | 5 | 5 | 5 | 5 |
| 4 | 3 | 3 | 4 | 4 | 5 | 5 | 5 | 5 | 5 | 5 | 5 |
| 5 | 3 | 4 | 5 | 5 | 5 | 5 | 5 | 5 | 5 | 5 | 5 |
| 6 | 3 | 4 | 5 | 5 | 5 | 5 | 5 | 5 | 5 | 5 | 5 |

Where plants were treated with the arginine-based bioherbicide that contained all components except microbes, all plants were dead by the end of the study with necrosis severity ratings of 5 for all treated plants (Table 9). The controls treated only with water showed no death or tissue damage (with ratings of 1) It is evident that citrus oil alone was not adequate to kill plants. Its function is exclusively to alter the plant surface and permit entry of the other components of the bioherbicide mixture, and it is not itself an effective bioherbicide.

TABLE 9
Ratings (1-5; with 5 = most severe) on plant necrosis and death assessed periodically
after treatment with bioherbicide (containing 15% sugars and 3% citric oil).

| | Jul. 29, | Jul. 30, | Jul. 31, | Aug. 3, | Aug. 11, | Aug. 12, | Aug. 13, | Aug. 14, | Aug. 18, | Aug. 24, | Sep. 1, |
|---|---|---|---|---|---|---|---|---|---|---|---|
| Replicate | 2020 | 2020 | 2020 | 2020 | 2020 | 2020 | 2020 | 2020 | 2020 | 2020 | 2020 |
| 1 | 2 | 2 | 2 | 3 | 3 | 3 | 3 | 3 | 3 | 3 | 3 |
| 2 | 2 | 2 | 2 | 3 | 3 | 3 | 3 | 3 | 3 | 2 | 2 |
| 3 | 2 | 2 | 2 | 3 | 3 | 3 | 3 | 3 | 3 | 2 | 2 |
| 4 | 2 | 2 | 3 | 3 | 2 | 2 | 2 | 2 | 2 | 2 | 2 |
| 5 | 2 | 2 | 3 | 3 | 5 | 5 | 5 | 4 | 4 | 4 | 4 |
| 6 | 3 | 3 | 3 | 3 | 4 | 4 | 4 | 4 | 4 | 4 | 4 |

### Role of Sugar in the Bioherbicide

Sugars are included in the bioherbicidal mixture in order to provide the fuel needed by the endosymbiotic, or exogenously applied, microbes to rapidly grow within and on the surfaces of tissues of the plant. In a preferred embodiment, sucrose is used in the mixture because it is the sugar that plants use within tissues of the plant due to its high solubility, and because many endosymbiotic microbes have the enzymes to utilize it (Chang, Kingsley and White, 2021). Other sugars, including fructose, glucose, mannose and lactose may be used. Other sugars or starches may also be effective as carbon sources for microbes in bioherbicidal mixtures. Crude sugars such as molasses or other plant extracts may be employed to fuel microbial growth in this arginine-based bioherbicidal mixture.

### Role of Organic Salts in the Bioherbicide

In laboratory experiments, we found that many organic acids and their salt forms inhibit plant tissue growth in annual bluegrass (Poa annua) and Phragmites australis (Table 10). In one set of experiments, a suite of short-chain organic acids (Table 10) was screened for effects on Poa annua root growth and with microbes present. In this pre-screen, organic acids at various concentrations (ranging from 0-1 mM, with 0.2 mM increments) were incorporated into 0.7% agarose medium. Seeds of Poa annua were first surface sterilized to remove all surface bacteria by disinfecting with constant agitation in 4% sodium hypochlorite solution for 40 minutes, washed thoroughly, then placed on the surface of agarose media in Petri plates and each seed was inoculated with one drop of a suspension of Pseudomonas strain SLB4 (at approximately 0.5 OD, 600 nm). After 7 days, plates were assessed for germination rate, percent of seedlings with roots that grew downward (positive gravitropism), root hair growth for agarose penetrating roots, root length and internal colonization of bacteria into root cells. In these experiments, we showed that seedling growth inhibition occurred when seedlings were exposed to acetic, benzoic, butyric, citric, hexanoic, oxalic and propionic acids (Table 10). The mechanism of activity of short-chain organic acids and salts has been shown to be inhibition of the cell cycle and metabolism in plants (Qiu et al., 2017; Lanzagorta, de la Torre and Aller, 1988; Tramontano and Scanlon, 1996); and effectively inhibits cell division in meristems and tissue recovery in plants treated with the arginine-based bioherbicide.

In other experiments, treatment of Phragmites australis plants with a 10 mM concentration of sodium butyrate applied to roots over a 6-week period resulted in suppression of root and shoot growth, reduced root branching, root browning, and increased bacterial and fungal growth on roots.

The addition of small amounts of organic acids to the arginine-based bioherbicide limits plant tissue recovery after the waxy cuticle has been removed. However, the use of short-chain organic acids or salts to suppress tissue recovery must be balanced with its capacity to also inhibit cell growth of bacteria and fungi. The use of these organic salts could be used sparingly in arginine-based bioherbicide mixes or they may be used in mixes with microbes that are not inhibited by the short-chain organic salts.

TABLE 10
Screen of short-chain organic acids for effects on
features associated with roots of Poa annua.

| | Inhibitory Activity On | | | | |
|---|---|---|---|---|---|
| | | | Hair | Bact. | Root |
| Acid | Germination | Gravitropism | Length | Entry | Length |
| Acetic | No | No | No | No | Yes |
| Propionic | No | Yes | Yes | Yes | Yes |
| Butyric | No | Yes | Yes | Yes | Yes |
| Benzoic | No | Yes | Yes | No | Yes |
| Hexanoic | No | Yes | Yes | No | Yes |
| Citric | No | Yes | Yes | No | Yes |
| Oxalic | No | Yes | Yes | Yes | Yes |
| Quinic | No | No | No | No | No |

### Role of Exogenous Microbes in the Arginine-Based Bioherbicide

Native endosymbiotic microbes in plants may be triggered to grow when plants are treated with the arginine-based bioherbicidal mixtures. However, addition of inhibitory microbes to the arginine-based bioherbicidal mixture increases the speed by which plant tissues die. In experiments in which Phragmites australis plants were treated with a single application of a bioherbicidal mix containing 15% citrus oil, 15% sucrose and 5% arginine or the same mix including bacterium Bacillus sp., after 3 days leaf death and desiccation of leaf blades was 68% effective in the treatment without the bacterium, whereas addition of the bacterium to the mix increased death and desiccation of leaf blades to 100% (FIG. 33).

The addition of inhibitory bacteria or fungi to the arginine-based bioherbicidal mix increases lethality of the bioherbicide because this increases the microbial load in plant tissues and results in more ethylene production in plant tissues. In previous experiments, we identified 36 microbes (bacteria and fungi) that are especially potent in terms of inhibition of plant growth. When these microbes enter into plant tissues, they replicate themselves at the expense of host plants because they are resistant to plant-produced ROS. The bacteria that may be used in the arginine-based bioherbicidal mixture may include those listed herein in certain embodiments, bacteria described in U.S. application Ser. No. 17/266,489 may be included.

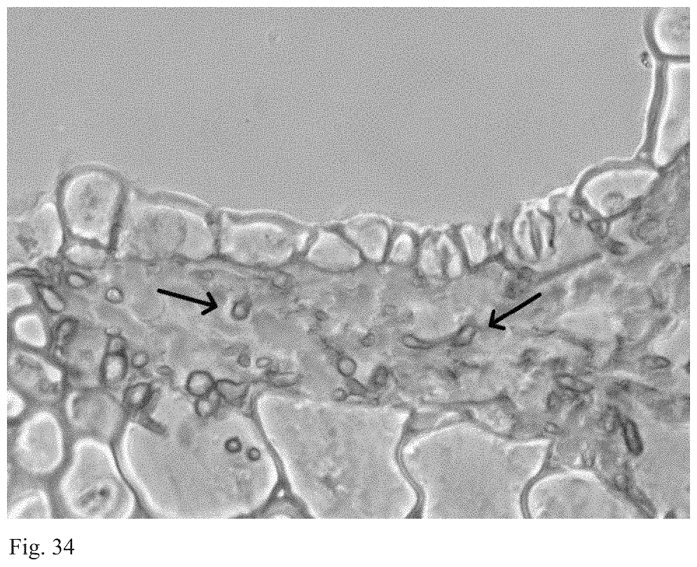

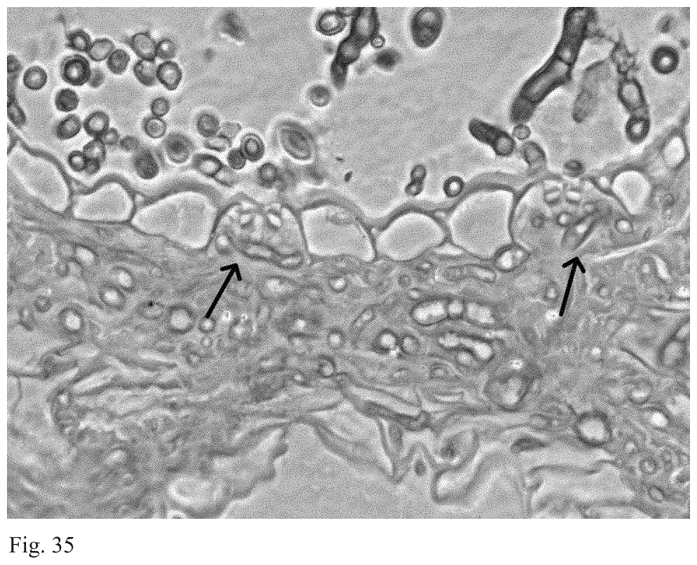

Microbial growth in tissues leads to increased ethylene production and stress, resulting in death of plants. However, as plant tissues die, microbes grow within plant tissues (FIGS. 34 and 35) and degrade plant tissues, releasing nutrients that may be used by plants that may grow after the weedy plants have been removed.

Several strains of the bacteria described herein can be identified by their distinct ribosomal 16S sequences. 16S ribosomal RNA (or 16S rRNA) is the component of the 30S small subunit of a prokaryotic ribosome that binds to the Shine-Dalgarno sequence. The genes coding for it are referred to as 16S rRNA gene (ITS regions) and are used in reconstructing phylogenies, due to the slow rates of evolution of this region of the gene.

TABLE 11
Strains of bacteria

| Bacterial Strain | SEQ ID NO: |
|---|---|
| Rhodotorula sp. | 1 |
| Sphingomonas sp. | 2 |
| Rhodococcus sp. | 3 |
| Curtobacterium sp. | 4 |
| Paenibacillus sp. | 5 |
| Pantoea sp. | 6 |
| Pantoea sp. | 7 |
| Aureobasidium pullulans | 8 |
| OVLBP2R Methylobacter sp. | 9 |
| Bacillus sp. | 11 |
| Bacillus sp. | 12 |
| Bacillus sp. | 13 |
| OMYESP3B ID: Terribacillus sp. | 14 |
| OMPDAP5BK ID: Bacillus sp. | 15 |
| Pseudomonas sp. | 16 |
| Exiguobacterium sp. | 17 |
| Pseudomonas sp. | 18 |
| Pantoea sp. | 19 |
| Pantoea sp. | 20 |
| Pantoea sp. | 21 |
| Pantoea sp. | 22 |
| Staphylococcus sp. | 23 |
| Pantoea sp. | 24 |
| Paenibacillus sp. | 25 |
| Pantoea sp. | 26 |
| Pantoea sp. | 27 |
| Xanthomonas sp. | 28 |
| Staphylococcus sp. | 29 |
| Methylobacterium sp. | 30 |
| Panteoa sp. | 31 |
| Panteoa sp. | 32 |
| Pantoea sp. | 33 |
| Pantoea sp. | 34 |
| Pantoea sp. | 35 |
| Micrococcus luteus | 36 |

### Methods for Administration of Bioherbicide

The bioherbicides described herein may be administered to the plant through any means know by the skilled artisan. Particular formulations to be applied in spraying forms such as water dispersible concentrates or wettable powders may contain surfactant such as wetting and dispersing agents, e.g., the condensation product of formaldehyde with naphthalene sulphonate, an alkyl-aryl-sulphonate, a lignin sulphonate, a fatty alkyl sulphate an ethoxylated alkylphenol and an ethoxylated fatty alcohol. In certain embodiments the bioherbicide is applied to the plant or a part thereof, and/or to the growth medium in contact with the plant. In certain embodiments, the bioherbicide is sprayed on the plant or growth medium. In other embodiments, the soil may be pre-treated with the bioherbicide to prevent growth of new undesired plants.

The compositions disclosed herein can be applied in a number of ways. In a preferred method of application, the compositions disclosed herein are applied directly to the soil that has been selected for treatment. Application methods include drip irrigation, sprinkler irrigation, spraying, or dusting or applying as a cream or paste formulation, or applying as a vapor or as slow-release granules.

The compositions may be applied using methods including but not limited to spraying, wetting, dipping, misting, drenching, showering, fogging, soaking, dampening, drizzling, dousing, aerial crop dusting via airplane or helicopter and splashing.

The compositions may be in the form of dustable powders or granules comprising the citrus oil compositions in dry form and a solid diluent or carrier, for example, fillers such as kaolin, bentonite, kieselguhr, dolomite, calcium carbonate, talc, powdered magnesia, fuller's earth, gypsum, diatomaceous earth and china clay. Such granules can be pre-formed granules suitable for application to the soil without further treatment. These granules can be made either by impregnating pellets of filler with the citrus oil compositions or by pelleting a mixture of the citrus oil composition and powdered filler.

Emulsifiable concentrates or emulsions may also be prepared. Suspension concentrates of largely insoluble solids may be prepared by ball or bead milling with a dispersing agent with a suspending agent included to stop the solid settling.

Compositions to be used as sprays may be in the form of aerosols wherein the formulation is held in a container under pressure of a propellant, e.g., fluorotrichloromethane or dichlorodifluoromethane.

Alternatively, the compositions may be used in micro-encapsulated form. They may also be formulated in biodegradable polymeric formulations to obtain a slow, controlled release of the composition.

As used herein the terms “spray” or “spraying” include the technique of applying to an exterior surface an ejected liquid material.

As used herein, the terms “coat” or “coating” include application, typically of a liquid or flowable solid, to an exterior surface such as a seed.

In certain embodiments, the bioherbicide is applied via soil drenching. The phrase “soil drenching” refers to the process of adding the diluted bioherbicide directly to the base of a plant, thereby flooding the roots and allowing the bioherbicide to be taken up systemically. This provides deep, targeted treatment and can also be used to apply fertilizers to plants with specific nutrient needs. During a soil drench, the product is poured directly over a plant's roots near the stem or trunk. This method allows the applicator to prevent the chemical from contacting other plants. Soil drenching allows the bioherbicide to be quickly absorbed by the plant roots and allows for simultaneous treatment of the soil.

### Field Experiments to Test Efficacy of Bioherbicidal Mixtures

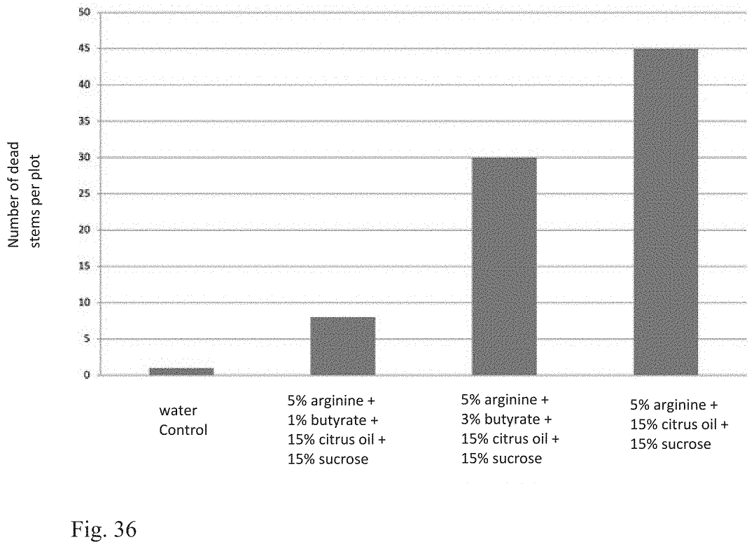

To test bioherbicidal mixtures, four naturally occurring 1-meter-square plots of actively growing Phragmites australis were identified. Plots were cut to 25 cm height, and rhizomatous growth into plots were severed using shovel penetration to a depth of 20 cm around the periphery of plots. Plants in plots were sprayed weekly to drench leaves and stems with water or herbicide mixes. Three herbicidal mixes were used as follows: 1) 5% arginine+1% butyrate+15% citrus oil+15% sucrose; 2) 5% arginine+3% butyrate+15% citrus oil+15% sucrose; 3) 5% arginine+15% citrus oil+15% sucrose. The numbers of dead culms (stems) and new culm growth from subterranean tillers were determined weekly. Table 12 and FIG. 36 show that the plots with bioherbicidal treatments contained the highest numbers of dead culms; with the bioherbicide mix that contained only 5% arginine+15% citrus oil+15% sucrose showing the highest number of dead tillers. In Table 12, plots were treated weekly with bioherbicidal mixtures and dead culms (stems) were assessed after 3 weeks.

TABLE 12
Phragmites australis killing effectiveness
after treatment with bioherbicidal mixtures.

| Plot | | Number of |
|---|---|---|
| Number | Treatment | Dead Culms |
| 1 | Water | 1 |
| 2 | 5% arginine + 1% butyrate + | 8 |
| | 15% citrus oil + 15% sucrose | |
| 3 | 5% arginine + 3% butyrate + | 30 |
| | 15% citrus oil + 15% sucrose | |
| 4 | 5% arginine + 15% citrus oil + | 45 |
| | 15% sucrose | |

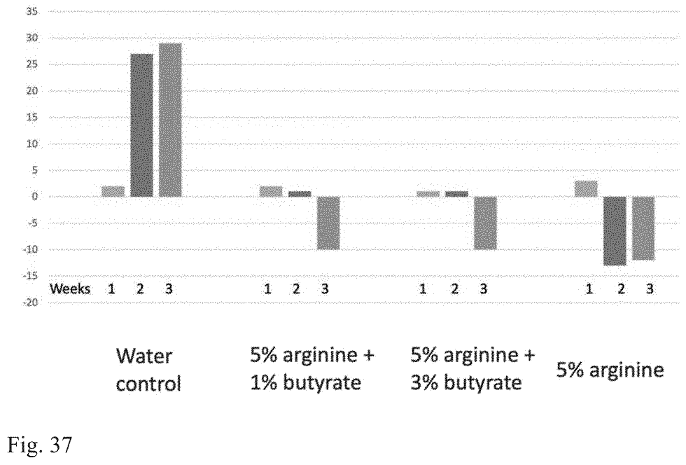

This indicates that the butyrate included in the first two bioherbicidal mixes may have been inhibiting some of the microbes within tissues and delaying the death of tissues. Similarly, this data (Table 13; FIG. 37) revealed that the bioherbicidal mixture that lacked the organic salts also showed the least new tillers and showed a faster decline in new tiller production. In Table 5, plots were treated weekly with bioherbicidal mixtures and dead culms (stems) were assessed after 3 weeks.

TABLE 13
New culm data (assessed at weekly intervals) in Phragmites australis
plots treated with bioherbicidal Mixtures

| | | | New | New | New |
|---|---|---|---|---|---|
| | | Initial | culms | culms | culms |
| Plot | | number | after 1 | after 2 | after 3 |
| number | Treatment | of culms | week | weeks | weeks |
| 1 | Water control | 105 | 125 | 127 | 152 |
| 2 | 5% arginine + | 94 | 101 | 103 | 102 |
| | 1% butyrate + | | | | |
| | 15% citrus oil + | | | | |
| | 15% sucrose | | | | |
| 3 | 5% arginine + | 105 | 108 | 109 | 109 |
| | 3% butyrate + | | | | |
| | 15% citrus oil + | | | | |
| | 15% sucrose | | | | |
| 4 | 5% arginine + | 98 | 105 | 108 | 92 |
| | 15% citrus oil + | | | | |
| | 15% sucrose | | | | |

This provides further support that the arginine-based bioherbicide may have a longer acting effect in reducing plant aggressiveness. Organic salts are used as preservatives in food products. Reduced activity of the arginine-containing bioherbicide when the organic salt is included may be an indication that the organic salts should be used in low concentration in bioherbicidal mixes.

Other Plants on which the Arginine-Based Bioherbicide was Found to be Effective

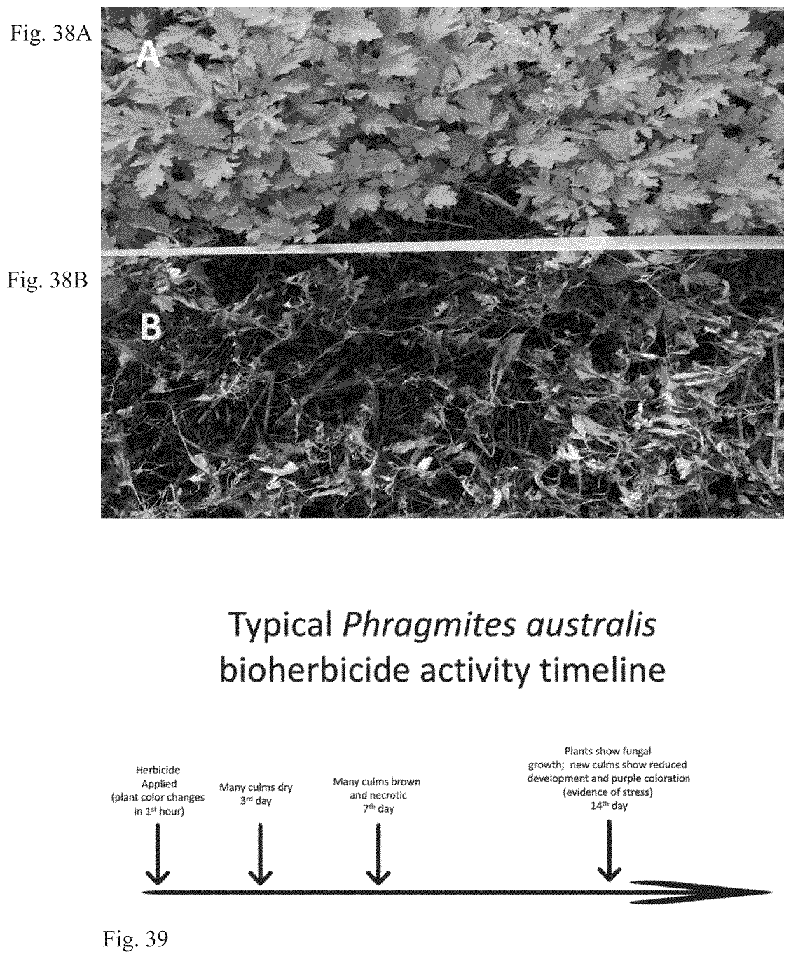

We have conducted experiments involving application of the arginine-based bioherbicide to several weedy plants. In several plants (e.g., invasive mugwort (Artemesia vulgaris); FIG. 38) the bioherbicidal mixture was found to be particularly potent, resulting in rapid killing of plants.

The bioherbicide has been tested and found effective on the following plants:

1) Invasive Mugwort (Artemesia vulgaris)

2) Pennsylvania Smartweed (Polygonum pensylvanicum)

3) Pokeweed (Phytolacca americana)

4) Common Yellow Wood Sorrel (Oxalis stricta)

5) Mile-A-Minute Vine (Persicaria perfoliate)

6) Japanese Stiltgrass (Microstegium vimineum)

7) Blue-Green Algae (Nostoc sp.)

8) Invasive Japanese Hops (Humulus japonicus)

Timeline for Activity of the Arginine-Based Bioherbicidal Mix in Phragmites australis

The arginine-based bioherbicide functions to kill plants over several weeks (FIG. 39). In experiments on Phragmites australis, we have found that application of the bioherbicide affects plants in the first hour, where leaves become lighter green to yellow, with leaves rolling. Over the first seven days, these plants desiccate completely, and over 2-3 weeks fungi are often seen degrading plant tissues. In Phragmites australis, even new growth (culms) from the clonal plants that were not treated with the bioherbicide show reduced growth and increased stress (FIG. 39).

### REFERENCES

Baker E A. (1982) Chemistry and morphology of plant epicuticular waxes. In: Cutler, D. F. Alvin, K. L., Price C E. The Plant Cuticle, Academic Press, 139-165.
Binder B M and Schaller E. eds (2017). Ethylene Signaling (Springer New York: New York, N.Y.).
Chae, H. S. and Lee, W. S. (2001). Ethylene- and enzyme-mediated superoxide production and cell death in carrot cells grown under carbon starvation. Plant Cell Rep. 20: 256-261.
Chang X, Kingsley K L and White J F. (2021) Chemical Interactions at the Interface of Plant Root Hair Cells and Intracellular Bacteria. Microorganisms. 2021; 9(5):1041. https://doi.org/10.3390/microorganisms9051041
Compant S, Clement C, Sessitsch A. (2010) Plant growth-promoting bacteria in the rhizo- and endosphere of plants: Their role, colonization, mechanisms involved and prospects for utilization. Soil Biol Biochem 42: 669-678.
Doty S L (2017) Functional importance of the plant microbiome: Implications for agriculture, forestry and bioenergy. Pages 1-5 in: Doty S L (Ed.), Functional Importance of the Plant Microbiome. Springer, Amsterdam, Netherlands.
Errington J, Mickiewicz K, Kawai Y, Wu U. (2016) L-form bacteria, chronic diseases and the origins of life. Phil. Trans. R. Soc. B 2016 371 20150494; DOI: 10.1098/rstb.2015.0494. Funk-Jensen D,
Feng Y, Xu P, Li B, Li P, Wen X, An F, et al. (2017). Ethylene promotes root hair growth through coordinated EIN3/EIL1 and RHD6/RSL1 activity in Arabidopsis. Proc. Natl. Acad. Sci. U.S.A. 114: 13834-13839.
Foreman J, Demidchik V, Bothwell J H F, Mylona P, Miedema H, et al. (2003). Reactive oxygen species produced by NADPH oxidase regulate plant cell growth. Nature 422: 442-446.
Gond S K, Bergen M, Torres M S, White J F. (2015) Effect of bacterial endophyte on expression of defense genes in Indian popcorn against Fusarium moniliforme. Symbiosis 66: 133-140. DOI: 10.1007/s13199-015-0348-9.
Hamilton C E, Gundel P E, Helander M, Saikkonen K. (2012) Endophytic mediation of reactive oxygen species and antioxidant activity in plants: a review. Fungal Diversity 54: 1-10.
Hardoim P R, van Overbeek L S, Berg G, Pirttilä A M, Compant S, et al. (2015) The hidden world within plants: ecological and evolutionary considerations for defining functioning of microbial endophytes. Microbiol. Mol. Biol. Rev. 79: 293-320. doi:10.1128/MMBR.00050-14.
Hill P W, Marsden K A, Jones D L (2013). How significant to plant N nutrition is the direct consumption of soil microbes by roots? New Phytol. 199: 948-955.
Holland M A. 1997. Methylobacterium and plants. Recent Res Dev in Plant Physiol 1: 207-213.
Hu L, Robert C A M, Cadot S, Zhang X, Ye M, et al. (2018). Root exudate metabolites drive plant-soil feedbacks on growth and defense by shaping the rhizosphere microbiota. Nat. Commun. 9: 1-13.
Irizarry I, White J F. (2017) Application of bacteria from non-cultivated plants to promote growth, alter root architecture and alleviate salt stress of cotton. J. Appl. Microbiol. 122: 1110-1120; doi: 10.1111/jam.13414.
Irizarry I, White J F. (2018). Bacillus amyloliquefaciens alters gene expression, ROS production, and lignin synthesis in cotton seedling roots. J. Applied Microbiology 124: 1589-1603.
Johnston-Monje D, Raizada M N. (2011) Conservation and diversity of seed associated endophytes in Zea across boundaries of evolution, ethnography and ecology. PLoS ONE 6(6): e20396. doi:10.1371/journal.pone.0020396.
Kandel S L, Joubert P M, Doty L S. (2017) Bacterial endophyte colonization and distribution within plants. Microorganisms 5: 77; doi:10.3390/microorganisms5040077.
Kowalski K P, Bacon C, Bickford W, Braun H, Clay K, et al. (2015) Advancing the science of microbial symbiosis to support invasive species management: A case study on Phragmites in the Great Lakes. Frontiers in Microbiology January 2015; 6:95. DOI: 10.3389/fmicb.2015.00095
Lanzagorta J M A, de la Torre C, Aller P. (1988). The effect of butyrate on cell cycle progression in Allium cepa root meristems. Physiologia Plantarum 72: 775-781.
Lynch J, Brown K M. (1997). Ethylene and plant responses to nutritional stress. Physiol. Plant. 100: 613-619.
Monshausen G B, Bibikova T N, Messerli M A, Shi C, Gilroy S. (2007). Oscillations in extracellular pH and reactive oxygen species modulate tip growth of Arabidopsis root hairs. Proc. Natl. Acad. Sci. U.S.A. 104: 20996-21001.
Paungfoo-Lonhienne C, Rentsch D, Robatzrk S, Webb R I, Sagulenko E, et al. (2010) Turning the table: plants consume microbes as a source of nutrients. PLOS ONE 5(7): e11915. doi: 10:1371/journal.pone.0011915.
Paungfoo-Lonhienne, C., Schmidt, S., Webb, R. and Lonhienne, T. (2013) Rhizophagy-A new dimension of plant-microbe interactions, in de Briujn, F. J. (Ed.) Molecular Microbial Ecology of the Rhizosphere. Wiley-Blackwell. Pub John Wiley & Sons, Inc.
Pitts R J, Cernac A, Estelle M. (1998). Auxin and ethylene promote root hair elongation in Arabidopsis. Plant J. 16: 553-560.
Qiu Y, Ma X, Yang X, Wang L, Jiang Z. (2017) Effect of sodium butyrate on cell proliferation and cell cycle in porcine intestinal epithelial (IPEC-J2) cells. In Vitro Cell Dev Biol Anim. 2017 April; 53(4):304-311. doi: 10.1007/s11626-016-0119-9. Epub 2017 Jan. 27. PMID: 28127702.
Rodriguez R J, Woodward C, Kim Y O, Redman R S. (2009) Habitat-adapted symbiosis as a defense against abiotic and biotic stresses. In: White J F Jr, Torres M S (eds) Defensive Mutualism in Microbial Symbiosis, CRC Press, Boca Raton, Fla., USA. pp. 335-346.
Shehata H R, Dumigan C, Watts S, Raizada M N. (2017). An endophytic microbe from an unusual volcanic swamp corn seeks and inhabits root hair cells to extract rock phosphate. Sci. Rep. 7: 1-13.
Soares M A, Li H, Bergen M, White J F. (2015) Functional role of an endophytic Bacillus amyloliquefaciens in enhancing growth and disease protection of invasive English ivy (Hedera helix L.). Plant and Soil 405: 107-123. DOI: 10.1007/s11104-015-2638-7.
Soares M A, Li H-Y, Kowalski K P, Bergen M, Torres M S, et al. (2016) Functional roles of bacteria from invasive Phragmites australis in promotion of host growth. Microb Ecol 72: 407-17.
Stone J K, Bacon C W, White J F. (2000) An overview of endophytic microbes: endophytism defined. In: Bacon C W, White J F (eds) Microbial Endophytes, Marcel-Dekker, New York, USA, pp. 3-30
Thomas P, Soly T A. (2009) Endophytic bacteria associated with growing shoot tips of banana (Musa sp.) cv. Grand Nane and the affinity of endophytes to the host. Microbial Ecology 58: 953-964.
Thomas P, Reddy K M. (2013) Microscopic elucidation of abundant endophytic bacteria colonizing the cell wall-plasma membrane peri-space in the shoot-tip tissue of banana. AOB Plants 5: plt011, https://doi.org/10.1093/aobpla/plt011.
Torres M S, White J F, Zhang X, Hinton D M, Bacon C W. (2012) Endophyte-mediated adjustments in host morphology and physiology and effects on host fitness traits in grasses. Fungal Ecology 5: 322-330.
Tramontano W A, Scanlon C. (1996) Cell cycle inhibition by butyrate in legume root meristems. Phytochemistry 41: 85-88.
Trobacher C P. (2009). Ethylene and programmed cell death in plants. Botany 87: 757-769.
Verma S K, Kingsley K, Irizarry I, Bergen M, Kharwar R N, et al. (2017a) Seed vectored endophytic bacteria modulate development of rice seedlings. J. Applied Microbiology 122: 1680-1691.
Verma S K, Kingsley K, Bergen M, English C, Elmore M, et al. (2017b) Bacterial endophytes from rice cut grass (Leersia oryzoides L.) increase growth, promote root gravitropic response, stimulate root hair formation, and protect rice seedlings from disease. Plant and Soil 422: 223-238. DOI: 10.1007/s11104-017-3339-1.
Verma S K, White J F. (2018) Indigenous endophytic seed bacteria promote seedling development and defend against fungal disease in browntop millet (Urochloa ramosa L.). Journal of Applied Microbiology 124: 764-778. DOI: 10.1111/jam.13673.
Verma S K, Kingsley K L, Bergen M S, Kowalski K P, White J F. (2018) Fungal disease protection in rice (Oryza sativa) seedlings by growth promoting seed-associated endophytic bacteria from invasive Phragmites australis. MDPI: Microorganisms. doi: 10.3390/microorganisms6010021.
Waller F, Achatz B, Baltruschat H, Fodor J, Becker K, et al. (2005) The endophytic fungus Piriformospora indica reprograms barley to salt-stress tolerance, disease resistance, and higher yield. PNAS 102: 13386-13391.
White J F, Kingsley K L, Kowalski K P, Irizarry I, Micci A, et al. (2017). Disease protection and allelopathic interactions of seed-transmitted endophytic pseudomonads of invasive seed grass (Phragmites australis). Plant and Soil. 422: 195-208. doi:10.1007/s11104-016-3169-6.
White J F, Torres M S. (2010) Is endophyte-mediated defensive mutualism oxidative stress protection? Physiologia Plantarum 138: 440-446.
White J F, Torres M S, Somu M P, Johnson H, Irizarry I, et al. (2014). Hydrogen peroxide staining to visualize intracellular bacterial infections of seedling root cells. Microscopy Research and Technique 77: 566-573. DOI: 10.1002/jemt.22375.
White J, Kingsley K, Verma S, Kowalski K. (2018a). Rhizophagy Cycle: An Oxidative Process in Plants for Nutrient Extraction from Symbiotic Microbes. Microorganisms 6: 95.
White J F, Chen Q, Torres M S, Mattera R, Irizarry I, et al. (2015). Collaboration between grass seedlings and rhizobacteria to scavenge organic nitrogen in soils. AoB PLANTS 7: 1-11.
White J F, Crawford H, Torres M S, Mattera R, Irizarry I, et al. (2012). A proposed mechanism for nitrogen acquisition by grass seedlings through oxidation of symbiotic bacteria. Symbiosis 57: 161-171.
White J F, Kingsley K, Harper C J, Verma S K, Brindisi L, et al. (2018b). Reactive Oxygen Defense Against Cellular Endoparasites and the Origin of Eukaryotes. In Transformative Paleobotany (Elsevier), pp. 439-460.
White J F, Kingsley K L, Zhang Q, Verma R, Obi N, et al. (2019a). Review: Endophytic microbes and their potential applications in crop management. Pest Manag. Sci. 75: 2558-2565.
White J F, Torres M S, Verma S K, Elmore M T, Kowalski K P, et al. (2019b). Evidence for Widespread Microbivory of Endophytic Bacteria in Roots of Vascular Plants Through Oxidative Degradation in Root Cell Periplasmic Spaces. In PGPR Amelioration in Sustainable Agriculture (Elsevier), pp. 167-193.
Xia J, Yamaji N, Che J, Shen R F, Ma J F. (2014). Normal root elongation requires arginine produced by argininosuccinate lyase in rice. Plant J. 78: 215-226.

### Example VI

### Administration of Bioherbicide Via Soil Drenching

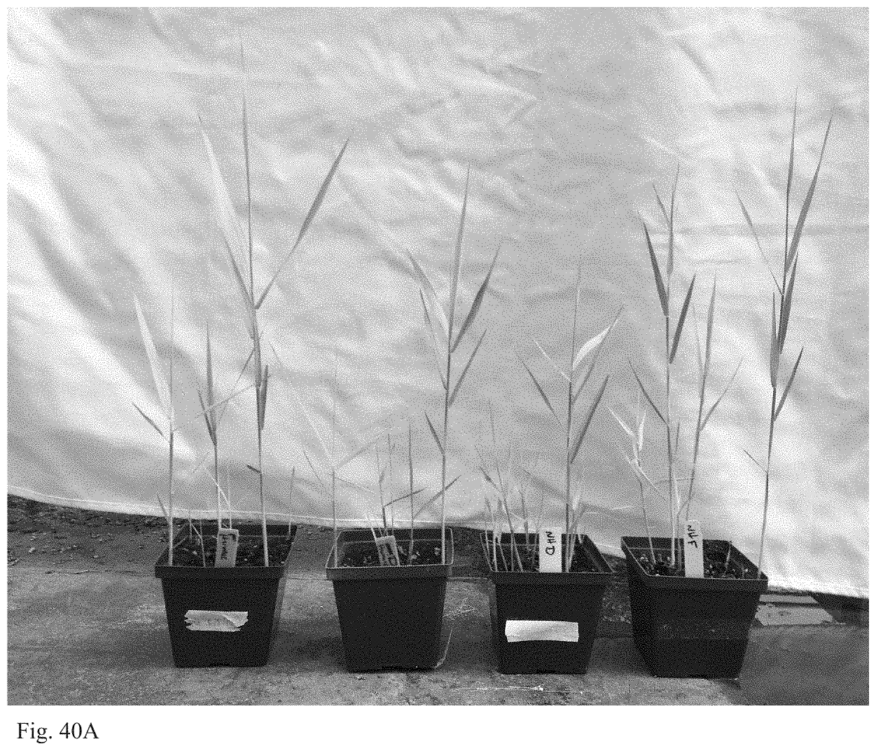

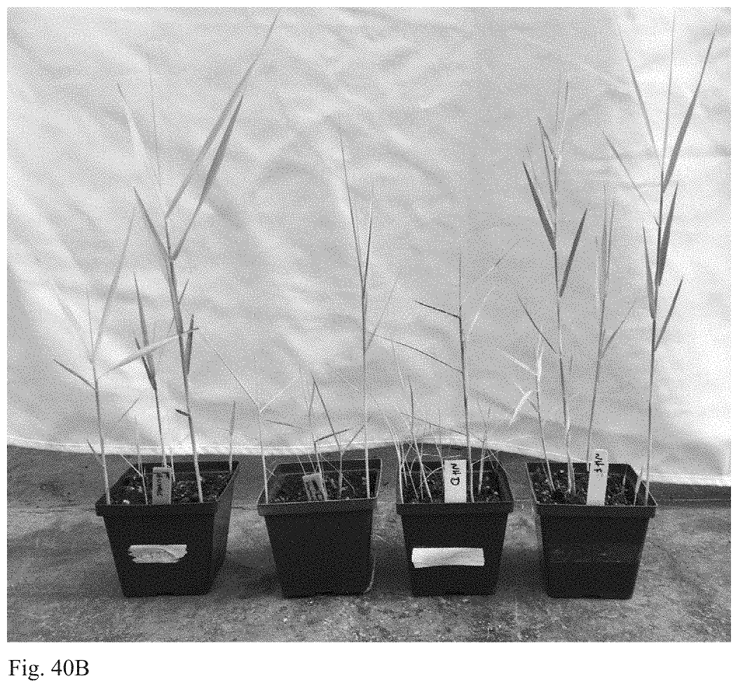

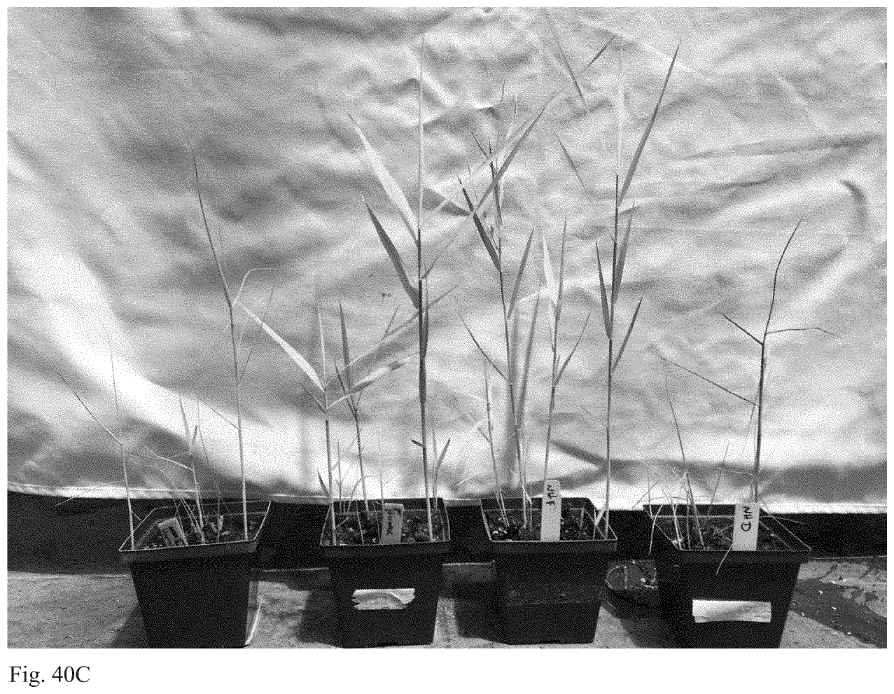

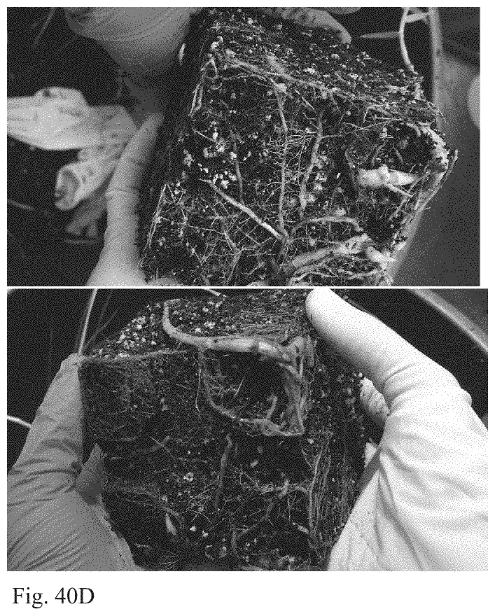

To test the viability of administration of the bioherbicide described above using the soil drenching technique, four plants were potted separately. FIG. 40A. Each plant was treated with 5% Arginine and 10% sucrose, however plants with the orange tags also received 0.01% humic acid. In both treatment groups, one plant received treatment by foliar spray and the other by 50 ml drenching. After 5 days of treatment, the plants that were drenched showed a significant decline and stem death while plants that were treated by foliar spray remained healthy. FIG. 40B. After 11 days, the plants that were drenched were dead or near death while the plants that were treated with foliar spray were beginning to show a decline and stem death. FIG. 40C.

A postmortem analysis of the roots showed complete death of the drenched plant. FIG. 40D. The plant that was drenched showed significantly greater root death than the plant that received the foliar application. Furthermore, the roots of the drenched plant were discolored and soft indicating that there was complete death of the root system. This data indicates that the need for certain bioherbicide components, such as citrus oil, are unnecessary when the composition is applied via soil/root drenching.

While certain of the preferred embodiments of the present invention have been described and specifically exemplified above, it is not intended that the invention be limited to such embodiments. Various modifications may be made thereto without departing from the scope and spirit of the present invention, as set forth in the following claims.

What is claimed is:

1. A bioherbicide composition comprising citrus oil, arginine, and sugar in an agriculturally compatible carrier.

2. The bioherbicide composition of claim 1, further comprising 1%-5% glycerol and wherein the sugar is sucrose.

3. The bioherbicide composition of claim 1, wherein the composition contains 1-15% arginine, 1-20% sucrose, and 5-20% citrus oil.

4. The bioherbicide composition of claim 1, further comprising an effective amount of one or more heterologously disposed inhibitory endophytic bacteria or fungi having 16S rDNA sequences, selected from

| Bacterial Strain | SEQ ID NO: |
|---|---|
| Rhodotorula sp. | 1 |
| Sphingomonas sp. | 2 |
| Rhodococcus sp. | 3 |
| Curtobacterium sp. | 4 |
| Paenibacillus sp. | 5 |
| Pantoea sp. | 6 |
| Pantoea sp. | 7 |
| Aureobasidium pullulans | 8 |
| OVLBP2R Methylobacter sp. | 9 |
| Bacillus sp. | 11 |
| Bacillus sp. | 12 |
| Bacillus sp. | 13 |
| OMYESP3B ID: Terribacillus sp. | 14 |
| OMPDAP5BK ID: Bacillus sp. | 15 |
| Pseudomonas sp. | 16 |
| Exiguobacterium sp. | 17 |
| Pseudomonas sp. | 18 |
| Pantoea sp. | 19 |
| Pantoea sp. | 20 |
| Pantoea sp. | 21 |
| Pantoea sp. | 22 |
| Staphylococcus sp. | 23 |
| Pantoea sp. | 24 |
| Paenibacillus sp. | 25 |
| Pantoea sp. | 26 |
| Pantoea sp. | 27 |
| Xanthomonas sp. | 28 |
| Staphylococcus sp. | 29 |
| Methylobacterium sp. | 30 |
| Panteoa sp. | 31 |
| Panteoa sp. | 32 |
| Pantoea sp. | 33 |
| Pantoea sp. | 34 |
| Pantoea sp. | 35 |
| Micrococcus luteus | 36 |

5. The bioherbicide composition of claim 4, wherein the composition contains 1×10²⁻⁶ cells/mL of inhibitory bacteria or fungi.

6. The bioherbicide composition of claim 4, further comprising organic acids or salts.

7. The bioherbicide composition of claim 4, wherein the composition contains 0.1-6% organic acids or salts.

8. The bioherbicide composition of claim 4, wherein the composition is dissolved or suspended in water.

9. The bioherbicide composition of claim 4, wherein said endophytic bacteria or fungus are present in a combination selected from
i) Aureobasidium pullulans (Froelichia #2) and Micrococcus luteus (Lycopersicum #1) for inducing induce maximum seed mortality or
ii) Rhodotorula sp. (strain Abrus #1), Sphingomonas sp. (strain Abrus #3) and Micrococcus luteus (Lycopersicum #1) for inhibiting root growth or
iii) Aureobasidium pullulans strain Froelichia #2 and Micrococcus luteus strain Lycopersicum #1, Rhodotorula sp. strain Abrus #1, Sphingomonas sp. strain Abrus #3 and Micrococcus luteus strain Lycopersicum #1 for inhibiting root growth and maximizing seed mortality
iv) Strain #5 Pantoea sp. from crabgrass, strain PP4F Pseudomonas sp. from Poa pratenses, strain Froelichia #2 Aureobasidium pullulans for inhibition of undesirable weed species or
v) Strain #4 Pantoea sp. from crabgrass, strain PA-NA-2B1 Paenibacillus sp. from Poa annua, strain PP4-F Pseudomonas sp. from Poa pratensis for inhibiting competitor weeds on grass hosts or
vi) Strain PP4F Pseudomonas sp. from Poa pratenses, Strain PA-NA-2B1 Paenibacillus sp. from Poa annua, Strain Froelichia #2 Aureobasidium pullulans for inhibiting competitor weeds on grass hosts.

10. A method of killing harmful plants comprising administering at least one bioherbicide formulation of claim 4.

11. A method of killing harmful plants comprising administering at least one bioherbicide formulation of claim 9.

12. The method of claim 9, wherein the bioherbicide is administered using a sprayer.

13. The method of claim 9, wherein the bioherbicide is administered by soil drenching.

14. A method of killing harmful plants comprising administering a bioherbicide comprising arginine and sugar by soil drenching.

15. The method of claim 14, wherein the bioherbicide contains 1-15% arginine and 1-20% sugar and at least one endophytic bacteria and/or fungi.

16. The bioherbicide of claim 15, wherein the bioherbicide contains 5% arginine, 1% butyrate, 15% citrus oil, and 15% sucrose.

17. The bioherbicide composition of claim 9, comprising 5% arginine, 1% butyrate, 15% citrus oil, and 15% sucrose.

18. A method of treating soil with a bioherbicidal composition comprising administering the bioherbicide of claim 4 by soil drenching.

19. The bioherbicide composition of claim 17 wherein said composition does not include organic acids or salts.

20. The bioherbicide composition of claim 17 wherein said composition does not include butyrate.

21. The method of claim 14, wherein said administration induces over-production of ethylene and superoxide by endophytic bacteria or fungi endogenous to said plant, thereby forming excess reactive oxygen species (ROS) and causing death of the plant.

22. The method of claim 15, wherein said administration leads to formation of excess reactive oxygen species (ROS) by said heterologously disposed inhibitory bacteria or fungi, said inhibitory bacteria or fungi being exogenous to said plant.

23. The method of claim 15 wherein said administration causes oxidative stress in said plants resulting in plant cell death.


SEQUENCE LISTING (38 sequences)

SEQ ID NO: 1 - DNA, 532 bp, Rhodotorula sp.
  source 1..532: mol_type = genomic DNA
ctaaagttgactaatagaattagaagcttctactttacaaaactcggccactcccgaaagagcgtcctcagcgaatagtctattacactgagtcaatccgattttcgaatatgagatgctaatcatttacgaacgagcttcgccaataaaggccagcaggcgttcagaatccaaacactaatccgatttactagaaaccggtaggttgaagagttcatgacactcaaacagacatgctctccggaataccagagagcgcaaggtgcgttcaaagattcgatgattcactgaattctgcaattcacattacttatcacatttcgctgcgttcttcatcgatgcgagagccaagagatccgttgttgaaagtttttttttgttttgtttttatttacatactttaactaatgtttaatagtgagccgcagactgaatagcaattgcttactctcagtccgccaatagtgcacagagttggaaaatgaaggttgagctaaccgaagttacgctctaaattcactaatgatccttc

SEQ ID NO: 2 - DNA, 1044 bp, Sphingomonas sp.
  source 1..1044: mol_type = genomic DNA
agtcgacgatgctctctcggcatagggttgcgtgggtgctgcgccttgggggcgtaccgcgtccctctgggataacaggtgtgggcgaacggtctgagaacgtggtatctcgaggttgatatcttgccatcaaaggatgatcccccgtcgtattccccgcttggagagaactatctggtggggggaaggcctacgaaggcggcttgctgggacggtcctgcgcggcggatctgacaccctgggactgctcctcgggccggcctcctaggggaagaatcagtggggaataatgccctatgcgcgaaagcctgtgccagcggtgccctgtttatggtggagcacttcgggttgtaaagctctttttgccgggatgcgaatgacagtacccgccaaattccccgcggccaaccccgtgcctgcagccggggcaataggggcggggatagcgtggttcggaagtactgggcgtaaagtttgcggacctggcaagagctggtgaaggtctgctcgttaattccaattaaacaagtgcctttgccgctgggtcacttgaccggcagttccttaggggtttatccaattgtacaagagacactcgaggataatctgaagagccagctgggcgaaccgaggatgatgttgcggggctgctactgatcatcgaaagaggcgtggattacctgggaatccactccggtatgcttggcccgcttttgcgcctcgtcgcggatcgggggtgtggaagttgggtggtccactgaagctcctgggaatatctactaggtagtcctgtaccctcgaataaacggggccctctccagcggggcatcgtggggctgtggaacgagcggctcacatcaaagtaccgccgttaaccttggccggactatttctgtaccgggcgcttcaccactcggggctcctacctcaggtacttgctggcggacggctgcttgggtgtcgacgggttgagcaagggctgattggaccgggacccccatccataagttcctatcctttaattaccgtaatttaaaagggaac

SEQ ID NO: 3 - DNA, 946 bp, Rhodococcus sp.
  source 1..946: mol_type = genomic DNA
ttcgccgccggcttcgggtgttaccgactttcatgaggggacgggcggtgtgtacaaggcccgggaacgtattcaccgcagcgttgctgatctgcgattactagcgactccgacttcacggggtcgagttgcagaccccgatccgaactgagaccggctttaagggattcgctccacctcacggtatcgcagccctctgtaccggccattgtagcatgtgtgaagccctggacataaggggcatgatgacttgacgtcgtccccaccttcctccgagttgaccccggcagtctcctgcgagtcccccgactccgcgggtggcaacacaggacaagggttgcgctcgttgcgggacttaacccaacatctcacgacacgagctgacgacagccatgcaccacctgtacaccgaccacaaggggggccgtgtctccacggctttccggtgtatgtcaaacccaggtaaggttcttcgcgttgcatcgaattaatccacatgctccgccgcttgtgcgggcccccgtcaattcctttgagttttagccttgcggccgtactccccaggcggggcgcttaatgcgttagctacggcacggatcccgtggaaggaaacccacacctagcgcccaccgtttacggcgtgaactaccagggtatctaatcctgttcgctacccacgcattcgctcctcagcgtcagttatttcccagagacccgccttcgccaccggtgttcctcctgatatctgcgcatttcaccgctacatcaggaattccagtctcccctgaagtactcaagtctgcccgtatcgcctgcaagccaacagttgagctgctgggatcctcagacgatgcgacaaaccgcctacaagctctttacccccagtaattccggacgaagcttggagcctacgtggtaccccggctgctggcacgtagttggccgg

SEQ ID NO: 4 - DNA, 1008 bp, Curtobacterium sp.
  source 1..1008: mol_type = genomic DNA
tggggtcgtccgacgagggggagcttgcccgggtgcggggtggagaaaggttgatgacttcgtgagtaacctgcccatggctctgggatgtatttagcacacgacgtctaatactggataagatcagacgccgcatggactggtggtggaagcagatttcagttggggctggactcgcggcctatcagcttgttggtgaggtaatggctcaccaaggcggcgccgggtagccggcctggcggggtgcccggccacactggggctgaatgacggcccagcctcctacgggtcgcagcagtggggaatattgcacaatgggcgaaagcctgctgcagcaacgccgcgtgtaggacgagggccttcgggttgtaaacctcttttagtagggaagaagccacgaggtgggtacctgcagaaaaagcaccggctaactacgtgcgagcagccgcggtaatacgtagggtgcaagcgttgtccggaattattgggcgtaaagagctcgtacgcggtttgtcgcgtcctccgccgcttgccgaggctccccctcgggcttgcggtgggtacgggcagactagagtgcggcaggggaggctgtaaatgctggagctgcggcgcaaagcgcagagaacaggccgaacatctatggccaaacgttaactctggggcgtaactggggctgtagtcctgatccgtggggacccattcggtctacagcgtctggtactgcccgcagtaatcgtttcgccctcggtgtaccgcccgttacccgggttctgcgccgcaactcccggatttcccgccccccctagggaattctgccgcgccggtaaaccttgaaggccttagggggggcctcggcaatccgcggcacatgcgactaaactcctagcagcgctttacaccttaccattcctggacatcccccggaccataggtatgacatgggctgcccctacggagcggggcaggggctttttattgcaggtatcggcactttccctgcgatct

SEQ ID NO: 5 - DNA, 849 bp, Paenibacillus sp.
  misc_feature 670: note = n is a, c, g, or t
  source 1..849: mol_type = genomic DNA
caattccgacttcatgcaggcgagttgcagcctgcaatccgaactgagaccggcttttaaggattggctccatcttgcgatattgcttcccgttgtaccggccattgtagtacgtgtgtagcccaagtcataaggggcatgatgatttgacgtcatccccaccttcctccggtttgtcaccggcagtctgcttagagtgcccaccatgatgtgctggcaactaagcataagggttgcgctcgttgcgggacttaacccaacatctcacgacacgagctgacgacaaccatgcaccacctgtctcctttgtcccgaaggaaaagactatctctagtccggtcaaagggatgtcaagacttggtaaggttcttcgcgttgcttcgaattaaaccacatactccactgcttgtgcgggtccccgtcaattcctttgagtttcagtcttgcgaccgtactccccaggcggaatgcttaatgtgttaacttcggcaccaagggtatcgaaacccctaacacctagcattcatcgtttacggcgtggactaccagggtatctaatcctgtttgctccccacgctttcgcgcctcagcgtcagttacagcccagaaagtcgccttcgccactggtgttcctccacatctctacgcatttcaccgctacacgtggaanttccactttcctcttctgtactcaagctctccagtttccagtgcgacccaaggttgagccttgggctgtgacaccggacttaaaaagccgcctgcgcgcgctttacgcccaataattccggacaacgcttgccccctacgtattaccgcggctgctggcacgtagttagccggggcttt

SEQ ID NO: 6 - DNA, 995 bp, Pantoea sp.
  source 1..995: mol_type = genomic DNA
ggtatgcactccccgggtggctagccaccctacttcttttgcacccccctcccttgttgtgacggggggtgtgtacaaggcccgggaaggtattacccggggaattctgttcaccgataactggcgattccgacttcagggagccgagttgcagattccgatccggacaacgccgcattttatgaggtccgttggctctcgcggggtcgcttctctttgttggcgccatggaagcacgtgtgtagccctactcgtaagggccatgttgccttgccgtcatccccaccttcctccggtttatcaccggcagtctcttttgagttcccgaccgaatcgctggcaacaaaggttaagggttgcgctcgttgcgggatttaacccaacatttcacaacacgagctgccgacagccatgcagcacctgtctcaaatttcccgaaggaaaaaaggaatctctgcctcttcgtcgggttgtcaagagtaggtaaggttcttcgcgttgcatcgaattaaaccacatgctccacccttgtgcgggccccccgtcaattcatttgattttaaaccttgcggccgaattcccagggcggccgcttaaccgcgtaacctccggaaccccctccccagggaaaaaccctccaatccaaattctttaagggggggaataacaggggaaccaatcctggtttcttcccacgccttcggcaccggacggcagtcctcggtcaagggggcgcccttcccccccggaattcctccgaactccaatccttttaccccctctcccggaaatctaaccccctttaacaaatttcaagccggccgttttcaatggaagttcccggttaaagccgggggctttacattcgaatttaaaaaacccccgggcggcgttttagccccagaatttccaattaagcttggaaccctcttaataacctcgatggctggaccgatttaaacagagccttttccggggggatcggtcatccaatg

SEQ ID NO: 7 - DNA, 1098 bp, Pantoea sp.
  source 1..1098: mol_type = genomic DNA
ggggagtatgctgcgggttgtaccacatagcttcgggagggaaaatactttcagtgggggtgctaacattctttcagtggccgagtcgatgacgttacccacaggagtagattcgggtaaccccgtgcaagcgcccgcgctaattcggaggcagcaggcccgattaggagttagtggccagaaagagtaggcaggagttggcgtaaagcgcatgcggacgcccggggcattcagatgggaatgccctggaatctggcaggcaagagcattgtaaagggggggagaattccatgtgaggcggggaaaggagtagaggtgtagcggaaaaccggggggagaggcggccccctgccggaagagaggcggtcagctgcgaaagcgaggggagcaaacaggattaggtgccctgatcatccacgctttgatcgatgtcgactccgagcttgttccgatgtcgactgggatctggagctcacgcgttaaggcgtccgcagggagagtacgaccgcaaggttaaaactcaaacgaatggaaggggacccgcacaagcggtggagcatgtggtttaattcgatgcaacgcgaagaaccttacctactcttgacaaagaaccttacctacagagatcatccagtgccttcgggagagatgagacaggtgctgcatggctgtcgtcagctcgtgttgtgaaatgttgggttaacgcccgcaacgagcgcaacccttatcctttgttgccagcgattcggtcgggaactcaaaggagactgccggggataaaccggaggaaggtggggatgacgacaagacacatggcccttacgagtagggctacacacgtgctacaatggcgcctacaaagagaagcgaccgcgcgagagcaagcggacctcataaactgcggcgtacgccggatcggaatctgcaactcgaccgggtgaaatcggaatcgccggtaatcggagatcagaatcccacggtaaatacgttcccaggccttgtacacatacgttcccggaccatgggagcaggttgcaaaagaagatgggagtgggttgtaaaagaagtaggtagcttaaccttcgggagggcgctacc

SEQ ID NO: 8 - DNA, 581 bp, Aureobasidium pullulans
  source 1..581: mol_type = genomic DNA
ccgtagggtgaacctgcggaaggatcattaaagagtaagggtgctcagcgcccgacctccaaccctttgttgttaaaactaccttgttgctttggcgggaccgctcggtctcgagccgctggggattcgtcccaggcgagcgcccgccagagttaaaccaaactcttgttatcaaaccggtcgtctgagttaaaattttgaataaatcaaaactttcaacaacggatctcttggttctcgcatcgatgaagaacgcagcgaaatgcgataagtaatgtgaattgcagaattcagtgaatcatcgaatctttgaacgcacattgcgccccttggtattccgaggggcatgcctgttcgagcgtcattacaccactcaagctatgcttggtattgggtgccgtccttagttgggcgcgccttaaagacctcggcgaggcctcaccggctttaggcgtagtagaatttattcgaacgtctgtcaaaggagaggacttctgccgactgaaacctttatttttctagttgacctcggatcaggtagggatacccgctgaacttaagcatatcaataagcggaggaa

SEQ ID NO: 9 - DNA, 1219 bp, Methylobacter sp.
  source 1..1219: mol_type = genomic DNA
tcgagttgcagagtgcaatctgaactgagacggtttttggggatttgctccagatcgctccttgcgtcccactgtcaccgccattgtagcacgtgtgtagcccatcccgtaagggccatgaggacttgacgtcatccacaccttcctcgcggcttatcaccggcagtctccctagagtgcccaactgaatgatggcaactaaggacgtgggttgcgctcgttgcgggacttaacccaacatctcacgacacgagctgacgacagccatgcagcacctgtgttcgcgtccccgaagggaaccccggatctctccggatggcacgacatgtcaagggatggtaaggttctgcgcgttgcttcgaattaaaccacatgctccaccgcttgtgcgggcccccgtcaattcctttgagttttaatcttgcgaccgtactccccaggcggaatgcttaaagcgttagctgcgctactgcggtgcaagcaccccaacagctagcattcatcgtttacggcgtggactaccagggtatctaatcctgtttgctccccacgctttcgcgcctcagcgtcagtaatggcccagtcagccgccttcgccactggtgttcttgcgaatatctacgaatttcacctctacactcgcagttccactgacctctgccatactcaagccaaacagtatcgaaggcaattctgtggttgagccacaggctttcacccccgacttgaatggccgcctacgcgccctttacgcccagtgattccgagcaacgctagcccccttcgtattaccgcggctgctggcacgaagttagccggggcttattcttccggtaccgtcattatcgtcccggacaaaagagctttacaaccctaaggccttcatcactcacgcggcatggctggatcaggcttgcgcccattgtccaatattccccactgctgcctcccgtaggagtctgggccgtgtctcagtcccagtgtggctgatcatcctctcagaccagctactgatcgtcgccttggtaggccattaccccaccaactagctaatcagacgcgggccgatccttcggcagtaaacctttccccagggccagaggccatgggcgtatccggtattagcgctagtttcccagcgttattccgaaccgaagggtacgttcccacgtgttactcacccgtctgccgctgacaccgaagtgcccgctcgacttcc

SEQ ID NO: 10 - DNA, 853 bp, Sphingomonas sp.
  source 1..853: mol_type = genomic DNA
actagcgattccgccttcatgctctcgagttgcagagaacaatccgaactgagacggcttttggagattagcgcacactcgcgtgcttgctgcccactgtcaccgccattgtagcacgtgtgtagcccagcgcgtaagggccatgaggacttgacgtcatccccaccttcctccggcttatcaccggcggttcctttagagtccccaactgaatgatggtaactaaaggcgagggttgcgctcgttgcgggacttaacccaacatctcacgacacgagctgacgacagccatgcagcacctgtgttccagtccccgaagggaagagatccatctctggaaatcgtccggacatgtcaaacgctggtaaggttctgcgcgttgcttcgaattaaaccacatgctccaccgcttgtgcaggcccccgtcaattcatttgagttttaaccttgcggccgtactccccaggcggataacttaatgcgttagctgcgccacccaaagaccaagtccccggacagctagttatcatcgtttacggcgtggactaccagggtatctaatcctgtttgctccccacgctttcgcacctcagcgtcaataccagtccagtgagccgccttcgccactggtgttcttccgaatatctacgaatttcacctctacactcggaattccactcacctctcctggattcaagccatgcagtatcaaaggcaattctggggttgagccccaggctttcacctctaacttacaaagccgcctacgtgcgctttacgcccagtaattccgaacaacgctagctccctccgtattaccgcggctgctggcacggagttagccggagcttat

SEQ ID NO: 11 - DNA, 736 bp, Bacillus sp.
  source 1..736: mol_type = genomic DNA
gctaataccggataacattttgaactgcatggttcgaaattgaaaggcggcttcggctgtcacttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggctttcgggtcgtaaaactctgttgttagggaagaacaagtgctagttgaataagctggcaccttgacggtacctaaccagaaagccacggctaactacgtgccagcagccgcggtaatacgtaggtggcaagcgttatccggaattattgggcgtaaagcgcgcgcaggtggtttcttaagtctgatgtgaaagcccacggctcaaccgtggagggtcattggaaactgggagacttgagtgcagaagaggaaagtggaattccatgtgtagcggtgaaatgcgtagagatatggaggaacaccagtggcgaaggcgactttctggtctgtaactgacactgaggcgcgaaagcgtggggagcaaacaggattagataccctggtagtccacgccgtaaacgatgagtgctaagtgttagagggtttccgccctttagtgctgaagttaacgcattaagcactccgcctggggagta

SEQ ID NO: 12 - DNA, 770 bp, Bacillus sp.
  source 1..770: mol_type = genomic DNA
gatggttcgaaattgaaaggcggcttcggctgtcttttatggatggacccgcgtcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgtcaaggcttgcgctcgttgcgggtgttaacccaacatcccacgacacgagctgtcgacaaccatgcaccacctgtcactctgctcccgaccgtgaagccctatctctagggttttcagaggaagtcaaggcctggtaacgctctaatacgtaggtggcaagcgttatcatgctctaccgctcgtgcggcgcccggtcgtttcctttgaattttgacctggcagccgacgtcccaacgggggatggtcattggaaaatgtgaagcttgaatggaggaaaggcctctggaacttagtgtttagcgttgaaggggggagatacctggatgactaaccctggtgaatccgcactctttgtctgcacctggccctgtagagcgaaaacgtgcggctccaacagggttggatcccctggtatctaccgccttaaacgatgagcgtggaatgttagttgcctctccccctttaaagttgacgtgttcgcattgagcactccggctggggactagggcttcaaggttgaaattcaaaagaattgagggggggcctcacgaccggtggagcatgag

SEQ ID NO: 13 - DNA, 863 bp, Bacillus sp.
  source 1..863: mol_type = genomic DNA
attactagcgattccagcttcatgtaggcgagttgcagcctacaatccgaactgagaacggttttatgagattagctccacctcgcggtcttgcagctctttgtaccgtccattgtagcacgtgtgtagcccaggtcataaggggcatgatgatttgacgtcatccccaccttcctccggtttgtcaccggcagtcaccttagagtgcccaacttaatgatggcaactaagatcaagggttgcgctcgttgcgggacttaacccaacatctcacgacacgagctgacgacaaccatgcaccacctgtcactctgctcccgaaggagaagccctatctctagggttttcagaggatgtcaagacctggtaaggttcttcgcgttgcttcgaattaaaccacatgctccaccgcttgtgcgggcccccgtcaattcctttgagtttcagccttgcggccgtactccccaggcggagtgcttaatgcgttaacttcagcactaaagggcggaaaccctctaacacttagcactcatcgtttacggcgtggactaccagggtatctaatcctgtttgctccccacgctttcgcgcctcagtgtcagttacagaccagaaagtcgccttcgccactggtgttcctccatatctctacgcatttcaccgctacacatggaattccactttcctcttctgcactcaagtctcccagtttccaatgaccctccacgggttgagccgtgggctttcacatcagacttaagaaaccacctgcgcgcgctttacgcccaataattccggataacgcttgccacctacgtattaccgcggctgctggcacgtagttagccgtggctttctgggtt

SEQ ID NO: 14 - DNA, 744 bp, Terribacillus sp.
  source 1..744: mol_type = genomic DNA
gattccggcttcatgcaggcgagttgcagcctgcaatccgaactgagaatggttttatgggatttgcttagcctcgcggcttcgctgccctttgtaccatccattgtagcacgtgtgtagcccaggtcataaggggcatgatgatttgacgtcatccccaccttcctccggtttgtcaccggcagtcactctagagtgcccaactgaatgctggcaactagaatcaagggttgcgctcgttgcgggacttaacccaacatctcacgacacgagctgacgacaaccatgcaccacctgtcacgctgtccccgaagggaacgccttgtctccaaggttgtcagcggatgtcaagacctggtaaggttcttcgcgttgcttcgaattaaaccacatgctccaccgcttgtgcgggcccccgtcaattcttttgagtttcagccttgcggccgtactccccaggcggagtgcttaatgcgttaacttcagcactaaggggcggaaaccccctaacacctagcactcatcgtttacggcgtggactaccagggtatctaatcctgtttgctcccccacgctttcgcgcctcagcgtcagttacagaccagagagtcgccttcgccactggtgttcctccacatatctacgcatttcaccgctacacgtggaattccactctcctcttctgcactcaagttccccagtttccaatgaccctccacagttaagctgtgggctttcacatca

SEQ ID NO: 15 - DNA, 560 bp, Bacillus sp.
  source 1..560: mol_type = genomic DNA
cggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggacggtcattggaaactgggaaacttgagtgcagaagaggagagtggaagtacacgtgtagcggtgaaatgcgtagagatgtggagaaacagcggtgga

SEQ ID NO: 16 - DNA, 788 bp, Pseudomonas sp.
  source 1..788: mol_type = genomic DNA
ctagcgattccgacttcacgcagtcgagttgcagactgcgatccggactacgatcggttttatgggattagctccacctcgcggcttggcaaccctctgtaccgaccattgtagcacgtgtgtagcccaggccgtaagggccatgatgacttgacgtcatccccaccttcctccggtttgtcaccggcagtctccttagagtgcccaccataacgtgctggtaactaaggacaagggttgcgctcgttacgggacttaacccaacatctcacgacacgagctgacgacagccatgcagcacctgtctcaatgttcccgaaggcaccaatctatctctagaaagttcattggatgtcaaggcctggtaaggttcttcgcgttgcttcgaattaaaccacatgctccaccgcttgtgcgggcccccgtcaattcatttgagttttaaccttgcggccgtactccccaggcggtcaacttaatgcgttagctgcgccactaaaagctcaaggcttccaacggctagttgacatcgtttacggcgtggactaccagggtatctaatcctgtttgctccccacgctttcgcacctcagtgtcagtattagtccaggtggtcgccttcgccactggtgttccttcctatatctacgcatttcaccgctacacaggaaattccaccaccctctaccatactctagtcagtcagttttgaatgcagttcccaggttgagcccggggatttcacatccaacttaacaaaccacctacgcgcgctttacgcccagtaa

SEQ ID NO: 17 - DNA, 797 bp, Exiguobacterium sp.
  source 1..797: mol_type = genomic DNA
accgaatagttcttcagaccgcatggtctgatgatgaaaggcgctccggcgtcaccttgggatggccttgcggtgcattagctagttggtggggtaatggcccaccaaggcgacgatgcatagccgacctgagagggtgatcggccacactgggactgagacacggcccagactcctacgggaggcagcagtagggaatcttccacaatggacgaaagtctgatggagcaacgccgcgtgagtgatgaaggttttcggatcgtaaaactctgttgtaagggaagaacaagtacgagaggtaatgctcgtaccttgacggtaccttgcgagaaagccacggctaactacgtgccagcagccgcggtaatacgtaggtggcaagcgttgtccggaattattgggcgtaaagcgcgcgcaggcggccttttaagtctgatgtgaaagcccccggctcaaccggggagggtcattggaaactggaaggcttgagtacagaagagaagagtggaattccatgtgtagcggtgaaatgcgtagagatgtggaggaacaccagtggcgaaggcgactctttggtctgtaactgacgctgaggcgcgaaagcgtggggagcaaacaggattagataccctggtagtccacgccgtaaacgatgagtgctagtgttggggggtttccgcccctcagtgctgaagctaacgcattaagcactccgcctggggagtacggccgcaaggctgaaactcaaggaattgacggggacccgcacaagcggtggagcatgtggtttaattcga

SEQ ID NO: 18 - DNA, 1358 bp, Pseudomonas sp.
  source 1..1358: mol_type = genomic DNA
tagctacttctggtgcaacccactcccatggtgtgacgggcggtgtgtacaaggcccgggaacgtattcaccgcgacattctgattcgcgattactagcgattccgacttcacgcagtcgagttgcagactgcgatccggactacgatcggttttgtgagattagctccacctcgcggcttggcgaccctctgtaccgaccattgtagcacgtgtgtagcccaggccgtaagggccatgatgacttgacgtcatccccaccttcctccggtttgtcaccggcagtctccttagagtgcccaccataacgtgctggtaactaaggacaagggttgcgctcgttacgggacttaacccaacatctcacgacacgagctgacgacagccatgcagcacctgtgtcagagttcccgaaggcaccaatccatctctggaaagttctctgcatgtcaaggcctggtaaggttcttcgcgttgcttcgaattaaaccacatgctccaccgcttgtgcgggcccccgtcaattcatttgagttttaaccttgcggccgtactccccaggcggtcaacttaatgcgttagctgcgccactaaaatctcaaggattccaacggctagttgacatcgtttacggcgtggactaccagggtatctaatcctgtttgctccccacgctttcgcacctcagtgtcagtatcagtccaggtggtcgccttcgccactggtgttccttcctatatctacgcatttcaccgctacacaggaaattccaccaccctctactgtactctagcttgccagttttggatgcagttcccaggttgagcccggggctttcacatccaacttaacaaaccacctacgcgcgctttacgcccagtaattccgattaacgcttgcaccctctgtattaccgcggctgctggcacagagttagccggtgcttattctgtcggtaacgtcaaaacagcaaggtattcgcttactgcccttcctcccaacttaaagtgctttacaatccgaagaccttcttcacacacgcggcatggctggatcaggctttcgcccattgtccaatattccccactgctgcctcccgtaggagtctggaccgtgtctcagttccagtgtgactgatcatcctctcagaccagttacggatcgtcgccttggtgagccattaccccaccaactagctaatccgacctaggctcatctgatagcgcaaggcccgaaggtcccctgctttctcccgtaggacgtatgcggtattagcgttcctttcgaaacgttgtcccccactaccaggcagattcctaggcattactcacccgtccgccgctgaatcgaagagcaagc

SEQ ID NO: 19 - DNA, 921 bp, Pantoea sp.
  source 1..921: mol_type = genomic DNA
tgcaagtcggacggtagcacagagagcttgctctcgggtgacgagtggcggacgggtgagtaatgtctggggatctgcccgatagagggggataaccactggaaacggtggctaataccgcataacgtcgcaagaccaaagagggggaccttcgggcctctcactatcggatgaacccagatgggattagctagtaggcggggtaatggcccacctaggcgacgatccctagctggtctgagaggatgaccagccacactggaactgagacacggtccagactcctacgggaggcagcagtggggaatattgcacaatgggcgcaagcctgatgcagccatgccgcgtgtatgaagaaggccttcgggttgtaaagtactttcagcggggaggaaggcgatggggttaataaccctgtcgattgacgttacccgcagaagaagcaccggctaactccgtgccagcagccgcggtaatacggagggtgcaagcgttaatcggaattactgggcgtaaagcgcacgcaggcggtctgttaagtcagatgtgaaatccccgggcttaacctgggaactgcatttgaaactggcaggcttgagtcttgtagaggggggtagaattccaggtgtagcggtgaaatgcgtagagatctggaggaataccggtggcgaaggcggccccctggacaaagactgacgctcaggtgcgaaagcgtggggagcaaacaggattagataccctggtagtccacgccgtaaacgatgtcgacttggaggttgttcccttgaggagtggcttccggagctaacgcgttaagtcgaccgcctggggagtacggccgcaaggttaaaactcaaatgaattgacgggggcccgcacaagcggtggagcatgtggtttaattcgatgcaacgcgaagaa

SEQ ID NO: 20 - DNA, 1009 bp, Pantoea sp.
  source 1..1009: mol_type = genomic DNA
ggtagcgccctcccgaaggttacgttccctacttttttctaccccctctcctttggtcccactcccgtggtgtacaaggcccggggaagtaggcaccgtggcatactgatcgacgatttctggcgattccgacttcacggtttcgagttgcaggctccgatccggagaacgccgcactttatgagatccgcttgctctcgcgaggtcgcttctctttgtatgcgccattgtagcacgtgtgtagccctactcgtaagggccatgttgtcttggcgtcatccccaccttcctccggtttatcaccggcagtctcctttgagttcccgaccgaatcgctggcaacaaagggcaagggttgcgctcgttgcggggcttaacccaacatttcacaacacgagctgacgaacacgagctgacgacagccatgcagcacctgtctgcacgcacccgaaggtgctaaagcatctctatgtcaagagtaggatgtcaagagtaggtaagattcttcgcgttgcatcgaattaaaccacatgctccaccgcttgtgcgggcccccgtcaattcatttgagttttaaccttgcggccgtactccccaggcggtcgacttaacgcgttagctccggaagccactcctcaagggaacaacctctaagtcgacatcgtttacggcgtggactaccagggtatctaatcctgtttgctccccacgctttcgcacctgagcgtcagtcttcgtccagggggccgccttcgccaccggtattcctccagatctctacgcatttcaccgctacaccagaaattctacccccctctacgagattcaagcctgccggttttaaatgcagttcccagggtcagcccggggatttcacatctgattcaacagaacgcctgcgtgcgctttacgcccaggaattccgattaacgcttgcaccctccgtattaccggggctgctggtacggagatagccggagcttctcctgcggggaatggcgatcgaata

SEQ ID NO: 21 - DNA, 854 bp, Pantoea sp.
  source 1..854: mol_type = genomic DNA
agcgccctcccgaaggttaagctacctacttcttttgcaacccactcccatggtgtgacgggcggtgtgtacaaggcccgggaacgtattcaccgtggcattctgatccacgattactagcgattccgacttcacggagtcgagttgcagactccgatccggactacgacgcactttatgaggtccgcttgctctcgcgaggtcgcttctctttgtatgcgccattgtagcacgtgtgtagccctactcgtaagggccatgatgacttgacgtcatccccaccttcctccggtttatcaccggcagtctcctttgagttcccgaccgaatcgctggcaacaaaggataagggttgcgctcgttgcgggacttaacccaacatttcacaacacgagctgacgacagccatgcagcacctgtctcagagttcccgaaggcaccaaagcatctctgctaagttctctggatgtcaagagtaggtaaggttcttcgcgttgcatcgaattaaaccacatgctccaccgcttgtgcgggcccccgtcaattcatttgagttttaaccttgcggccgtactccccaggcggtcgacttaacgcgttagctccggaagccactcctcaagggaacaacctccaagtcgacatcgtttacggcgtggactaccagggtatctaatcctgtttgctccccacgctttcgcacctgagcgtcagtcttcgtccagggggccgccttcgccaccggtattcctccagatctctacgcatttcaccgctacacctggaattctacccccctctacgagactcaagcctgccagtttcaaatgcagttcccaggttaagcccgggga

SEQ ID NO: 22 - DNA, 897 bp, Pantoea sp.
  misc_feature 28: note = n is a, c, g, or t
  source 1..897: mol_type = genomic DNA
tacttcttttgcaacccactcccatggntgtgacgggcggtgtgtacaaggcccgggaacgtattcaccgtggcattctgatccacgattactagcgattccgacttcacggagtcgagttgcagactccgatccggactacgacgcactttatgaggtccgcttgctctcgcgaggtcgcttctctttgtatgcgccattgtagcacgtgtgtagccctactcgtaagggccatgatgacttgacgtcatccccaccttcctccggtttatcaccggcagtctcctttgagttcccgaccgaatcgctggcaacaaaggataagggttgcgctcgttgcgggacttaacccaacatttcacaacacgagctgacgacagccatgcagcacctgtctcagagttcccgaaggcaccaaagcatctctgctaagttctctggatgtcaagagtaggtaaggttcttcgcgttgcatcgaattaaaccacatgctccaccgcttgtgcgggcccccgtcaattcatttgagttttaaccttgcggccgtactccccaggcggtcgacttaacgcgttagctccggaagccactcctcaagggaacaacctccaagtcgacatcgtttacggcgtggactaccagggtatctaatcctgtttgctccccacgctttcgcacctgagcgtcagtcttcgtccagggggccgccttcgccaccggtattcctccagatctctacgcatttcaccgctacacctggaattctacccccctctacgagactcaagcctgccagtttcaaatgcagttcccaggttaagcccggggatttcacatctgacttaacagaccgcctgcgtgcgctttacgcccagtaatttccgattaacgcttgca

SEQ ID NO: 23 - DNA, 931 bp, Staphylococcus sp.
  source 1..931: mol_type = genomic DNA
tgcaagtcgagcgaacagataaggagcttgctcctttgacgttagcggcggacgggtgagtaacacgtgggtaacctacctataagactgggataacttcgggaaaccggagctaataccggataacatttggaaccgcatggttctaaagtgaaagatggttttgctatcacttatagatggacccgcgccgtattagctagttggtaaggtaacggcttaccaaggcgacgatacgtagccgacctgagagggtgatcggccacactggaactgagacacggtccagactcctacgggaggcagcagtagggaatcttccgcaatgggcgaaagcctgacggagcaacgccgcgtgagtgatgaagggtttcggctcgtaaaactctgttattagggaagaacaaatgtgtaagtaactgtgcacatcttgacggtacctaatcagaaagccacggctaactacgtgccagcagccgcggtaatacgtaggtggcaagcgttatccggaattattgggcgtaaagcgcgcgtaggcggtttcttaagtctgatgtgaaagcccacggctcaaccgtggagggtcattggaaactgggaaacttgagtgcagaagaggaaagtggaattccatgtgtagcggtgaaatgcgcagagatatggaggaacaccagtggcgaaggcgactttctggtctgtaactgacgctgatgtgcgaaagcgtggggatcaaacaggattagataccctggtagtccacgccgtaaacgatgagtgctaagtgttagggggtttccgccccttagtgctgcagctaacgcattaagcactccgcctggggagtacgaccgcaaggttgaaactcaaaggaattgacggggacccgcacaagcggtggagcatgtggtttaattcgaagcaacgcgaagaa

SEQ ID NO: 24 - DNA, 993 bp, Pantoea sp.
  source 1..993: mol_type = genomic DNA
ggtaagcgccctcccgaaggttaagctacctacttcttttgcaacccactcccatggtgtgacgggcggtgtgtacaaggcccgggaacgtattcaccgtggcattctgatccacgattactagcgattccgacttcacggagtcgagttgcagactccgatccggactacgacgcactttatgaggtccgcttgctctcgcgaggtcgcttctctttgtatgcgccattgtagcacgtgtgtagccctactcgtaagggccatgatgacttgacgtcatccccaccttcctccggtttatcaccggcagtctcctttgagttcccgaccgaatcgctggcaacaaaggataagggttgcgctcgttgcgggacttaacccaacatttcacaacacgagctgacgacagccatgcagcacctgtctcagagttcccgaaggcaccaaagcatctctgctaagttctctggatgtcaagagtaggtaaggttcttcgcgttgcatcgaattaaaccacatgctccaccgcttgtgcgggcccccgtcaattcatttgagttttaaccttgcggccgtactccccaggcggtcgacttaacgcgttagctccggaagccactcctcaagggaacaacctccaagtcgacatcgtttacggcgtggactaccagggtatctaatcctgtttgctccccacgctttcgcacctgagcgtcagtcttcgtccagggggccgccttcgccaccggtattcctccagatctctacgcatttcaccgctacacctggaattctacccccctctacgagactcaagcctgccagtttcaaatgcagttcccaggttaagcccggggatttcacatctgacttaacagaccgcctgcgtgcgctttacgcccagtaattccgattaacgcttgcaccctccgtattaccgcggctgctggcacggagttagccggtgcttcttctgcgggtaacgtcaatcga

SEQ ID NO: 25 - DNA, 880 bp, Paenibacillus sp.
  source 1..880: mol_type = genomic DNA
agaagcttgcttctttgatagcgttagcggcggacgggtgagtaacacgtaggcaacctgccctcaagtttgggacaactaccggaaacggtagctaataccgaatagttgttttcttcgcctgaaggaaactggaaagacggagcaatctgtcacttggggatgggcctgcggcgcattagctagttggtggggtaacggctcaccaaggcgacgatgcgtagccgacctgagagggtgatcggccacactgggactgagacacggcccagactcctacgggaggcagcagtagggaatcttccgcaatgggcgaaagcctgacggagcaatgccgcgtgagtgatgaaggttttcggatcgtaaagctctgttgccagggaagaacgcttgggagagtaactgctctcaaggtgacggtacctgagaagaaagccccggctaactacgtgccagcagccgcggtaatacgtagggggcaagcgttgtccggaattattgggcgtaaagcgcgcgcaggcggtcatttaagtctggtgtttaatcccggggctcaaccccggatcgcactggaaactgggtgacttgagtgcagaagaggagagtggaattccacgtgtagcggtgaaatgcgtagatatgtggaggaacaccagtggcgaaggcgactctctgggctgtaactgacgctgaggcgcgaaagcgtggggagcaaacaggattagataccctggtagtccacgccgtaaacgatgagtgctaggtgttaggggtttcgatacccttggtgccgaagttaacacattaagcactccgcctggggagtacggtcgcaagactgaaactcaaaggaattgacggggacccgcacaagcagtgg

SEQ ID NO: 26 - DNA, 839 bp, Pantoea sp.
  source 1..839: mol_type = genomic DNA
aagcgccctcccgaaggttaagctacctacttcttttgcaacccactcccatggtgtgacgggcggtgtgtacaaggcccgggaacgtattcaccgtggcattctgatccacgattactagcgattccgacttcacggagtcgagttgcagactccgatccggactacgacgcactttatgaggtccgcttgctctcgcgaggtcgcttctctttgtatgcgccattgtagcacgtgtgtagccctactcgtaagggccatgatgacttgacgtcatccccaccttcctccggtttatcaccggcagtctcctttgagttcccgaccgaatcgctggcaacaaaggataagggttgcgctcgttgcgggacttaacccaacatttcacaacacgagctgacgacagccatgcagcacctgtctcagagttcccgaaggcaccaaagcatctctgctaagttctctggatgtcaagagtaggtaaggttcttcgcgttgcatcgaattaaaccacatgctccaccgcttgtgcgggcccccgtcaattcatttgagttttaaccttgcggccgtactccccaggcggtcgacttaacgcgttagctccggaagccactcctcaagggaacaacctccaagtcgacatcgtttacggcgtggactaccagggtatctaatcctgtttgctccccacgctttcgcacctgagcgtcagtcttcgtccagggggccgccttcgccaccggtattcctccagatctctacgcatttcaccgctacacctggaattctacccccctctacgagactcaagcctgccagtttcaaatgcagttccc

SEQ ID NO: 27 - DNA, 993 bp, Pantoea sp.
  source 1..993: mol_type = genomic DNA
gggtagcgccctcccgaaggttaagctacctacttcttttgcaacccactcccatggtgtgacgggcggtgtgtacaaggcccgggaacgtattcaccgtggcattctgatccacgattactagcgattccgacttcacggagtcgagttgcagactccgatccggactacgacgcactttatgaggtccgcttgctctcgcgaggtcgcttctctttgtatgcgccattgtagcacgtgtgtagccctactcgtaagggccatgatgacttgacgtcatccccaccttcctccggtttatcaccggcagtctcctttgagttcccgaccgaatcgctggcaacaaaggataagggttgcgctcgttgcgggacttaacccaacatttcacaacacgagctgacgacagccatgcagcacctgtctcagagttcccgaaggcaccaaagcatctctgctaagttctctggatgtcaagagtaggtaaggttcttcgcgttgcatcgaattaaaccacatgctccaccgcttgtgcgggcccccgtcaattcatttgagttttaaccttgcggccgtactccccaggcggtcgacttaacgcgttagctccggaagccactcctcaagggaacaacctccaagtcgacatcgtttacggcgtggactaccagggtatctaatcctgtttgctccccacgctttcgcacctgagcgtcagtcttcgtccagggggccgccttcgccaccggtattcctccagatctctacgcatttcaccgctacacctggaattctacccccctctacgagactcaagcctgccagtttcaaatgcagttcccaggttaagcccggggatttcacatctgacttaacagaccgcctgcgtgcgctttacgcccagtaattccgattaacgcttgcaccctccgtattaccgcggctgctggcacggagttagccggtgcttcttctgcgggtaacgtcaatcga

SEQ ID NO: 28 - DNA, 928 bp, Xanthomonas sp.
  source 1..928: mol_type = genomic DNA
catgcagtcgaacggcagcacaggagagccttgctctctgggtggcgagtggcggacgggtgaggaatacatcggaatctaccttttcgtgggggataacgtagggaaacttacgctaataccgcatacgaccttagggtgaaagcggaggaccttcgggcttcgcgcggatagatgagccgatgtcggattagctagttggcggggtaaaggcccaccaaggcgacgatccgtagctggtctgagaggatgatcagccacactggaactgagacacggtccagactcctacgggaggcagcagtggggaatattggacaatgggcgcaagcctgatccagccatgccgcgtgggtgaagaaggccttcgggttgtaaagcccttttgttgggaaagaaaagcagtcggttaatacccgattgttctgacggtacccaaagaataagcaccggctaacttcgtgccagcagccgcggtaatacgaagggtgcaagcgttactcggaattactgggcgtaaagcgtgcgtaggtggttgtttaagtccgttgtgaaagccctgggctcaacctgggaattgcagtggatactgggcaactagagtgtggtagaggatggcggaattcccggtgtagcagtgaaatgcgtagagatcgggaggaacatctgtggcgaaggcggccatctggaccaacactgacactgaggcacgaaagcgtggggagcaaacaggattagataccctggtagtccacgccctaaacgatgcgaactggatgttgggtgcaacttggcacgcagtatcgaagctaacgcgttaagttcgccgcctggggagtacggtcgcaagactgaaactcaaaggaattgacgggggcccgcacaagcggtggagtatgtggtttaattcgatgcaacgcgaagaacc

SEQ ID NO: 29 - DNA, 935 bp, Staphylococcus sp.
  source 1..935: mol_type = genomic DNA
tgcaagtcgagcgaacaggataaggagcttgctcctttgaagttagcggcggacgggtgagtaacacgtgggtaacctacctataagactggaataacttcgggaaaccggagctaatgccggataacatatagaaccgcatggttctatagtgaaagatggttttgctatcacttatagatggacccgcgccgtattagctagttggtaaggtaaaggcttaccaaggcgacgatacgtagccgacctgagagggtgatcggccacactggaactgagacacggtccagactcctacgggaggcagcagtagggaatcttccgcaatgggcgaaagcctgacggagcaacgccgcgtgagtgatgaaggttttcggatcgtaaaactctgttattagggaagaacaaatgcgtaagtaactgtgcgcatcttgacggtacctaatcagaaagccacggctaactacgtgccagcagccgcggtaatacgtaggtggcaagcgttatccggaattattgggcgtaaagcgcgcgtaggcggtttcttaagtctgatgtgaaagcccacggctcaaccgtggagggtcattggaaactgggaaacttgagtgcagaagaggaaagtggaattccatgtgtagcggtgaaatgcgcagagatatggaggaacaccagtggcgaaggcgactttctggtctgtaactgacgctgatgtgcgaaagcgtggggatcaaacaggattagataccctggtagtccacgccgtaaacgatgagtgctaagtgttagggggtttccgccccttagtgctgcagctaacgcattaagcactccgcctggggagtacgaccgcaaggttgaaactcaaaggaattgacggggacccgcacaagcggtggagcatgtgggtttaattcgaagcaacgcgaagaacc

SEQ ID NO: 30 - DNA, 949 bp, Methylobacterium sp.
  source 1..949: mol_type = genomic DNA
cggggtcagcggcggacgggtgagtaacgcgtgggaacgtgccttctggttcggaataaccctgggaaactagggctaataccggatacgcccttatggggaaaggtttactgccggaagatcggcccgcgtctgattagctagttggtggggtaacggcctaccaaggcgacgatcagtagctggtctgagaggatgatcagccacactgggactgagacacggcccagactcctacgggaggcagcagtggggaatattggacaatgggcgcaagcctgatccagccatgccgcgtgagtgatgaaggccttagggttgtaaagctcttttatccgggacgataatgacggtaccggaggaataagccccggctaacttcgtgccagcagccgcggtaatacgaagggggctagcgttgctcggaatcactgggcgtaaagggcgcgtaggcggcgttttaagtcgggggtgaaagcctgtggctcaaccacagaatggccttcgatactgggacgcttgagtatggtagaggttggtggaactgcgagtgtagaggtgaaattcgtagatattcgcaagaacaccggtggcgaaggcggccaactggaccattactgacgctgaggcgcgaaagcgtggggagcaaacaggattagataccctggtagtccacgccgtaaacgatgaatgccagctgttggggtgcttgcaccgcagtagcgcagctaacgctttgagcattccgcctggggagtacggtcgcaagattaaaactcaaaggaattgacgggggcccgcacaagcggtggagcatgtggtttaattcgaagcaacgcgcagaaccttaccatcctttgacatggcgtgttacccagagagatttggggtccacttcggtggcgcgcacacaggtgctgcatggctgtcgtcagctcgtgtcgtgaga

SEQ ID NO: 31 - DNA, 988 bp, Pantoea sp.
  source 1..988: mol_type = genomic DNA
gccttccggcgggtgaaactacctacttcttttgcaacccactcccatggggtggagggcggtgtgtacaaggcccgggaacgtattcaccgtggcattctgatccacgattactagcgattccgacttcacggagtcgagttgcagactccgatccggactacgacgcactttatgaggtccgcttgctctcgcgaggtcgcttctctttgtatgcgccattgtagcacgtgtgtagccctactcgtaagggccatgatgacttgacgtcatccccaccttcctccggtttatcaccggcagtctcctttgagttcccgaccgaatcgctggcaacaaaggataagggttgcgctcgttgcgggacttaacccaacatttcacaacacgagctgacgacagccatgcagcacctgtctcatcgatcccgaaggcccgcaaaaatctctccggatatctccggatgtcaagagtaggtaaggttcttcgcgttgcatcgaattaaaccacatgctccaccgcttgtgcgggcccccgtcaattcatttgagttttaaccttgcggtcgtactccccaggcggtcgacttaacgcgttagctccggaagccactcctcaagggaacaacctcgtagtcgacatcgtttacggcgtggactaccagggtatctaatcctgtttgctccccacgctttcgcacctgaccgtcagtcttcgtccagggggccgccttcgccaccggtattcctccccacctctacgcatttgtccgctacacctgtaattctaccccgctctactacactcaagcccgcgtgtttccaatgcagttcccaggttaagcccggggatttcctctctgaatttacagaccgcctgcgtgcgctttacgcccagtagtttccaattaacgcttgccccctacgtattaccgccgacgcttggcacgcagttagccgtcgcttcttctgcggttaacgtcattcga

SEQ ID NO: 32 - DNA, 1085 bp, Pantoea sp.
  source 1..1085: mol_type = genomic DNA
gtaggcgccgtcctcgcgggggataaccctacttcttttttttcccactcccttggtgtgaggggcggtgtgtacatggcccgggcaggtatttaccgaggcattctgttcgacgattactagcgattccgacttcacggacgcgagttgcatgctccgaccgatactacgacgcactttatgaggtccgtttgctctcgcgaggtcgcttctctttgtatgcgccattgtagcacgtgtgtagccctactcgtaagggccatgctggcttgacgtcatccataccttcctccggtttatcaccggcagtctcctttgagttcccgaccgaatcgctggcaacaaaggaaaagggttgcgctcgttgcgggcgttaacccaacatttcacaacacgagctggcgacagccatgcagcacctgtctgtctattcccgaaggaaggacaaaatctctctctgctttccgggatgtcaagagtaggtaagtatcttcgcgttgcatcgaattaaaccacatgctccaccgcccgtgcgggcccccgtcaatcaattcaagtttgaaccttgcgggcgtactccccacgcggtcgatttaacgcgctagctccggaagcaactcctccagggaaggacctcccactcgatctccttcgttgcgtgcgtggcctaggtagctaaccctgcttgtttcctccgcttgcttacctgaccgaccgtcttcctccgtgggggcggcctccctcccggccggcctccctacctctctccacttctttgcccgctccgcctgtctatccccctccctcaaacacaatccagccagtttctttcgaatgtcccttcttagttcagggcggtgactatccgtctgtattaagcgaccgcgcgcgcgttactcccagcaagtattacctattcgcgcttccaccctccttcctaccttggttgctgggactgagttagagagtgcttcgtcggctgcgtcagtcaatcgaggaagttgcttcttcacatcctctccccccctaatgaagttaattaccagccgaagcccacatccgaatcgcgcaattggtcgtcccat

SEQ ID NO: 33 - DNA, 342 bp, Pantoea sp.
  source 1..342: mol_type = genomic DNA
atccagacacggaggcagagatgctttggtgccttcgggaactctgagacaggtgctgcatggctgtcgtcagctcgtgttgtgaaatgttgggttaagtcccgcaacgagcgcaacccttatcctttgttgccagcgattcggtcgggaactcaaaggagactgccggtgataaaccggaggaaggtggggatgacgtcaagtcatcatggcccttacgagtagggctacacacgtgctacaatggcgcatacaaagagaagcgacctcgcgagagcaagcggacctcataaagtgcgtcgtagtccggatcggagtctgcaactcgactccgtgaagtcg

SEQ ID NO: 34 - DNA, 429 bp, Pantoea sp.
  source 1..429: mol_type = genomic DNA
actgagacaggtgctgcatggctgtcgtcagctcgtgttgtgaaatgttgggttaagtcccgcaacgagcgcaacccttatcctttgttgccagcgattcggtcgggaactcaaaggagactgccggtgataaaccggaggaaggtggggatgacgtcaagtcatcatggcccttacgagtagggctacacacgtgctacaatggcgcatacaaagagaagcgacctcgcgagagcaagcggacctcataaagtgcgtcgtagtccggatcggagtctgcaactcgactccgtgaagtcggaatcgctagtaatcgtggatcagaatgccacggtgaatacgttcccgggccttgtacacaccgcccgtcacaccatgggagtgggttgcaaaagaagtaggtagcttaaccttcgggagggcgctacc

SEQ ID NO: 35 - DNA, 303 bp, Pantoea sp.
  source 1..303: mol_type = genomic DNA
gaatcaagagacaggtgctgcatggctgtcgtcagctcgtgttgtgaaatgttgggttaagtcccgcaacgagcgcaacccttatcctttgttgccagcgattcggtcgggaactcaaaggagactgccggtgataaaccggaggaaggtggggatgacgtcaagtcatcatggcccttacgagtagggctacacacgtgctacaatggcgcatacaaagagaagcgacctcgcgagagcaagcggacctcataaagtgcgtcgtagtccggatcggagtctgcaactcgactccgtgaagtc

SEQ ID NO: 36 - DNA, 1050 bp, Micrococcus luteus
  source 1..1050: mol_type = genomic DNA
ggtctaataccggataggagcgtccaccgcatggtgggtgttggaaagatttatcggttttggatggactcgcggcctatcagcttgttggtgaggtaatggctcaccaaggcgacgacgggtagccggcctgagagggtgaccggccacactgggactgagacacggcccagactcctacgggaggcagcagtggggaatattgcacaatgggcgaaagcctgatgcagcgacgccgcgtgagggatgacggccttcgggttgtaaacctctttcagtagggaagaagcgaaagtgacggtacctgcagaagaagcaccggctaactacgtgccagcagccgcggtaatacgtagggtgcgagcgttatccggaattattgggcgtaaagagctcgtaggcggtttgtcgcgtctgtcgtgaaagtccggggcttaaccccggatctgcggtgggtacgggcagactagagtgcagtaggggagactggaattcctggtgtagcggtggaatgcgcagatatcaggaggaacaccgatggcgaaggcaggtctctgggctgtaactgacgctgaggagcgaaagcatggggagcgaacaggattagataccctggtagtccatgccgtaaacgttgggcactaggtgtggggaccattccacggtttccgcgccgcagctaacgcattaagtgccccgcctggggagtacggccgcaaggctaaaactcaaaggaattgacgggggcccgcacaagcggcggagcatgcggattaattcgatgcaacgcgaagaaccttaccaaggcttgacatgttcccgatcgccgtagagatacgatttcccctttggggcgggttcacaggtggtgcatggttgtcgtcagctcgtgtcgtgagatgttgggttaagtcccgcaacgagcgcaaccctcgttccatgttgccagcacgtaatggtggggactcatgggagactgccggggtcaactcggaggaaggtgaggacgacgtcaaatcatcatgccccttatgtcttgggcttcacgca

SEQ ID NO: 37 - DNA, 20 bp, synthetic construct
  misc_feature 1..20: note = Primer 16SF
  source 1..20: mol_type = other DNA
agagtttgatcctggctcag

SEQ ID NO: 38 - DNA, 20 bp, synthetic construct
  misc_feature 1..20: note = primer 16SR
  source 1..20: mol_type = other DNA
ctacggctaccttgttacga